(19) United States
(12) Patent Application Publication
(10) Pub. No.: US 2026/0295552 A1
(43) Pub. Date: Oct. 1, 2026

(54) PARALLEL SUBSTRATES FOR MULTIPLEXING BIOMOLECULE PROCESSING

(71) Applicant: Twist Bioscience Corporation, South San Francisco, CA (US)

(72) Inventors: Anthony DE LA CRUZ, San Francisco, CA (US); Pranav SUNDARAM, San Francisco, CA (US); Roger RUDOFF, Honolulu, HI (US)

(73) Assignee: Twist Bioscience Corporation, South San Francisco, CA (US)

(21) Appl. No.: 19/477,011

(22) PCT Filed: Apr. 17, 2024
(86) PCT No.: PCT/US2024/024898

§ 371 Date: Oct. 20, 2025

(51) Int. Cl. B01J 19/00

(52) U.S. Cl. CPC B01J 19/0046; B01J 19/0093; B01J 2219/00608; B01J 2219/00858

(57) ABSTRACT

Described herein are devices, systems, methods for processing biomolecules on a plurality of parallel substrates. A device can comprise a first substrate and a second substrate that can be substantially parallel. Each substrate can comprise a functionalized surface facing one another. The device may further comprise one or more fluidic interfaces and one or more spacers separating a plurality of substrates.

### CROSS-REFERENCE TO RELATED APPLICATIONS

This application claims priority to U.S. Provisional Application No. 63/497,555, filed on Apr. 21, 2023, which is hereby incorporated by reference in its entirety. All publications, patents, and patent applications mentioned in this specification are herein incorporated by reference to the same extent as if each individual publication, patent, or patent application was specifically and individually indicated to be incorporated by reference.

### BACKGROUND

Biomolecules on an array can be processed using flow devices (e.g., flow cells). After the substrate is placed in the flow device, reagents can be introduced into the device. The reagent is held in the device for a predetermined period of time, and subsequently drained to force out the liquid.

### SUMMARY

Provided herein is a device for processing a plurality of biomolecules comprising: a first substrate comprising a first surface functionalized for association with a first building block of the plurality of biomolecules; and a second substrate comprising a second surface functionalized for association with a second building block of the plurality of biomolecules, wherein the second surface faces the first surface. In some instances, the first substrate and the second substrate are substantially parallel. In some instances, the first substrate or the second substrate comprises dimensions of about 15 to 40 mm by about 15 to 40 mm. In some instances, the plurality of biomolecules comprises a plurality of polynucleotides and wherein the building block comprises a nucleotide. In some instances, the first surface and the second surface are functionalized with a chemical moiety suitable for nucleotide coupling. In some instances, the first surface or the second surface comprises a plurality of addressable loci. In some instances, the first surface or the second surface are functionalized for association with the plurality of molecules at a density of about 1 pmol/cm² to 200 pmol/cm². In some instances, the first substrate or the second substrate comprises at least one through-hole. In some instances, the at least one through-hole is about 120 to 500 μm in diameter. In some instances, the second substrate comprises at least two through-holes located on opposite sides. In some instances, the at least two through-holes are located diagonal to each other on the second substrate. In some instances, the at least two through-holes of the second substrate each connect to a manifold of a flow cell assembly. In some instances, the first substrate and the second substrate each comprise at least one through-hole. In some instances, the at least one through-hole of the first substrate and the at least one through-hole of the second substrate are located diagonal to each other. In some instances, the at least one through-hole of the first substrate and the at least one through-hole of the second substrate each connect to a manifold of a flow cell. In some instances, further comprising a spacer comprising a perimeter surface. In some instances, the spacer comprises a seal, a frame, or end pieces. In some instances, the end pieces comprise spacing beads. In some instances, the perimeter surface is juxtaposed to the first substrate forming a first active surface. In some instances, the second substrate is juxtaposed to the perimeter surface opposite to the first substrate forming a second active surface. In some instances, the spacer comprising the perimeter surface between the first substrate and the second substrate forms a cavity enclosed by the first active surface and the second active surface.

Also provided herein is a device for processing a plurality of biomolecules comprising a plurality of substrates, the plurality of substrates comprising: a top substrate comprising a first top surface and a first bottom surface, wherein the first bottom surface is functionalized for association with a building block of the plurality of biomolecules; a middle substrate comprising a second top surface and a second bottom surface functionalized for association with a building block of the plurality of biomolecules, wherein the second top surface faces the first bottom surface; and a bottom substrate comprising a third top surface and a third bottom surface, the third top surface functionalized for association with a building block of the plurality of biomolecules, wherein the top third surface faces the second bottom surface. In some instances, each of the plurality of substrates is substantially parallel to one another. In some instances, further comprising a plurality of middle substrates, each of the plurality of middle substrates comprising a top surface and a bottom surface. In some instances, the top surface and the bottom surface of each of the plurality of middle substrates is functionalized for association with a building block of the plurality of biomolecules. In some instances, each of the plurality of substrates is separated by a seal comprising a perimeter surface. In some instances, the spacer comprises a seal, a frame, or end pieces. In some instances, the end pieces comprise spacing beads. In some instances, the perimeter surface forms an active surface on a surface of a substrate of the plurality of substrates to which it is juxtaposed. In some instances, the device comprises a number of active surfaces on a number of substrates, wherein the number of active surfaces is twice that of the number of substrates. In some instances, each of the plurality of substrates comprises at least one through-hole. In some instances, the at least one through-hole on each of the plurality of substrates is located diagonal to the at least one through-hole on an adjacent substrate of the plurality of substrates. In some instances, the at least one through-hole on each of the plurality of substrates provides fluidic connection between each of the plurality of substrates. In some instances, the at least one through-hole of the top substrate and the at least one through-hole of the bottom substrate each connect to a manifold of a flow cell assembly.

Further provided herein is a flow cell assembly for processing a plurality of biomolecules, comprising: the device provided herein; and one or more fluidic interfaces. In some instances, further comprising one or more of: a top assembly clamp and a bottom clamp; a support plate; or one or more spacers. In some instances, the one or more spacers comprises one or more seals, one or more frames, or one or more beads. In some instances, the one or more seals comprises a perfluoroelastomer (FFKM) comprising tetrafluoroethylene (TFE), perfluoromethyl vinyl ether (PMVE), or cure site monomer (CSM), or any combination thereof. In some instances, the at least one through-hole is connected to at least one manifold of a fluidic interface of the one or more fluidic interfaces.

Also provided herein is a method of processing a plurality of biomolecules, comprising: (a) providing a flow cell assembly comprising: the device comprising a plurality of substrates provided herein; and one or more fluidic interfaces; (b) filling at least a portion of the flow cell assembly with a fluid; and (c) evacuating the fluid from at least the portion of the flow cell assembly. In some instances, each of the plurality of substrates is substantially parallel to one another. In some instances, filling the flow cell assembly comprises filling at least one cavity between two substrates of the plurality of substrates in at least the portion of the flow cell assembly. In some instances, evacuating the fluid in the flow cell assembly comprises evacuating the fluid in at least one cavity between the two substrates of the plurality of substrates in at least the portion of the flow cell assembly. In some instances, further comprising repeating (b)-(c) to synthesize a plurality of biomolecules, wherein the fluid comprises a reagent for synthesis of the plurality of biomolecules. In some instances, the plurality of biomolecules comprises a plurality of polynucleotides. In some instances, the synthesis comprises solid-phase synthesis or enzymatic synthesis. In some instances, the reagent comprises a reagent for one or more of: (i) coupling; (ii) capping; (iii) oxidizing; (iv) deblocking; or (v) washing. In some instances, the fluid comprises a reagent for removing the plurality of biomolecules. In some instances, removing the plurality of biomolecules comprises cleaving the association with the building block of the plurality of biomolecules. In some instances, (c) evacuating the fluid comprises evacuating the plurality of biomolecules from the active surface on each surface of the plurality of substrates or a portion thereof.

Also provided herein is a platform for processing a plurality of biomolecules, comprising: a device provided herein; and an apparatus comprising at least one logic element for performing one or more operations based on sensor data from one or more components of the flow cell assembly. In some instances, each of the plurality of substrates is substantially parallel to one another. In some instances, one or more operations comprise one or more of: determining a timing for opening or closing one or more valves connecting the one or more components; adjusting one or more parameters of the flow cell assembly, wherein the one or more parameters comprises a fill rate of the liquid, a volume of the liquid, the liquid, an evacuation rate of the liquid, a capillary number, or one or more angles of the flow cell assembly; or determining a recovery efficiency of a fluid evacuated from the flow cell assembly. In some instances, further comprising a cloud computing resource communicably coupled to the apparatus. In some instances, the apparatus comprises at least one processor, a memory, and instructions executable by at least one processor. In some instances, the at least one logic element comprises a programmable logic controller (PLC), programable logic array (PLA), programmable array logic (PAL), generic logic array (GLA), complex programmable logic decide (CPLD), field programable gate array (FPGA), or application-specific integrated circuit (ASIC). In some instances, the platform further comprises a synthesis module, a sequencing module, an amplification module, or any combination thereof. In some instances, the platform further comprises one or more reservoirs. In some instances, the one or more reservoirs are in connected to the one or more fluidic interfaces. In some instances, the one or more reservoirs hold a fluid for processing the plurality of biomolecules. In some instances, the platform further comprises a controller communicatively coupled to one or more actuators that open and close valves connected to the flow cell assembly.

Further provided herein is a platform for processing a plurality of biomolecules, comprising: a flow cell assembly comprising one or more components, wherein the one or more component comprises: one or more fluidic interfaces; a plurality of substrates, each surface of the plurality of substrates facing an adjacent substrate of the plurality of substrates is functionalized for association with a building block of the plurality of biomolecules; one or more spacers each comprising a perimeter surface, wherein each of the plurality of substrates is separated by a spacer of the one or more spacers, wherein the perimeter surface forms an active surface on each surface of the plurality of substrates to which it is juxtaposed; and an apparatus comprising at least one logic element for performing one or more operations based on sensor data from one or more components of the flow cell assembly. In some instances, each of the plurality of substrates is substantially parallel to one another. In some instances, one or more operations comprise one or more of: determining a timing for opening or closing one or more valves connecting the one or more components; adjusting one or more parameters of the flow cell assembly, wherein the one or more parameters comprises a fill rate of the liquid, a volume of the liquid, the liquid, an evacuation rate of the liquid, a capillary number, or one or more angles of the flow cell assembly; or determining a recovery efficiency of a fluid evacuated from the flow cell assembly. In some instances, further comprising a cloud computing resource communicably coupled to the apparatus. In some instances, the apparatus comprises at least one processor, a memory, and instructions executable by at least one processor. In some instances, the at least one logic element comprises a programmable logic controller (PLC), programable logic array (PLA), programmable array logic (PAL), generic logic array (GLA), complex programmable logic decide (CPLD), field programable gate array (FPGA), or application-specific integrated circuit (ASIC). In some instances, the platform further comprises a synthesis module, a sequencing module, an amplification module, or any combination thereof. In some instances, the platform further comprises one or more reservoirs. In some instances, the one or more reservoirs are in connected to the one or more fluidic interfaces. In some instances, the one or more reservoirs hold a fluid for processing the plurality of biomolecules. In some instances, the platform further comprises a controller communicatively coupled to one or more actuators that open and close valves connected to the flow cell assembly.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIGS. 1A-1B show non-limiting example of schematics illustrating oligomer synthesis, according to some embodiments. FIG. 1A illustrates a schematic of oligomer synthesis on a substrate. FIG. 1B illustrates a schematic of multiplexing oligomer synthesis on two substrates that are parallel or substantially parallel to one another.

FIG. 2 shows a non-limiting example of a schematic illustrating cyclic oligomer synthesis using parallel or substantially parallel substrates by flowing reagents between them, according to some embodiments.

FIG. 3 shows a non-limiting example of a schematic illustrating fluidic routing for parallel or substantially parallel substrates, according to some embodiments.

FIGS. 4A-4E show non-limiting examples of a prototype comprising substrates in a flow cell assembly and components thereof, according to some embodiments. FIG. 4A shows an example of a silicon substrate for oligomer synthesis, where the whole surface can be an active surface. FIG. 4B shows the bottom of a PEEK flow cell comprising fluidic manifolding for introducing reagents used in the prototype, as well as a gasket acting as a seal to prevent leakages. FIG. 4C shows a first substrate placed on top of the gasket shown in FIG. 4B with two 150 μm holes for introducing reagents. FIG. 4D shows a FFKM Kalrez gasket defining the fluidic boundary and net active area available for oligomer synthesis in the prototype, which is placed on top of the first substrate shown in FIG. 4C. FIG. 4E shows a second silicon substrate placed face down on the gasket, meaning the functionalized surface facing the FFKM Kalrez gasket of FIG. 4D, where the gasket separates the two substrates.

FIG. 5 shows a non-limiting example of a blow-out of components involved in the assembly of the flow cell prototype described herein, according to some embodiments. The blow-out schematic (left) includes part numbers for components that correspond to the part numbers and description in the upper right table. The table includes part numbers 501 through 509, with the following descriptions: assembly clamp 501 (e.g., top), comprising, for example, aluminum; support plate 502, comprising, for example, glass; synthesis substrate 503 (e.g., top), comprising, for example, silicon; gasket seal 504 (e.g., flow cell boundary), comprising, for example, Kalrez; synthesis substrate 505 (e.g., bottom, fluidic vias), comprising, for example, silicon; gasket seal 506 (e.g., flow cell fluidics), comprising, for example, Perlast; gasket seal 507 (e.g., flow cell fluidics spacer), comprising, for example, Kalrez; flow cell fluidic interface 508, comprising, for example, PEEK; and assembly clamp 509 (e.g., bottom), comprising, for example, aluminum.

FIG. 6 shows a non-limiting example of the area of focus within the assembly prototype model with labels indicating the fluidic routing for the parallel substrates, according to some embodiments.

FIG. 7 shows a non-limiting example of conditions tested for validating the parallel substrate design, according to some embodiments. Run A comprises a control run with a single substrate with standard operating protocol; Run B comprises a single chip with 1×150 micron drilled hole; Run C comprises a single chip with 1×150 micron drilled hole (repeat run of Run B); Run D comprises a simultaneous synthesis in 2 chips with flow sandwiched in between the substrates; and Run R comprises a repeated control run with a single substrate with standard operating protocol (repeat run of Run A).

FIG. 8 shows a non-limiting example of a fluorescent image stitched together to represent a silicon substrate post-oligomer synthesis, according to some embodiments.

FIG. 9 shows a non-limiting example of comparison between the microscope image of a silicon substrate pre-synthesis versus post-synthesis, according to some embodiments.

FIG. 10 shows a table with experimental analysis results (ANOVA test) of various comparison groups from the various conditions shown in FIG. 7, according to some embodiments. The table provides p-values and F-ratios to demonstrate statistical significance of differences.

FIG. 11 shows a box and whisker plot for fluorescent intensity from the conditions evaluated (FIG. 7), according to some embodiments. The plot shows that variances in the average signal for repeats between runs and experiments are higher than the chips used within a sandwich design (parallel substrates), and between the sandwich design and control. The plot indicates the variations are caused by a secondary source and not the prototype concept itself.

FIG. 12 shows a non-limiting example of a schematic illustrating an alternative fluidic routing to introduce reagents between substrates that can be used to adapt to multiplexing more than two substrates, according to some embodiments.

FIG. 13 shows a non-limiting example of a schematic illustrating a flow cell design for a modified fluidic routing to introduce reagents between two substrates, according to some embodiments.

FIG. 14 shows a non-limiting example of a schematic illustrating a plurality of substrates for multiplexing synthesis on a larger number of substrates, according to some embodiments. The plurality of substrates can be parallel or substantially parallel to one another. Fluidic routing of the reagents is shown by the arrows on the left diagram, while the right diagram provides a side-view image of a cartridge concept housing multiple substrates and fluidic layers within in the form of a sandwich. The design with 4 substrates can allow for 8 active surfaces.

FIG. 15 shows a non-limiting example of a schematic illustrating a parallel operation where all fluidic layers are filled at the same time, according to some embodiments. Such parallel operation can allow for reactions (e.g., synthesis) on the surfaces of the substrates in contact with the fluid to take place in parallel. Such parallel operation can use the maximum amount of reagents but allow for the fastest operation time.

FIG. 16 shows a non-limiting example of a schematic illustrating a batch operation where a sub-set of fluidic layers are filled at a time, according to some embodiments. Such batch operation can allow for reactions (e.g., synthesis) on the surfaces of the substrates in contact with the fluid to take place in parallel. The control volume of reagents can be passed onto the next batch and sequential/serial reactions (e.g., synthesis) can take place. Such operation can use smaller amounts of fluids than the parallel operation (FIG. 15) but can require higher operation times.

FIG. 17 shows a non-limiting example of system for synthesizing, storing, and sequencing a plurality of polynucleotides, according to some embodiments.

FIGS. 18A-18G show non-limiting examples of a structure for storing a plurality of polynucleotides in accordance with some embodiments. FIG. 18A shows a structure that is substantially tubular. FIG. 18B shows a structure comprising a cap and a body that are flush-welded together. FIG. 18C shows structure comprising a removable screw-cap. FIG. 18D shows a structure comprising a septum. FIG. 18E shows a structure comprising two rounded, pill-shaped halves that form a seal when one half is inserted into the other. FIG. 18F shows a structure comprising a substantially flat, disc container with sealable lid. FIG. 18G shows a structure comprises a box with an optionally attached lid.

FIG. 19 shows a non-limiting example of a computing device; in this case, a device with one or more processors, memory, storage, and a network interface.

FIGS. 20A-20B show non-limiting examples of a schematic illustrating substrates separated by a frame, according to some embodiments. FIG. 20A shows a cross-section of the substrates separated by the frame, while FIG. 20B shows the full schematic of the substrates and the frame.

FIGS. 21A-21B show non-limiting examples of a schematic illustrating spacing between substrates set by end pieces, according to some embodiments. FIG. 21A shows a cross-section of the substrates separated by the end pieces, while FIG. 21B shows the full schematic of the substrates and the frame.

### DETAILED DESCRIPTION

Provided herein are devices, systems, methods, and platforms for scaling up biomolecule processing, such as oligomer synthesis, on a substrate while preserving the turnaround time and reagent usage. The disclosure provided herein, in some instances, can improve current processing methods (e.g., oligomer synthesis methods). In some instances, the present disclosure allows for lowering the use of expensive reagents while increasing production and doing so for every cycle involved in processing biomolecules (e.g., synthesizing oligomers). This can reduce operation expenditure, as well as allow processes to be more sustainable for the environment when considering disposal of harmful organic chemicals. In some instances, the present disclosure allows for reducing the turnaround time associated with the process while increasing production. In some instances, the present disclosure provides scaling up strategies that are easy to manufacture, design, and/or incorporate in current workflows. In some instances, the present disclosure provides a compact and simple solution that can be extended to larger numbers of substrates for further scaling up and multiplexing of biomolecule production from a substrate.

Provided herein are systems and methods for achieving multiplexing of biomolecule processing (e.g., oligomer synthesis) between two substrates by introducing fluidic reagents between them in the form of a sandwich. The surfaces can be placed face to face creating a flow cell where reagents for processing biomolecules can flow between. Cyclic addition of reagents according to standard chemical or biochemical processes can lead to growth of biomolecules, such as oligomers, on both substrates. The present design can provide advantages, including lower reagent usage due to utilization of the same chemical reagent between the two surfaces that establish the fluidic boundary. Common use of reagents between the two surfaces can achieve multiplexing while preserving a unit control volume of reagent used per cycle. A further advantage can comprise demonstration of a novel method for multiplexing and increasing throughput, as well as scaling up to grow on two surfaces while preserving the operation time involved for one substrate surface (i.e., a decreased turnaround time). Further, the systems and methods provided herein can reduce design complexity and ease of scaleup. In some instances, the systems and methods provided herein are applicable to parallel reactions taking place on multiple substrates enclosed in a cartridge, such as oligomer synthesis. Further, parity in conditions and oligomer quality across the two substrates can provide means for an internal replicate that can be used for further troubleshooting of systemic variances.

In some instances, provided herein is a device for processing a plurality of biomolecules comprising: (a) a first substrate comprising a first surface functionalized for association with a first building block of the plurality of biomolecules; and (b) a second substrate comprising a second surface functionalized for association with a second building block of the plurality of biomolecules, wherein the second surface faces the first surface.

In some instances, provided herein is a device for processing a plurality of biomolecules comprising a plurality of substrates, the plurality of substrates comprising: (a) a first substrate comprising a first top surface and a first bottom surface, wherein the first bottom surface is functionalized for association with a building block of the plurality of biomolecules; (b) a second substrate comprising a second top surface and a second bottom surface functionalized for association with a building block of the plurality of biomolecules, wherein the second top surface faces the first bottom surface; and (c) a third substrate comprising a third top surface and a third bottom surface, the third top surface functionalized for association with a building block of the plurality of biomolecules, wherein the top third surface faces the second bottom surface.

In some instances, provided herein is a flow cell assembly for processing a plurality of biomolecules, comprising: a device described herein; and one or more fluidic interfaces.

In some instances, provided herein is a method of processing a plurality of biomolecules, comprising: (a) providing a flow cell assembly comprising: (i) a device comprising a plurality of substrates; and (ii) one or more fluidic interfaces; (b) filling at least a portion of the flow cell assembly with a fluid; and (c) evacuating the fluid from at least the portion of the flow cell assembly.

In some instances, provided herein is a platform for processing a plurality of biomolecules, comprising: (a) a device described herein; and (b) an apparatus comprising at least one logic element for performing one or more operations based in part on sensor data from one or more components of the flow cell assembly.

In some instances, provided herein is a platform for processing a plurality of biomolecules, comprising: (a) a flow cell assembly comprising one or more components, wherein the one or more component comprises: (i) one or more fluidic interfaces; (ii) a plurality of substrates, each surface of the plurality of substrates facing an adjacent substrate is functionalized for association with a building block of the plurality of biomolecules; (iii) one or more seals each comprising a perimeter surface, wherein each of the plurality of substrates is separated by a seal of the one or more seals, wherein the perimeter surface forms an active surface on each surface of the plurality of substrates to which it is juxtaposed; and (b) an apparatus comprising at least one logic element for performing one or more operations based in part on sensor data from one or more components of the flow cell assembly.

### Devices and Flow Cell Assemblies for Biomolecule Processing

Provided herein are systems and devices for processing biomolecules. Biomolecules can generally comprise one or more of carbohydrates, protein, lipids, or nucleic acids. In some instances, biomolecules comprise polynucleotides. In some instances, biomolecules comprise peptides. The devices and systems provided herein may process biomolecules, for example, by synthesizing, generating, sequencing, transferring, extracting, reacting, amplifying, or analyzing the biomolecules.

Devices and systems for processing molecules can comprise one or more substrates. The one or more substrates may be, in some instances, a silicon chip. The one or more substrates can each comprise a surface. A surface, in some instances, is functionalized for association with a building block of a biomolecule. A building block can comprise monomer of the biomolecule or a plurality thereof (e.g., nucleotides, amino acids, saccharides, etc.). In some instances, a building block is an amino acid or a plurality thereof (e.g., dipeptide, tripeptide, etc.). In some instances, a building block is a nucleotide or a plurality thereof (e.g., dinucleotide, trinucleotide, etc.). In some examples, a building block comprises sugar, nitrogenous base, phosphate, or any combination thereof. In some examples, the nitrogenous base or the sugar, or both may be protected using a suitable protecting group (or blocking group).

The surface may be functionalized for association with a building block of the molecule. In some instances, the surface is functionalized with a chemical moiety suitable for coupling or linking a building block of a biomolecule, for example, a nucleotide. A chemical moiety may comprise an organosilane, for example, without limitation, N-(3-triethoxysilylpropyl)-4-hydroxybutyramide (HAPS), 11-acetoxyundecyltriethoxysilane, n-decyltriethoxysilane, (3-aminopropyl)trimethoxysilane, (3-aminopropyl)triethoxysilane, 3-glycidoxypropyltrimethoxysilane (GOPS), 3-iodo-propyltrimethoxysilane, butyl-aldehydr-trimethoxysilane, dimeric secondary aminoalkyl siloxanes, (3-aminopropyl)-diethoxy-methylsilane, (3-aminopropyl)-dimethyl-ethoxysilane, and (3-aminopropyl)trimethoxysilane, (3-glycidoxypropyl)-dimethyl-ethoxysilane, glycidoxy-trimethoxysilane, (3-mercaptopropyl)-trimethoxysilane, 3-4 epoxycyclohexyl-ethyltrimethoxysilane, and (3-mercaptopropyl)-methyl-dimethoxysilane, allyl trichlorochlorosilane, 7-oct-1-enyl trichlorochlorosilane, or bis (3-trimethoxysilylpropyl) amine. A passive agent for inclusion in a set of molecules described herein includes, without limitation, perfluorooctyltrichlorosilane; tridecafluoro-1,1,2,2-tetrahydrooctyl)trichlorosilane; tridecafluoro-1,1,2,2-tetrahydrooctyl)trimethoxysilane; 1H, 1H, 2H, 2H-fluorooctyltriethoxysilane (FOS); trichloro(1H, 1H, 2H, 2H-perfluorooctyl)silane; tert-butyl-[5-fluoro-4-(4,4,5,5-tetramethyl-1,3,2-dioxaborolan-2-yl)indol-1-yl]-dimethyl-silane; CYTOP™; Fluorinert™; perfluoroctyltrichlorosilane (PFOTCS); perfluorooctyldimethylchlorosilane (PFODCS); perfluorodecyltriethoxysilane (PFDTES); pentafluorophenyl-dimethylpropylchloro-silane (PFPTES); perfluorooctyltriethoxysilane; perfluorooctyltrimethoxysilane; octylchlorosilane; dimethylchloro-octodecyl-silane; methyldichloro-octodecyl-silane; trichloro-octodecyl-silane; trimethyl-octodecyl-silane; triethyl-octodecyl-silane; or octadecyltrichlorosilane. The surface may, in some instances, be functionalized in a pattern, creating active regions for association with a building block of the biomolecule and passive regions that cannot associate with a building block of the biomolecule.

In some instances, the surface is functionalized for association with the plurality of molecules at a density of about 1 pmol/cm² to 200 pmol/cm². In some instances, the density may vary based at least in part on the length of the polynucleotides. As an example, the density may be about 50 pmol/cm² for the synthesis of 80mers. In some instances, the density is about 1 to 10 pmol/cm², 1 to 50 pmol/cm², 1 to 80 pmol/cm², 1 to 100 pmol/cm², 1 to 120 pmol/cm², 1 to 150 pmol/cm², 1 to 200 pmol/cm², 10 to 50 pmol/cm², 10 to 80 pmol/cm², 10 to 100 pmol/cm², 10 to 120 pmol/cm², 10 to 150 pmol/cm², 10 to 200 pmol/cm², 50 to 80 pmol/cm², 50 to 100 pmol/cm², 50 to 120 pmol/cm², 50 to 150 pmol/cm², 50 to 200 pmol/cm², 80 to 100 pmol/cm², 80 to 120 pmol/cm², 80 to 150 pmol/cm², 80 to 200 pmol/cm², 100 to 120 pmol/cm², 100 to 150 pmol/cm², 100 to 200 pmol/cm², 120 to 150 pmol/cm², 120 to 200 pmol/cm², or 150 to 200 pmol/cm². In some instances, the density is about 1, 10, 50, 80, 100, 120, 150, or 200 pmol/cm². In some instances, the density is about at least 1, 10, 50, 80, 100, 120, or 150 pmol/cm². In some instances, the density is about at most 10, 50, 80, 100, 120, 150, or 200 pmol/cm².

In some instances, the net yield of polynucleotides from one or more substrates of a flow cell assembly is about 1×10⁻⁷ pmol/cm² to about 1×10³ pmol/cm². However, the yield may vary at least in part on any one of dimensions of the flow cell assembly or the components therein (e.g., the active surface area), density of the functionalization agent, length of the polynucleotides, number of substrates, synthesis method, flow rate (or evacuation rate), air-liquid interface instabilities (e.g., Saffman-Taylor instability), or any combination thereof. In some instances, the net yield of polynucleotides from one or more substrates of a flow cell assembly is about 1.3×10⁻⁷ pmol/cm² to about 7.3×10² pmol/cm². In some instances, the net yield is about 1×10⁻⁷, 1×10⁻⁶, 1×10⁻⁵, 1×10⁻⁴, 1×10⁻³, 5×10⁻³, 0.01, 0.05, 0.1, 0.5, 1, 10, 50, 100, 200, 300, 400, 500, 600, 700, 800, 900, or 1000 pmol/cm². In some instances, the net yield is about 1×10⁻⁷, 1×10⁻⁶, 1×10⁻⁵, 1×10⁻⁴, 1×10⁻³, 5×10⁻³, 0.01, 0.05, 0.1, 0.5, 1, 10, 50, 100, 200, 300, 400, 500, 600, 700, 800, or 900 pmol/cm². In some instances, the net yield is about 1×10⁻⁶, 1×10⁻⁵, 1×10⁻⁴, 1×10⁻³, 5×10⁻³, 0.01, 0.05, 0.1, 0.5, 1, 10, 50, 100, 200, 300, 400, 500, 600, 700, 800, 900, or 1000 pmol/cm². In some instances, the net yield is about 1×10⁻⁷ to 1×10⁻⁵, 1×10⁻⁷ to 1×10⁻³, 1×10⁻⁷ to 0.1, 1×10⁻⁷ to 1, 1×10⁻⁷ to 10, 1×10⁻⁶ to 1×10⁻⁴, 1×10⁻⁶ to 0.1, 1×10⁻⁶ to 1, 1×10⁻⁶ to 0.1, 1×10⁻⁶ to 1, 1×10⁻⁶ to 10, 1×10⁻⁵ to 1×10⁻³, 1×10⁻⁵ to 0.1, 1×10⁻⁵ to 1, 1×10⁻⁵ to 10, 1×10⁻⁴ to 0.1, 1×10⁻⁴ to 1, 1×10⁻⁴ to 0.1, 1×10⁻⁴ to 1, 1×10⁻⁴ to 10, 1×10⁻³ to 0.1, 1×10⁻³ to 1, 1×10⁻³ to 10, 5×10⁻³ to 0.01, 5×10⁻³ to 0.05, 5×10⁻³ to 0.1, 5×10⁻³ to 0.5, 5×10⁻³ to 1, 5×10⁻³ to 10, 0.01 to 0.05, 0.01 to 0.1, 0.01 to 0.5, 0.01 to 1, 0.01 to 10, 0.05 to 0.1, 0.05 to 0.5, 0.05 to 1, 0.05 to 10, 0.1 to 0.5, 0.1 to 1, 0.1 to 10, 0.1 to 50, 0.5 to 1, 0.5 to 10, 0.5 to 50, 1 to 10, 1 to 50, 1 to 100, 1 to 200, 10 to 50, 10 to 100, 10 to 200, 10 to 300, 10 to 400, 10 to 500, 10 to 1000, 50 to 100, 50 to 200, 50 to 300, 50 to 400, 50 to 500, 50 to 800, 50 to 1000, 100 to 200, 100 to 300, 100 to 400, 100 to 500, 100 to 600, 100 to 700, 100 to 800, 100 to 900, 100 to 1,000, 200 to 300, 200 to 400, 200 to 500, 200 to 600, 200 to 700, 200 to 800, 200 to 900, 200 to 1,000, 300 to 400, 300 to 500, 300 to 600, 300 to 700, 300 to 800, 300 to 900, 300 to 1,000, 400 to 500, 400 to 600, 400 to 700, 400 to 800, 400 to 900, 400 to 1,000, 500 to 600, 500 to 700, 500 to 800, 500 to 900, 500 to 1,000, 600 to 700, 600 to 800, 600 to 900, 600 to 1,000, 700 to 800, 700 to 900, 700 to 1,000, 800 to 900, 800 to 1,000, or 900 to 1,000 pmol/cm².

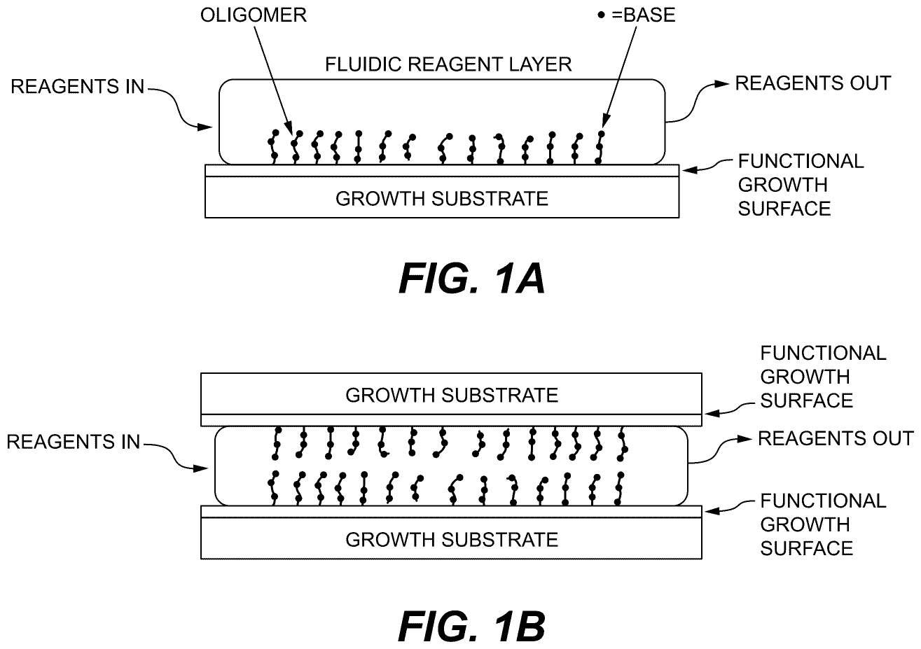

An exemplary schematic illustrating a plurality of biomolecules on a functionalized surface is provided in FIG. 1A. As shown, the substrate is functionalized, and a plurality of oligomers can be extended from the functionalized surface. The reagents may be provided to the device from the left, exposing the plurality of oligomers to the reagent, and the reagent may be evacuated from the right. The reagents can react with the plurality of oligomers, for example, for extension of the oligomers or extraction of oligomers. In some instances, the reagents are used to synthesize the oligomers. In some instances, the reagents are used to break or cleave the association or link between the oligomers and the functionalized surface, thereby extracting the oligomers with the reagent as it is evacuated from the device. In some instances, the reagents are for one or more steps of polynucleotide synthesis cycle (e.g., coupling, capping, oxidizing, deblocking or deprotecting, etc.).

The devices and systems for processing biomolecules can comprise at least two substrates. The substrates can each comprise a surface that can be functionalized, partially or fully, for association with a building block of the biomolecules. A device for processing a plurality of biomolecules can comprise a first substrate comprising a first surface functionalized for association with a first building block of the plurality of biomolecules; and a second substrate comprising a second surface functionalized for association with a second building block of the plurality of biomolecules. In some instances, the second surface faces the first surface (e.g., sandwich design). In some instances, the two substrates may be parallel or substantially parallel to one another.

An exemplary schematic illustrating this sandwich design is provided in FIG. 1B. The two substrates are functionalized on the surfaces facing one another. The two substrates may be substantially parallel. In some instances, the two substrates are parallel. The oligomers can be synthesized and extended from each of these surfaces towards one another. The substrates may be spaced apart such that the biomolecules extending from surfaces facing one another are not in contact or do not interact. Referring to FIG. 1B, the oligomers on each of the growth substrates do not interact. The reagents may be provided to the device from the left, exposing the plurality of oligomers to the reagent, and the reagent may be evacuated from the right, as generally described for FIG. 1A. In some instances, the directionality of the fluid flow in this exemplary embodiment is reversed, for example, during or between operations of the device. The sandwiched design illustrated in FIG. 1B may allow for about double the oligomer production with the same amount of reagent and operation time. In some instances, such design increases the processing efficiency and yield of biomolecules.

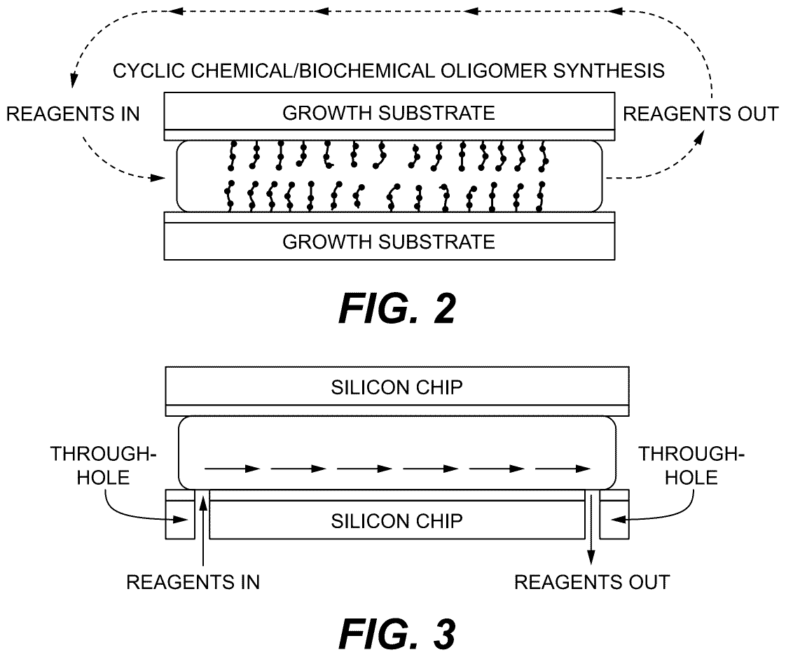

FIG. 2 provides an exemplary illustration in which cyclic chemical or biochemical oligomer synthesis may be performed using this sandwiched design, where two surfaces functionalized with a reactive group suitable for nucleotide coupling face one another. In some instances, the two surfaces are functionalized prior to being sandwiched. In some instances, the two surfaces are not functionalized prior to being sandwiched. In some examples, the two surfaces are functionalized by exposure to the surfaces in contact with fluidic layer to the fluid passing through the fluidic layer. The fluidic layer is sandwiched between the two substrates, which in some instances, are parallel or substantially parallel. Here, the same protocol used for oligomer synthesis for one substrate involving the cyclic introduction of chemical or biochemical reagents to the substrate surface can be practiced. A layer of fluid passes over the substrate surface for reactions to occur and is replaced by the subsequent fluid in the oligomer synthesis cycle. In some instances, the fluid can comprise a wash solvent for washing or cleaning the surfaces exposed to the fluidic layer. In some examples, the surfaces are washed or cleaned between steps of a synthesis cycle, between synthesis cycles, or after completing synthesis of desired polynucleotides.

In some instances, the two substrates, for example as shown in FIG. 1B, are separated by a gap of about 0.1 to 0.5 mm. In some instances, the distance or gap between the two substrates is about 0.1 to 0.15, 0.1 to 0.2, 0.1 to 0.25, 0.1 to 0.3, 0.1 to 0.35, 0.1 to 0.4, 0.1 to 0.45, 0.1 to 0.5, 0.15 to 0.2, 0.15 to 0.25, 0.15 to 0.3, 0.15 to 0.35, 0.15 to 0.4, 0.15 to 0.45, 0.15 to 0.5, 0.2 to 0.25, 0.2 to 0.3, 0.2 to 0.35, 0.2 to 0.4, 0.2 to 0.45, 0.2 to 0.5, 0.25 to 0.3, 0.25 to 0.35, 0.25 to 0.4, 0.25 to 0.45, 0.25 to 0.5, 0.3 to 0.35, 0.3 to 0.4, 0.3 to 0.45, 0.3 to 0.5, 0.35 to 0.4, 0.35 to 0.45, 0.35 to 0.5, 0.4 to 0.45, 0.4 to 0.5, or 0.45 to 0.5 mm. In some instances, the distance or gap between the two substrates is about 0.1, 0.15, 0.2, 0.25, 0.3, 0.35, 0.4, 0.45, or 0.5 mm. In some instances, the distance or gap between the two substrates is at least about 0.1, 0.15, 0.2, 0.25, 0.3, 0.35, 0.4, or 0.45 mm. In some instances, the distance or gap between the two substrates is at most about 0.15, 0.2, 0.25, 0.3, 0.35, 0.4, 0.45, or 0.5 mm.

The device can comprise at least one through-hole. The at least one through-hole can be fabricated into a substrate of the device for fluid flow to and from the fluidic reagent layer sandwiched between two substrates. An exemplary schematic showing the fluidic routing of a device described herein is provided in FIG. 3. Introduction of a fluidic layer between two parallel or substantially parallel flat surfaces can be achieved by fabricating two through-holes in one substrate, with one serving as the inlet and the other as the outlet. Referring to FIG. 3, the bottom substrate can comprise two through-holes, one for reagents to enter the space (or cavity) between the two substrates (left) and one for reagents to be evacuated from the space (or cavity) between the two substrates (right). This can result in a single inlet-single outlet flow path with fluid entering through one substrate, flowing between the two surfaces, and then exiting out of the same substrate.

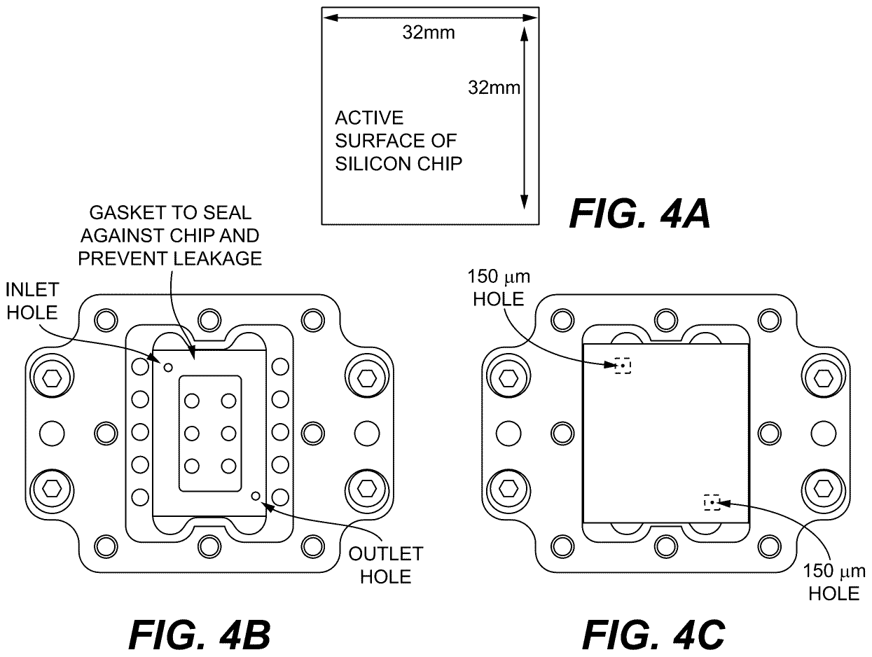

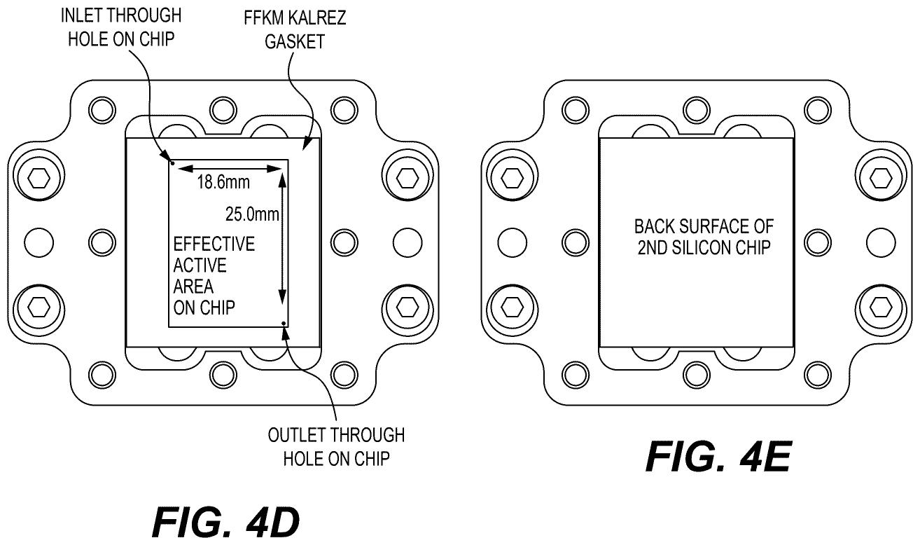

The at least one through-hole can comprise an inlet and an outlet. In some instances, each of the two through-holes (or each of the inlet and the outlet), are located on opposite sides of the same substrate or diagonal to each other on the same substrate. For example, referring to FIG. 4C, the inlet hole and the outlet hole are located on opposite sides of the substrate and are further diagonal to one another. In some instances, there exists manifolds for connection of each through-hole to the reagents on the outer surfaces of the substrates. In some instances, the manifolds comprise valves for controlling reagent flow to and from the device, as further described herein. In some instances, the manifolds comprise bypasses for routing the reagents to or from the device to other components of systems comprising the device, as further described herein.

The substrates of the device described herein can vary in shape and size. In some instances, the substrates have a shape that is substantially square, rectangular, or circular, or any other suitable shape according to the embodiments provided herein. In some instances, the substrate is substantially square or rectangular, comprising a first length and a second length, each about 15 to 40 mm. In some instances, a first length, a second length, or both, is about 15 to 16, 15 to 17, 15 to 18, 15 to 19, 15 to 20, 15 to 21, 15 to 22, 15 to 25, 15 to 28, 15 to 30, 15 to 32, 15 to 35, 15 to 38, or 15 to 40, 18 to 19, 18 to 20, 18 to 21, 18 to 22, 18 to 25, 18 to 28, 18 to 30, 18 to 32, 18 to 35, 18 to 38, or 18 to 40, 20 to 21, 20 to 22, 20 to 25, 20 to 28, 20 to 30, 20 to 32, 20 to 35, 20 to 38, or 20 to 40, 25 to 28, 25 to 30, 25 to 32, 25 to 35, 25 to 38, or 25 to 40, 30 to 32, 30 to 35, 30 to 40, or 35 to 40 mm. In some instances, a first length, a second length, or both, is about 15, 15.5, 16, 16.5, 17, 17.5, 17.9, 18, 18.5, 19, 19.5, 19.9, 20, 20.5, 21, 21.5, 22, 25, 28, 30, 32, 35, 38, or 40 mm. In some instances, a first length, a second length, or both, is at least about 15, 15.5, 16, 16.5, 17, 17.5, 18, 18.5, 19, 19.5, 20, 20.5, 21, 21.5, 22, 25, 28, 30, 32, 35, 38, or 40 mm. In some instances, a first length, a second length, or both, of the substrate is at most about 15.5, 16, 16.5, 17, 17.5, 18, 18.5, 19, 19.5, 20, 20.5, 21, 21.5, 22, 25, 28, 30, 32, 35, 38, or 40 mm. In some instances, as shown in FIG. 4A, the first length of the substrate is about 32 mm, and the second length of the substrate is about 32 mm. In some examples, the whole surface of the substrate can be an active surface functionalized for association with a building block of a biomolecule. In some examples, a section or a plurality of sections of the surface of the substrate can be an active surface functionalized for association with a building block of a biomolecule.

The device provided herein may be part of a flow cell assembly. The flow cell assembly may be used to process biomolecules as described herein, for example, for synthesis or extraction of biomolecules from the one or more substrate. In some instances, the flow cell assembly comprises a housing defining a flow chamber. In some instances, the flow cell comprises a Hele-Shaw flow cell. In some instances, the flow cell assembly comprises an opening for receiving a substrate. In some examples, the substrate is placed in a recess in the flow cell assembly.

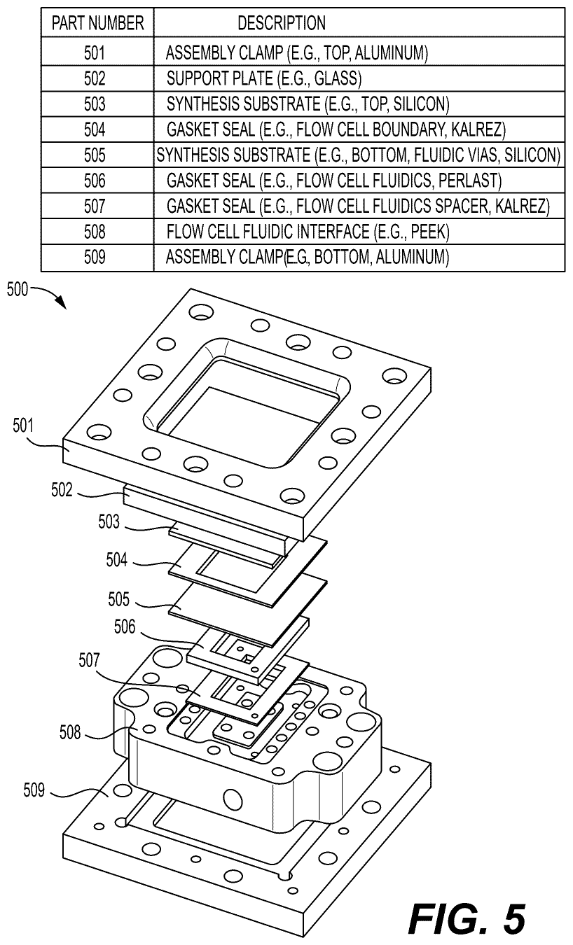

In some instances, the flow cell assembly can enclose one or more substrates and be fluidically sealed. In some examples, the opening of the flow cell can be sealed after the one or more substrates is placed therein, to prevent the leakage of fluids from the flow cell assembly through the opening. Such seals may include a flexible material that is sufficiently flexible or compressible to form a fluid tight seal that may be maintained under increased pressures encountered in the use of the device. The flexible member may be, for example, rubber, flexible plastic, flexible resins, and the like and combinations thereof. In one aspect, the flexible material is substantially inert with respect to the fluids introduced into the device and does not interfere with the reactions that occur within the device. The flexible member may be a gasket and may be in any shape such as, for example, circular, oval, rectangular, and the like, e.g., the flexible member may be in the form of a seal, such as an O-ring (e.g., FFKM Kalrez O-ring) in certain embodiments. In some instances, the flow cell assembly comprises a groove for a seal (e.g., a Kalrez O-ring), which is shown for example in FIG. 5. The groove may be dovetailed to ensure the O-ring is retailed. In some instances, the groove is a single-sided. In some instances, the groove is double-sided dovetail.

The flow cell assembly can comprise two halves. In some examples, the two halves can be brough into proximity to enclose one or more substrate (e.g., sandwiched substrate design shown in FIG. 3) and fluidically seal the one or more substrates. In some examples, when the flow chamber comprises two halves, the halves may be stably associated by providing mating elements (e.g., a prong on one half that fits into an opening of another half). However, in another aspect, the two halves may be stably associated by clamps or other pressure sealing mechanisms. In one aspect, the two halves are sealable and engaged during processing or reaction steps (e.g., synthesis steps) and are separable at other times to permit the one or more substrates to be placed into and removed from the chamber of the flow cell assembly. Movement of the one half with respect to the other may be achieved by means of, for example, pistons, and so forth. The movement may be controlled electronically by means that are conventional in the art.

The dimension of the flow cell assembly, or the substrate(s) placed therein can be varied. In some instances, the dimension of flow cell assembly is varied depending on the dimension of the substrate(s) placed therein. In some instances, a recess of in the body of a flow cell assembly housing the substrate(s) has at least one dimension (e.g., length, width, or height) that is about the same as a dimension of a substrate placed therein. In some examples, the recess of in the body of a flow cell assembly housing the substrate(s) is substantially square, rectangular, or circular, corresponding to the shape of the substrate(s). In some examples, the recess of in the body of a flow cell assembly housing the substrate(s) is formed via a separate shim with both surfaces planar. In some examples, a top surface can comprise a polymer, such as PEEK or PPS, or any other suitable polymer known in the art. In some examples, a top surface can comprise a metal (e.g., solid metal) or plated plastic. In some instances, the top surface can comprise an out of plane cathode using a conductive material. In some examples, a metal, such as platinum or stainless steel is used for the plating.

An example of a bottom half of a flow cell assembly is provided in FIG. 4B. The flow cell assembly can be constructed from PEEK used for housing the one or more substrates and for providing the fluidic manifolding architecture to introduce reagents and remove reagent (e.g., waste) to the external environment. The inlet and outlet holes fabricated into the bottom of the flow cell assembly are labeled in FIG. 4B, located diagonal to one another. A gasket can be placed in a recess in the body of the flow cell to seal against the substrate placed therein and prevent leakages. The gasket can also be fabricated such that it has inlet and outlet holes that allow for reagent flow to and from the one or more substrates placed in the flow cell assembly. In some instances, at least one through-hole, for example, an inlet and an outlet, is drilled into the gasket.

A first substrate may be placed in the flow cell assembly as shown in FIG. 4C, on top of the gasket shown in FIG. 4B. The substrate may be placed in a further recess in the body of the flow cell assembly. As shown, the substrate comprises two through-holes: inlet (top left) and outlet (bottom right) located diagonal to one another. This creates a path for reagents to flow to and from the substrate and the external environment when overlaid on the bottom half of the flow cell assembly and the gasket.

The at least one though-hole of the one or more substrates in a device described herein can vary in size. In some instances, at least one through-hole is drilled into the flow cell assembly housing the one or more substrate (e.g., bottom, or top half of the flow cell assembly, a gasket, etc.) that spatially corresponds to the at least one through-hole of one or more substrates. In some instances, the at least one through-hole comprises two through-holes that are located on opposite sides of the substrate, for example in diagonal corners of a rectangular surface. In some instances, each of through-holes (e.g., inlet and outlet hole(s)) is about 100 to 500 μm. In some instances, each of the at least two openings has a diameter of about 100 to 150, 100 to 200, 100 to 250, 100 to 300, 100 to 350, 100 to 400, 100 to 450, 100 to 500, 150 to 200, 150 to 250, 150 to 300, 150 to 350, 150 to 400, 150 to 450, 150 to 500, 200 to 250, 200 to 300, 200 to 350, 200 to 400, 200 to 450, 200 to 500, 250 to 300, 250 to 350, 250 to 400, 250 to 450, 250 to 500, 300 to 350, 300 to 400, 300 to 450, 300 to 500, 350 to 400, 350 to 450, 350 to 500, 400 to 450, 400 to 500, or 450 to 500 μm. In some instances, the at least on through-hole has a diameter of about 100, 120, 150, 180, 200, 250, 300, 350, 400, 450, or 500 μm. In some instances, the at least on through-hole has a diameter of at least about 100, 120, 150, 180, 200, 250, 300, 350, 400, or 450 μm. In some instances, the at least on through-hole has a diameter of at most about 120, 150, 180, 200, 250, 300, 350, 400, 450, or 500 μm. In some examples, the at least on through-hole of one or more substrates is connected to one or more manifolds for feeding fluid (e.g., liquid, gas, or both) in and/or out of the fluidic layer between two substrates. In some instance, the diameter of a first through-hole and a second through-hole (e.g., inlet and outlet) are the same. In some instance, the diameter of a first through-hole and a second through-hole (e.g., inlet and outlet) is different. The at least one through-hole may be connected to a manifold of an assembly or system that can deliver or evacuate fluid for processing molecules as further described herein.

In some instances, the device comprises at least two openings (e.g., inlet and outlet). In some instances, in operation, outlet port(s) sit vertically above inlet port(s). In some examples, the device comprises 1 to 25 inlet holes, outlet holes, or both. In some instances, the device comprises 1 to 2, 1 to 5, 1 to 8, 1 to 10, 1 to 12, 1 to 15, 1 to 20, 1 to 22, 1 to 25, 2 to 5, 2 to 8, 2 to 10, 2 to 12, 2 to 15, 2 to 20, 2 to 22, 2 to 25, 5 to 8, 5 to 10, 5 to 12, 5 to 15, 5 to 20, 5 to 22, 5 to 25, 8 to 10, 8 to 12, 8 to 15, 8 to 20, 8 to 22, 8 to 25, 10 to 12, 10 to 15, 10 to 20, 10 to 22, 10 to 25, 12 to 15, 12 to 20, 12 to 22, 12 to 25, 15 to 20, 15 to 22, 15 to 25, 20 to 22, 20 to 25, or 22 to 25 inlet holes, outlet holes, or both. In some instances, the device comprises 1, 2, 5, 8, 10, 12, 15, 20, 22, or 25 inlet holes, outlet holes, or both. In some instances, the device comprises at least 1, 2, 5, 8, 10, 12, 15, 20, or 22 inlet holes, outlet holes, or both. In some instances, the device comprises at most 2, 5, 8, 10, 12, 15, 20, 22, or 25 inlet holes, outlet holes, or both. In some instances, the number and position of inlet holes, outlet holes, or both is varied to bias flow across different regions of the device. However, in some instances, the number of inlet holes and outlet holes are uniform to provide for an unbiased flow. In some instances, inlet holes are uniformly spaced along the bottom of the cavity (formed by the two substrates and a seal, as further described herein). In some instances, the outlet holes are uniformly spaced along the top of the cavity. In some instances, inlet holes are not uniformly spaced along the bottom of the cavity. In some instances, the outlet holes are not uniformly spaced along the top of the cavity. In some instances, uniform flow is attained, provided the inlet and outlet are symmetric. In some examples, uniform flow is attained, provided the inlet and outlet are symmetric, but the spacing between the inlet holes or outlet holes are not uniform.

In some instances, high pressure at one or more openings (e.g., inlet holes) equalizes pressure in a manifold. In some instances, a manifold provides a mechanism for removing bubbles, or to reduce the presence of bubbles in the one or more openings (e.g., inlet holes). In some instances, the diameter of an outlet hole in the flow cell which connects or is connectable to a manifold is larger than the diameter of an inlet hole, e.g., at least about 1-fold larger, at least about 1.5-fold larger, at least about 2-fold larger or at least about 4-fold larger. In some instances, flow through the inlet and/or outlet holes to the manifolds is controlled by providing a valve whose opening and closing is controlled by a controller, such as a micro-processor.

The two substrates comprising functionalized surfaces facing one another may be separated by a seal, for example, a gasket. The seal can comprise a perimeter surface. The perimeter surface may be juxtaposed to the first substrate to form an active surface or an effective active surface. As shown in FIG. 4D, an FFKM Kalrez© gasket can be placed onto the substrate shown in FIG. 4C, where in some instances, the gasket does not overlap or cover the at least one through-hole on the substrate that is it in contact with. The seal placed onto the substrate may define a boundary for a first active area or active surface on the first substrate for association with biomolecules. The active area defined by the perimeter surface of the seal may also referred to as net active area or effective active area. In some instances, the effective active area is substantially circular, square, or rectangular. In some instances, the effective active area is defined by the boundary created by the perimeter surface of the seal or gasket.

In some instances, the effective active area is substantially planar. In some instances, the effective active area has a first length and a second length. In some instances, the first length, the second length or both of the effective active area is about 15 mm to about 40 mm. In some instances, a first length, a second length, or both, is about 15 to 16, 15 to 17, 15 to 18, 15 to 19, 15 to 20, 15 to 21, 15 to 22, 15 to 25, 15 to 28, 15 to 30, 15 to 32, 15 to 35, 15 to 38, or 15 to 40, 18 to 19, 18 to 20, 18 to 21, 18 to 22, 18 to 25, 18 to 28, 18 to 30, 18 to 32, 18 to 35, 18 to 38, or 18 to 40, 20 to 21, 20 to 22, 20 to 25, 20 to 28, 20 to 30, 20 to 32, 20 to 35, 20 to 38, or 20 to 40, 25 to 28, 25 to 30, 25 to 32, 25 to 35, 25 to 38, or 25 to 40, 30 to 32, 30 to 35, 30 to 40, or 35 to 40 mm. In some instances, a first length, a second length, or both, is about 15, 15.5, 16, 16.5, 17, 17.5, 18, 18.5, 19, 19.5, 20, 20.5, 21, 21.5, 22, 25, 28, 30, 32, 35, 38, or 40 mm. In some instances, a first length, a second length, or both, is at least about 15, 15.5, 16, 16.5, 17, 17.5, 18, 18.5, 19, 19.5, 20, 20.5, 21, 21.5, 22, 25, 28, 30, 32, 35, 38, or 40 mm. In some instances, a first length, a second length, or both, is at most about 15.5, 16, 16.5, 17, 17.5, 18, 18.5, 19, 19.5, 20, 20.5, 21, 21.5, 22, 25, 28, 30, 32, 35, 38, or 40 mm. In some examples, as shown in FIG. 4D, the first length of the effective active area of substrate is about 18.6 mm, and the second length of the effective active area of the substrate is about 25.6 mm.

A second substrate may be placed on top of the gasket shown in FIG. 4D. The second substrate can be placed with the functionalized surface facing down towards the first substrate and the gasket. Thus, the second substrate is juxtaposed to the perimeter surface of the seal opposite to the first substrate. This forms a second active area or surface (also referred to as net active area or effective active area).

FIG. 4E provides a view of the back surface of the second silicon chip placed on top of the gasket, which separates the two substrates. In some instances, the seal comprising the perimeter surface between the first substrate and the second substrate forms a cavity enclosed by the first active surface and the second active surface. In some instances, the two substrates are separated by a distance of about 0.1 to 0.5 mm. In some instances, the distance or gap between the two substrates is about 0.1 to 0.15, 0.1 to 0.2, 0.1 to 0.25, 0.1 to 0.3, 0.1 to 0.35, 0.1 to 0.4, 0.1 to 0.45, 0.1 to 0.5, 0.15 to 0.2, 0.15 to 0.25, 0.15 to 0.3, 0.15 to 0.35, 0.15 to 0.4, 0.15 to 0.45, 0.15 to 0.5, 0.2 to 0.25, 0.2 to 0.3, 0.2 to 0.35, 0.2 to 0.4, 0.2 to 0.45, 0.2 to 0.5, 0.25 to 0.3, 0.25 to 0.35, 0.25 to 0.4, 0.25 to 0.45, 0.25 to 0.5, 0.3 to 0.35, 0.3 to 0.4, 0.3 to 0.45, 0.3 to 0.5, 0.35 to 0.4, 0.35 to 0.45, 0.35 to 0.5, 0.4 to 0.45, 0.4 to 0.5, or 0.45 to 0.5 mm. In some instances, the distance or gap between the two substrates is about 0.1, 0.15, 0.2, 0.25, 0.3, 0.35, 0.4, 0.45, or 0.5 mm. In some instances, the distance or gap between the two substrates is at least about 0.1, 0.15, 0.2, 0.25, 0.3, 0.35, 0.4, or 0.45 mm. In some instances, the distance or gap between the two substrates is at most about 0.15, 0.2, 0.25, 0.3, 0.35, 0.4, 0.45, or 0.5 mm. In some instances, the flow cell is a Hele-Shaw flow cell, since the height of the cavity (formed by the two substrates and the seal) is much smaller in comparison to the length and the width. In some instances, the dimensions of the substrate are less than the dimensions of the cavity. In some instances, the dimension of the flow cell is greater than the dimensions of the cavity. In some instances, the gap is formed by machined recesses. In some instances, the gap is formed using shims to set the gap, and the top and bottom are allowed to be machined, and optionally further lapped flat. In some examples, this fabrication can be easier to machine, can result in a more accurate gap size, or both.

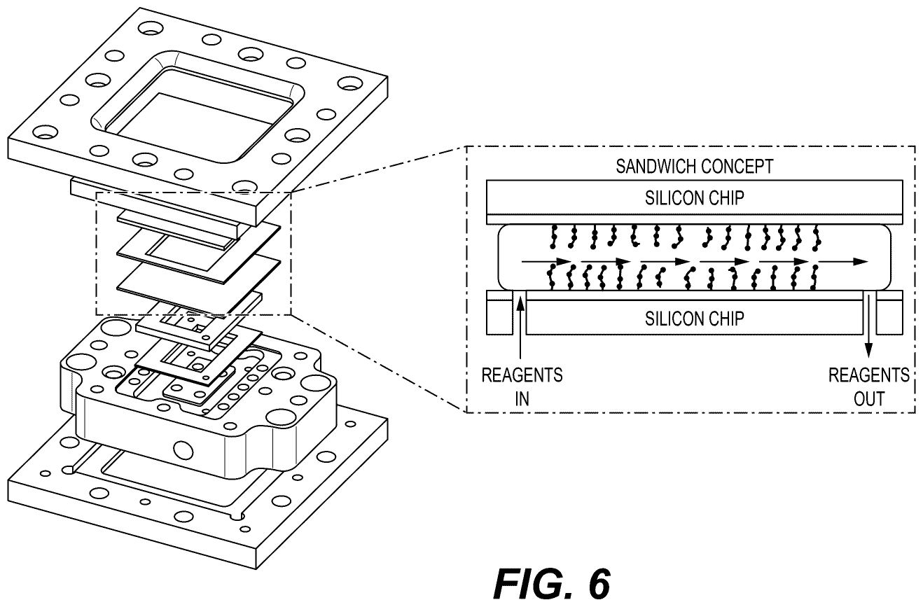

An exemplary schematic of a flow cell assembly comprising a device described herein is shown in FIG. 5. The flow cell assembly can comprise a plurality of components, as shown by the blow-out of the components involved in the assembly of the device (e.g., sandwiched devices shown in FIGS. 4A-4E). In an exemplary embodiment, the assembly is secured in place by an assembly clamp top and screwed in place with M4, 25 mm long screws. A flow cell assembly for processing a plurality of biomolecules comprises the device for processing biomolecules described herein (see, e.g., FIG. 6). The flow cell assembly can further comprise one or more fluidic interfaces. Referring to FIG. 6, the device can comprise at least one through-holes for reagents to enter and/or leave the space between the substrates, which can be connected to one or more manifolds that provide communication between the device and the flow cell assembly or larger external system. In some instances, the assembly further comprises one of more of: a top assembly clamp and a bottom clamp; a support plate; or one or more seals. In some instances, the top assembly clamp and the bottom assembly clamp comprise an aluminum clamp. In some instances, the support plate comprises a glass plate. In some instances, the at least one seal comprises a perfluoroelastomer (FFKM) comprising tetrafluoroethylene (TFE), perfluoromethyl vinyl ether (PMVE), or cure site monomer (CSM), or any combination thereof. In some instances, the at least one through-hole is connected to at least one manifold of a fluidic interface of the one or more fluidic interfaces. In some instances, the flow cell assembly is integrated with an external pressure-driven liquid handling system that helps facilitate delivery of reagents for polynucleotide synthesis on the substrates.

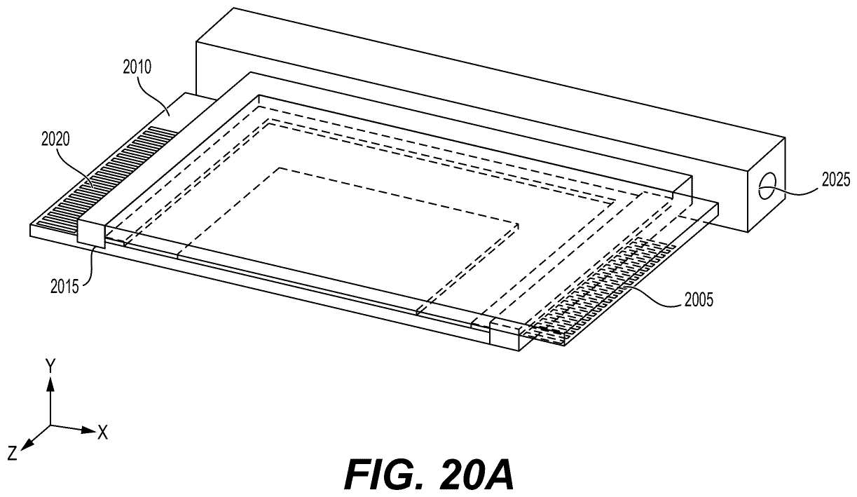

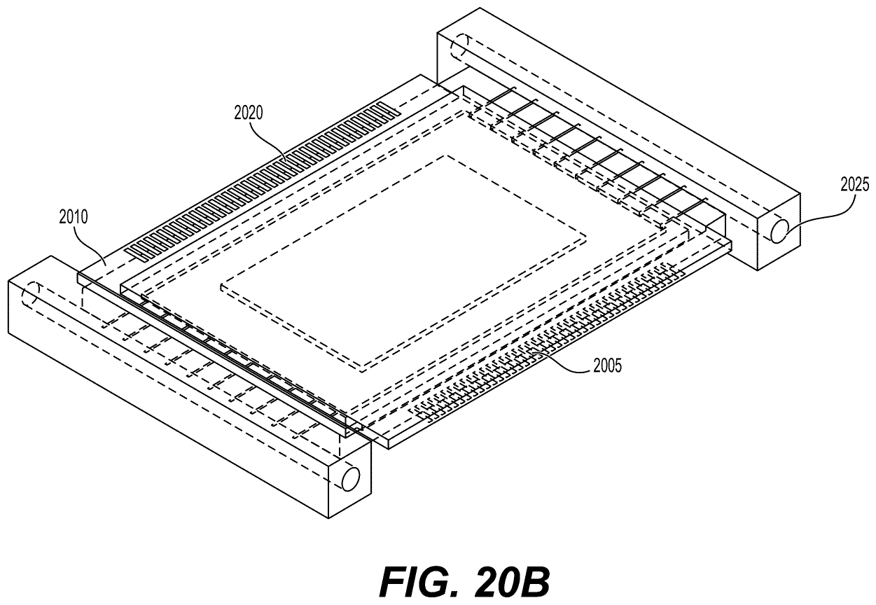

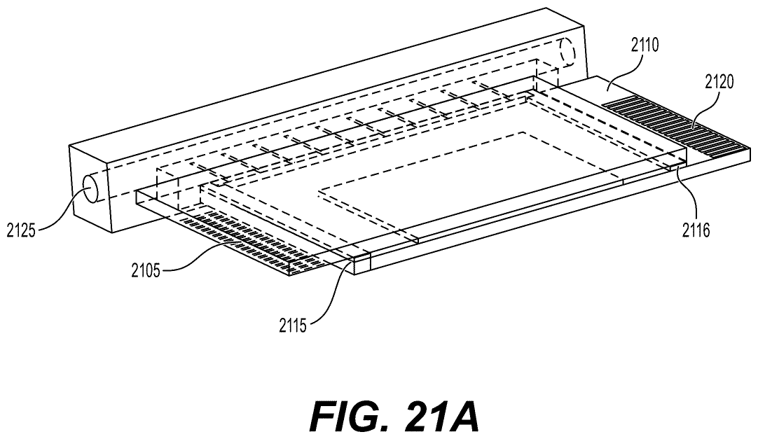

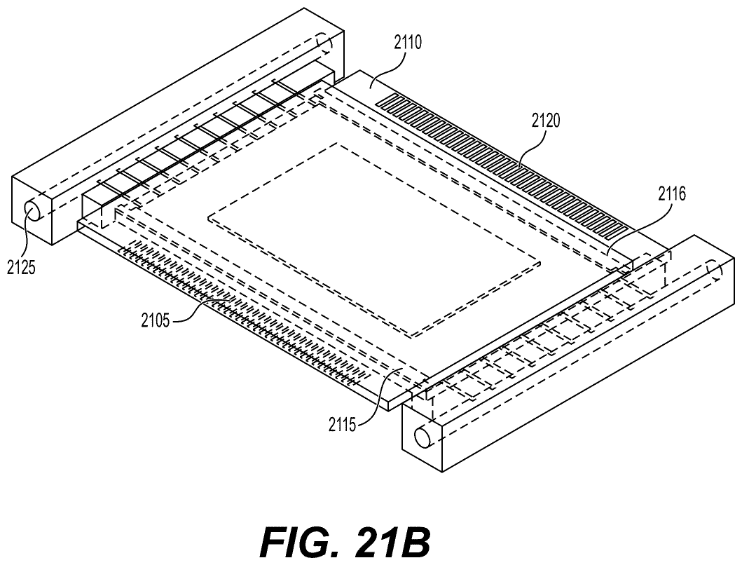

In some further instances, the one or more substrates can be separated by a spacer, such as a frame (e.g., FIGS. 20A-20B) or end pieces (e.g., FIGS. 21A-21B). In some instances, the substrate spacing can be adjusted. For example, the spacing between the substrates can be about 150 to 500 μm. In some examples, the spacing is about 150 to 300, 150 to 400, 150 to 500, 200 to 300, 200 to 400, 200 to 500, 300 to 400, 300 to 500, or 400 to 500 μm. In some examples, the spacing is about 150, 200, 250, 300, 350, 400, 450, or 500 μm. In some examples, the spacing is at least about 150, 200, 250, 300, 350, 400, 450, or 500 μm. In some examples, the spacing is at most about 150, 200, 250, 300, 350, 400, 450, or 500 μm. In some instances, some or all of the one or more substrates comprise contacts, which can be exposed. The contacts can be used to connect with existing pads such as Zebra® connectors, Pogo Pins or wire bonding to a substrate. In some instances, the one or more substrates can be used for electrochemical processing on biomolecules on a substrate. In some examples, the electrochemical processing comprises enzyme based synthesis of polynucleotides, where bonding is more feasible due to aqueous chemistry.

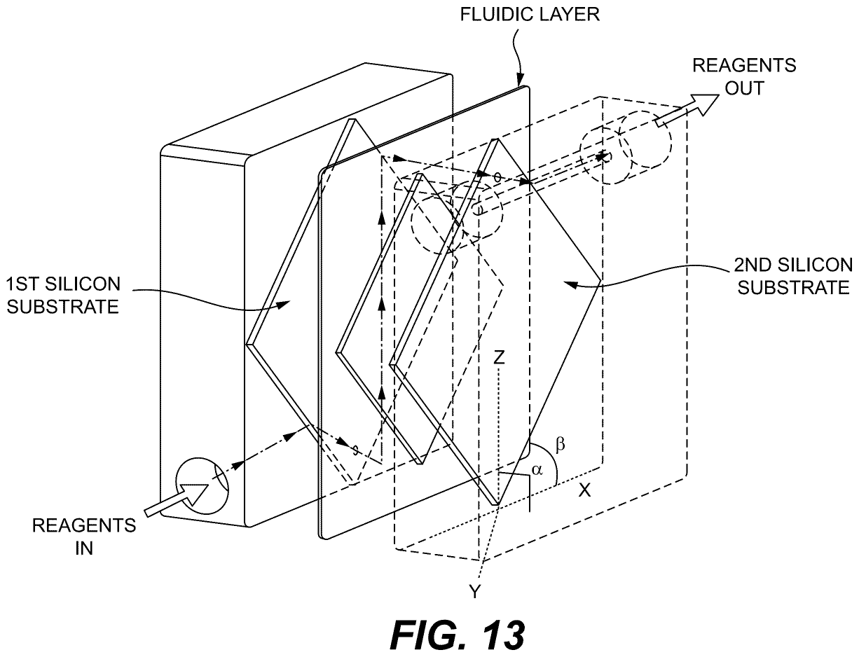

In some instances, the one or more substrates are separated by a frame. In some examples, the one or more substrates are bonded into a machined or molded frame. In some examples, the machined or molded frame comprises one or more fluid ports. In some examples, the frame material comprises plastic or metal. In some examples, gluing features (e.g., glue trough) is provided. In some examples, the assembly can be entirely or partly automated. A cross-section and full schematic of two substrates separated by a frame is provided in FIG. 20A and FIG. 20B, respectively. For example, the active areas on the two substrates 2005 and 2010 face each other with gap set by the frame 2015. In some examples, the substrates are bonded in place and the frame sets the spacing between them. In some instances, a plurality of contacts 2020 are exposed for electrical connection of a substrate, for example, for electrochemical processing of biomolecules on the substrates. In some instances, fluid is introduced through cross manifolds 2025 and/or a plurality of ports, exposing the substrate's active surface to the fluid. In some instances, fluid can similarly be evacuated through the cross manifolds 2025 and/or a plurality of ports, for example, those located opposite to the inlet manifold/ports. In some examples, the plurality of ports are smaller in cross sectional area than the cross manifold to assure even distribution. In some examples, the cross manifold assures even filling and bypass if desired. In some examples, a single port at each corner is used for fluid flow, as shown for example in FIG. 4B. In such example, for adequate flow, the single port at each corner can be oblong in nature to provide added flow area without restriction. In some instances, the assembly illustrated in FIG. 20B can be horizontal, vertical, or titled. For example, referring to the angles defined in FIG. 13, the assembly of FIG. 20B can be oriented such that angle α is about 0° to 90° and/or angle β is about 0° to 60°, as described elsewhere herein. In some instances, the assembly shown in FIG. 20B can be scaled up to a plurality of substrates, each separated by a frame, and may be used for batch or sequential processing of biomolecules on the substrates, as described further herein.

In some instances, the one or more substrates are separated by end pieces. For example, substrates can be bonded with spacing beads and separate fluid port manifolds can be located at each end. In some examples, bonding is done using PSA. A cross-section and full schematic of two substrates separated by end pieces is provided in FIG. 21A and FIG. 21B, respectively. Spacing between two substrates 2105 and 2110 can be set by end pieces 2115 and 2116, and the bond line with glass beads can be glued. Similar to FIGS. 20A-20B, a plurality of contacts 2120 are exposed for electrical connection of a substrate, for example, for electrochemical processing of biomolecules on the substrates. In some instances, fluid is introduced through cross manifolds 2125 and/or a plurality of ports, exposing the substrate's active surface to the fluid. In some instances, fluid can similarly be evacuated through the cross manifolds 2125 and/or a plurality of ports, for example, those located opposite to the inlet manifold/ports. In some examples, manufacturing is less costly or more efficient in the design comprising substrates separated by the end pieces rather than the frame. In some examples, the plurality of ports are smaller in cross sectional area than the cross manifold to assure even distribution. In some examples, the cross manifold assures even filling and bypass if desired. In some examples, a single port at each corner is used for fluid flow, as shown for example in FIG. 4B. In such example, for adequate flow, the single port at each corner can be oblong in nature to provide added flow area without restriction. In some instances, the assembly illustrated in FIG. 20B can be horizontal, vertical, or titled. For example, referring to the angles defined in FIG. 13, the assembly of FIG. 20B can be oriented such that angle α is about 0° to 90° and/or angle β is about 0° to 60°, as described elsewhere herein. In some instances, the assembly shown in FIG. 21B can be scaled up to a plurality of substrates, each separated by end pieces (e.g., spacer beads), and may be used for batch or sequential processing of biomolecules on the substrates, as described further herein.

Further provided herein are devices for processing a plurality of biomolecules comprising a plurality of substrates. The plurality of substrates can be substantially parallel to one another. In some instances, the plurality of substrates can comprise at least two substrates. In some instances, the plurality of substrates can comprise at least three substrates. The device comprising a plurality of substrates (e.g., at least three substrates) may be integrated into a flow cell assembly as described herein (e.g., FIGS. 5-6). In some instances, the device provided herein comprising a plurality of substrates can allow for extrapolation of device comprising two substrates illustrated herein for further scaling up the processing of the plurality of biomolecules. Processing biomolecule on two substrates, which can be substantially parallel (e.g., sandwiched concept described herein), by supplying fluid such as reagents between them can be applied to ‘n’ number of substrates held back-to-back with a common fluidic pathway between them. In some instances, a cartridge-like concept can house the substrates which have both sides functionalized for association with a plurality of biomolecules, acting as active surfaces. In some instances, biomolecule processing is scaled up by altering the fluidic routing. For example, fluids can pass through the substrates from one to the other in a zig-zag manner. In some instances, glass beads can be used as spacers between two chips with bonding achieved by using adhesives, instead of the gasket. In some instances, fluidic routing can be possible via an external circuit without having to drill holes in the chips, with most of or all the components assembled in a common housing.

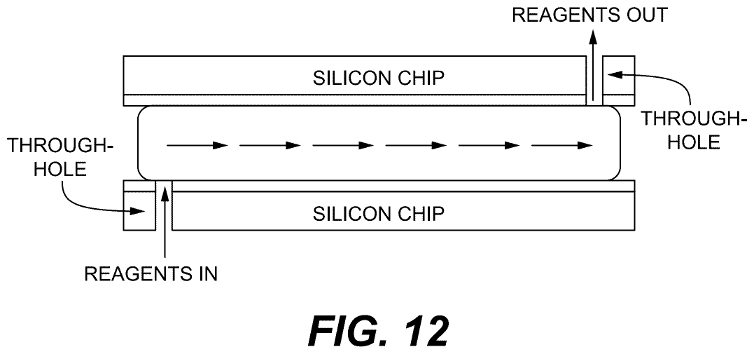

An alternative fluidic routing between two substrates to that of FIG. 3, is shown in the exemplary embodiment of FIG. 12. As shown, fluid can enter the space between two substrates through a first through-hole in the bottom substrate. Fluid can pass through, exposing the bottom surface of the top substrate and the top surface of the bottom substrate to the fluid. As described herein, the fluid may be used to wash the surfaces, alter one or more properties of the surfaces, or process a plurality of biomolecules (e.g., synthesis, cleavage, etc.), as described herein. The fluid can then be evacuated through a second through-hole on the top substrate located opposite or diagonal to the first through-hole. In some instances, this change in fluidic routing compared to FIG. 3) allows for multiplexing more than two substrates in a cartridge.

An exemplary flow cell design is illustrated in FIG. 13, which is adapted for the modified fluidic routing to introduce reagents between two substrates. Fluid, such as reagents, can enter a first manifold of the flow cell assembly, whose surface is juxtaposed to a first substrate or a seal (e.g., gasket) which is juxtaposed to the first substrate. The first manifold is connected to a first through-hole on the first substrate, which allows the fluid to enter the fluidic layer between the two substrates, thereby exposing the surfaces of the substrates facing one another to the fluid. The fluid can then be evacuated through a second through-hole on the second substrate, which is connected to a second manifold of the flow cell. The second substrate can be juxtaposed to the second manifold of the flow cell assembly or a seal (e.g., gasket) which is juxtaposed to the second manifold of the flow cell assembly. The design illustrates in FIG. 13 may be part of the larger flow cell assembly shown in FIG. 5, but with the modified fluidic routing.

One or more angles of the orientation of the flow cell assembly may be adjusted. In some instances, the flow cell assembly is partially or fully vertical during operation. In some instances, “at least partially vertical” refers to an orientation in which a planar surface of the substrate(s) comprising the inlet holes and outlet holes is placed at an angle of greater then about 0° relative to a horizonal plane (x-y plane), as shown in FIG. 13. As shown in FIG. 13, the flow cell can be in a z-axis orientation, so that the plane of the substrate(s) is oriented at an angle α with respect to the horizontal plane. In some instances, angle α is about 0° to 90°. As used herein, angle α refers to the angle between the planar surface of the cavity relative to a horizontal plane, as illustrated in FIG. 13. In some instances, angle α is 0° to 10°, 0° to 20°, 0° to 30°, 0° to 40°, 0° to 50°, 0° to 60°, 0° to 70°, 0° to 80°, 0° to 90°, 10° to 20°, 10° to 30°, 10° to 40°, 10° to 50°, 10° to 60°, 10° to 70°, 10° to 80°, 10° to 90°, 20° to 30°, 20° to 40°, 20° to 50°, 20° to 60°, 20° to 70°, 20° to 80°, 20° to 90°, 30° to 40°, 30° to 50°, 30° to 60°, 30° to 70°, 30° to 80°, 30° to 90°, 40° to 50°, 40° to 60°, 40° to 70°, 40° to 80°, 40° to 90, 50° to 60°, 50° to 70°, 50° to 80°, 50° to 90°, 60° to 70°, 60° to 80°, 60° to 90°, 70° to 80°, 70° to 90°, or 80° to 90°. In some instances, angle α is 0°, 10°, 20°, 30°, 40°, 50°, 60°, 70°, 80°, or 90°. In some instances, angle α is at least 0°, 10°, 20°, 30°, 40°, 50°, 60°, 70°, or 80°. In some instances, angle α is at most 10°, 20°, 30°, 40°, 50°, 60°, 70°, 80°, or 90°.

The planar surface of the substrate(s) may be substantially parallel to a body force. In some examples, the body force comprises a gravitational force, electric force, or magnetic force. In some examples, the body force comprises a fictitious force, such as a centrifugal force, Coriolis force, or Euler force. In some instances, the planar surface of the substrate(s) is substantially parallel to a gravitational force. Referring to FIG. 13, a planar surface of the substrate(s) being substantially parallel to a gravitational force comprises an orientation of the flow cell at an angle α of about 90°.

The flow cell assembly may be placed in a vertical orientation using a stand or base. The flow cell assembly may comprise or may be connectable to a base station or platform to which, in some instances, one or more fluid dispensing stations can be stably associated (e.g., by mounting). In some examples, a mount is used to place the flow cell on a stand or base, such that the flow cell assembly can be oriented at one or more angles.

The flow cell assembly may further be oriented at a second angle. The second angle may be an orientation of the flow cell assembly along the corner of a planar surface of the substrate(s) relative to a horizonal plane, as exemplary illustrated in FIG. 13. This angle may be referred to as angle β. Angle β as used herein refers to the angle formed between the corner of a planar surface of the substrate(s) and the horizontal plane, as illustrated in FIG. 13. In some instances, angle β is about 0°to 60°. In some instances, angle β is 0° to 5°, 0° to 10°, 0° to 15°, 0° to 20°, 0 to 25, 0 to 30, 0° to 35°, 0° to 40°, 0° to 45°, 0° to 50°, 0° to 55°, 0° to 60°, 5° to 10°, 5° to 15°, 5° to 20°, 5° to 25°, 5° to 30°, 5° to 35°, 5° to 40°, 5° to 45°, 5° to 50°, 5° to 55°, 5° to 60°, 10° to 15°, 10° to 20°, 10° to 25°, 10° to 30°, 10° to 35°, 10° to 40°, 10° to 45°, 10° to 50°, 10° to 55°, 10° to 60°, 15° to 20°, 15° to 25°, 15° to 30°, 15° to 35°, 15° to 40°, 15° to 45°, 15° to 50°, 15° to 55°, 15° to 60°, 20° to 25°, 20° to 30°, 20° to 35°, 20° to 40°, 20° to 45°, 20° to 50°, 20° to 55°, 20° to 60°, 25° to 30°, 25° to 35°, 25° to 40°, 25° to 45, 25° to 50°, 25° to 55°, 25° to 60°, 30° to 35°, 30° to 40°, 30° to 45°, 30° to 50°, 30° to 55°, 30° to 60°, 35° to 40°, 35° to 45°, 35° to 50°, 35° to 55°, 35° to 60°, 40° to 45°, 40° to 50°, 40° to 55°, 40° to 60°, 45° to 50°, 45° to 55°, 45° to 60°, 50° to 55°, 50° to 60°, or 55° to 60°. In some instances, angle β is 0°, 5°, 10°, 15°, 20°, 25°, 30°, 35°, 40°, 45°, 50°, 55°, or 60°. In some instances, angle β is at least 0°, 5°, 10°, 15°, 20°, 25°, 30°, 35°, 40°, 45°, 50°or 55°. In some instances, angle β is at most 5°, 10°, 15°, 20°, 25°, 30°, 35°, 40°, 45°, 50°, 55°or 60°. In some instances, the flow cell assembly is oriented at an angle α of about 90°and an angle β of about 45°.

The flow cell assembly may be placed in a vertical orientation and/or rotated using a stand or base. The flow cell assembly may comprise or may be connectable to a base station or platform to which, in some instances, one or more fluid dispensing stations can be stably associated (e.g., by mounting). In some examples, a mount is used to place the flow cell assembly on a stand or base. In some instances, the stand or the base allows the flow cell assembly to be oriented at one or more angles, such as angles α or β as described herein. In some instances, a user or an automated system (e.g., robotic system) is used to adjust or orient the flow cell assembly at one or more angles (e.g., angles α or β). In some instances, angle β is built into the flow cell. In such instances, there may not be a need for an external mount to rotate the flow cell since the cavity (or groove) is built into the flow cell at an angle. In such instances, the true angle β may be zero.

In some instances, when two mediums of different viscosities such as air and liquid interact with each other, the interface can develop instabilities known as the Saffman-Taylor instability. This can cause growing fingers of one phase presented into another phase. The unstable interface between the liquid and air can result in remanent liquid sticking on surfaces within the flow cell assembly, as well as the remanent droplets in the cavity. Orientating the flow cell assembly vertically can reduce instability (e.g., Saffman-Taylor instability) between two phases. In some instances, the instability is resolved partially or fully by making use of gravity as a spatially uniform body force to control the behavior of this air-liquid interface. Orienting the flow cell assembly in a vertical orientation (angle α of 90° and β of 45°) can partially or fully resolve the instability caused by the unstable interface, (e.g., remanent liquid or droplets). Instead, the planar surface of the cavity can be substantially parallel to a body force, creating a stable interface. In some examples, the body force comprises a flow rate dependent inertial force, gravity, or both. In some examples, the body force comprises a summation of a flow rate dependent inertial force and gravity. In some examples, the stability of the air-liquid interface is impacted by the balance of this body force and the surface tension forces present due to the interaction of the interface with the walls and flat surfaces enclosing the cavity. In some instances, the flow cell is oriented at angle α of 90° and β of 45°. In some instances, this angular orientation not only allows for a stable air-liquid interface and smooth extraction of fluid from the cavity, but also resolves a secondary phenomenon related to the interplay between capillary forces and body forces on the fluid present in the one or more manifolds. In some instances, optimizing angle β, for example, angle β is 45°, minimizes the oscillating flow reliably by essentially draining the liquid by tilting and exploiting gravity as a body force to counteract the capillary forces. In some instances, the presence of multiple orifices (e.g., through-holes) and a manifold, such as the twelve holes connected to a collector or a manifold, results in the secondary phenomenon of oscillating flow. In some examples, each through-hole of the multiple through-holes acts as a source for this oscillating flow to develop, which can further increase the volume entrapped in the flow cell. Thus, in some instances, a flow cell comprising a single inlet and single outlet design. In some examples, other process parameters (e.g., angles α or β) are maintained to further simplify the design, minimize this phenomenon, or both.

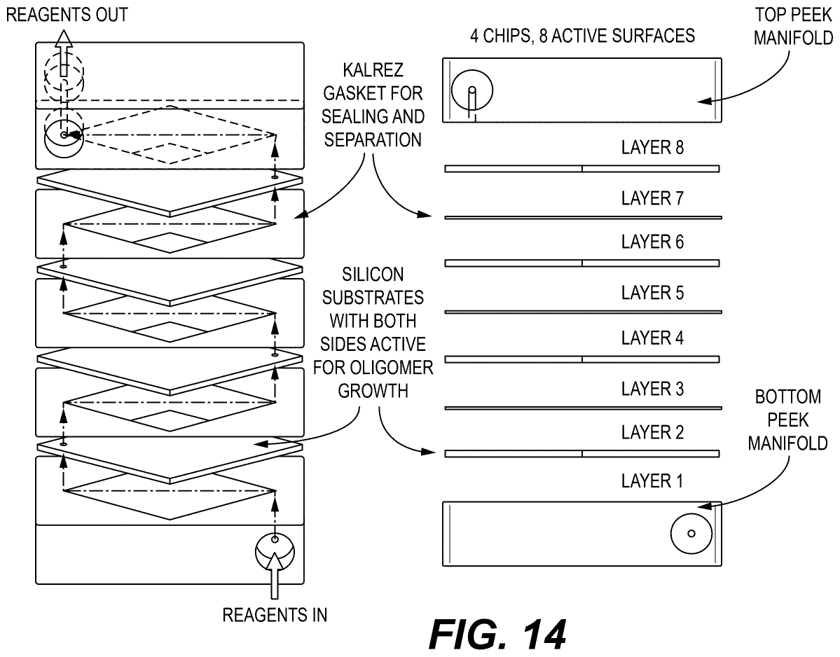

The design comprising the modified fluidic routing may be conducive to scaling up the processing of a plurality of biomolecules. The device for processing a plurality of biomolecules can comprise a plurality of substrates, as illustrates in FIG. 14, which can be substantially parallel or parallel to one another. The plurality of substrates can comprise at least three substrates: a top substrate, a middle substrate, and a bottom substrate. In some instances, as shown in FIG. 14, the device can comprise a plurality of middle substrates, for example two, three, four, five, six, seven, or eight. Each substrate comprises a top surface and a bottom surface. In some instances, the top substrate and the bottom substrate are only functionalized on one side. For example, the top substrate comprises a top surface and a bottom surface, and only the bottom surface is functionalized for association with a building block of the plurality of biomolecule. For example, the bottom substrate comprises a top surface and a bottom surface, and only the top surface is functionalized for association with a building block of the plurality of biomolecule. However, in alternative instances, the top substrate, the bottom substrate, or both, are functionalized on both the top surface and the bottom substrate. In some instances, the middle substrate(s) comprise a top surface and a bottom surface, both of which are functionalized for association with a building block of the plurality of biomolecules.

Each of the substrates of the plurality of substrates can be separated by a seal as illustrated in FIG. 14. The seal can comprise a perimeter surface, which can form a boundary for an active surface on the substrate to which it is juxtaposed. Referring to FIG. 14, the left illustrates multiple substrates arranged in parallel or substantially parallel for multiplexing synthesis on a larger number of substrates. The fluidic routing of the reagents is shown by the arrows providing directionality of the fluid path. In some instances, each of the plurality of substrates comprises at least one through-hole. In some instances, the at least one through-hole on each of the plurality of substrates is located diagonal to the at least one through-hole on an adjacent substrate of the plurality of substrates (e.g., FIG. 12 for exemplary schematic for fluidic routing in a zig-zag manner between two substrates). In some instances, at least one through-hole on each of the plurality of substrates provides fluidic connection between each of the plurality of substrates. In some instances, the at least one through-hole of the top substrate and the at least one through-hole of the bottom substrate each connect to a manifold of a flow cell as shown in FIG. 14. However, in some instances, roles of one or more manifolds may be reversed between or during operation of the flow cell assembly, reversing the directionality of the arrows shown in FIG. 14. In some examples, it is advantageous to introduce a fresh reagent from the top of the flow cell assembly (e.g., such as when the fresh reagent is less dense than the resident liquid). In some instances, a valve can be shut in a manifold (e.g., top manifold) to increase pressure in the manifold for introducing liquid into the flow cell through the outlets and the manifold (e.g., bottom manifold) can be used to vent the flow cell assembly.

The right diagram of FIG. 14 provides a side-view image of the cartridge concept housing multiple substrates and fluidic layers within in the form of a sandwich. In some instances, the substrates can comprise silicon substrates, with both sides active for association with a building block of a biomolecule, such as oligomer growth. In some instances, the seal comprising the perimeter surface is used for creating and sealing the cavity comprising active surface(s), as well as separating substrates from one another. In some examples, the seal comprises a Kalrez gasket. In some instances, the device comprises a number of active surfaces (n) and a number of substrates (m), where the number of active surfaces is twice that of the number of substrates (n=2m). As shown in FIG. 14, the exemplary schematic shows four substrates with eight active surfaces, since both sides of each substrate is functionalized. However, in some instances, only one side of the top or bottom substrate is functionalized. Therefore, in some instances, the number of active surfaces is n=2m−2.

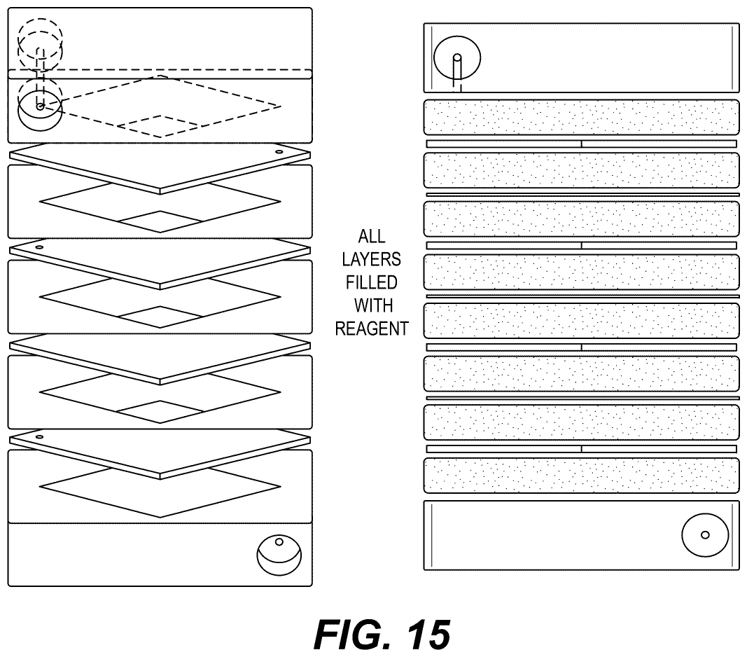

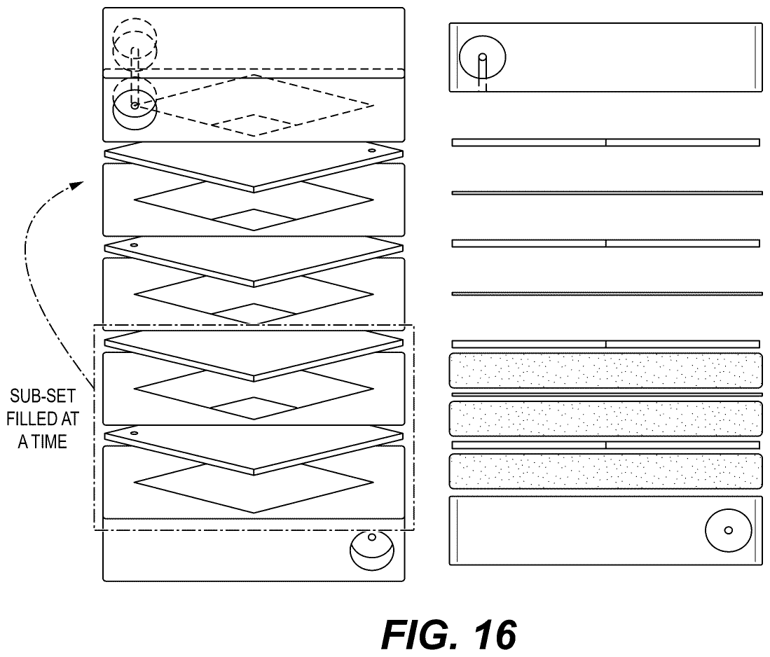

Reagents for biomolecule processing (e.g., polynucleotide synthesis) can fill the layers between the substrates, either fully as shown in FIG. 15 or partially as shown in FIG. 16. In some instances, parallelized operations can be implemented to obtain oligomers from all substrates for the same operation time. In some instances, this parallelized operation uses more reagent, but the turnaround time is decreased compared to other strategies. The concept demonstrating this parallel operation is shown in FIG. 15, where all fluidic layers are filled at the same time and processing of biomolecules can take place in parallel. Filling all the fluidic layers utilizes the maximum amount of fluid but can show the fastest operation time.

In some instances, as shown in FIG. 16, the fluidic layers can be partially filled. FIG. 16 provides a schematic of a batch operation where a sub-set of fluidic layers are filled at a time and processing (e.g., synthesis) occurs in only some of the surfaces of the substrates. In some instances, a control volume of fluids then passes onto the next batch and sequential or serial processing (e.g., synthesis) takes place. This case utilizes a smaller amount of fluid than the parallel operation (e.g., FIG. 15) but can have an increased operation time. In some instances, if reagent use is of specific interest, the cartridge can be operated in a serial manner incorporating batch processing where a unit control volume of reagent moves across two or more sets of substrates or chips. In some instances, a processing step (e.g., synthesis step) occurs between two or more surfaces before moving onto the next batch of substrates. In some instances, this can reduce the volume of reagents used, however, while adding the turnaround time due to the sequential operation protocol.

The volume containable by the flow cell assembly can vary. The volume containable by the flow cell may vary depending on the number of substrates. In some instances, the volume containable by two substrates is about 20 mm³ to about 1000 mm³. For example, the volume enclosed by an active area of a flow cell assembly for two substrates can have dimensions of about 15 mm×15 mm×100 μm, and therefore a volume of about 22.5 mm³. As another example, the volume enclosed by an active area of a flow cell assembly for two substrates can have dimensions of about 40 mm×40 mm×500 μm, and therefore a volume of about 800 mm³. In some instances, the volume containable by two substrates is 20 to 50 mm³, 20 to 100 mm³, 20 to 200 mm³, 20 to 300 mm³, 20 to 400 mm³, 20 to 500 mm³, 20 to 600 mm³, 20 to 700 mm³, 20 to 800 mm³, 20 to 900 mm³, 20 to 1,000 mm³, 50 to 100 mm³, 50 to 200 mm³, 50 to 300 mm³, 50 to 400 mm³, 50 to 500 mm³, 50 to 600 mm³, 50 to 700 mm³, 50 to 800 mm³, 50 to 900 mm³, 50 to 1,000, 100 to 200 mm³, 100 to 300 mm³, 100 to 400 mm³, 100 to 500 mm³, 100 to 600 mm³, 100 to 700 mm³, 100 to 800 mm³, 100 to 900 mm³, 100 to 1,000 mm³, 200 to 300 mm³, 200 to 400 mm³, 200 to 500 mm³, 200 to 600 mm³, 200 to 700 mm³, 200 to 800 mm³, 200 to 900 m³, 200 to 1,000, 300 to 400 mm³, 300 to 500 mm³, 300 to 600 mm³, 300 to 700 mm³, 300 to 800 mm³, 300 to 900 mm³, 300 to 1,000 mm³, 400 to 500 mm³, 400 to 600, 400 to 700 mm³, 400 to 800 mm³, 400 to 900 mm³, 400 to 1,000, 500 to 600 mm³, 500 to 700 mm³, 500 to 800 mm³, 500 to 900, 500 to 1,000 mm³, 600 to 700 mm³, 600 to 800 mm³, 600 to 900 mm³, 600 to 1,000 mm³, 700 to 800 mm³, 700 to 900 mm³, 700 to 1,000 mm³, 800 to 900 mm³, 800 to 1,000 mm³, or 900 to 1,000 mm³. In some instances, the volume containable by two substrates is 20, 50, 100, 200, 300, 400, 500, 600, 700, 800, 900, or 1,000 mm³. In some instances, the volume containable by two substrates is at least 20, 50, 100, 200, 300, 400, 500, 600, 700, 800, or 900 mm³. In some instances, the volume containable by two substrates is at most 50, 100, 200, 300, 400, 500, 600, 700, 800, 900, or 1,000 mm³.

### Systems and Platforms for Biomolecule Processing

A device or flow cell assembly comprising a plurality of substrates as described herein may be integrated into a system for processing molecules. In some instances, processing material comprises synthesizing or extracting biomolecules, such as polynucleotides. In some instances, the flow cell assembly comprises a recess to which a plurality of substrates can be placed and/or enclosed. In some examples, a substrate comprising a plurality of biomolecules is placed in a flow cell and fluidically sealed (e.g., using an O-ring) (e.g., FIG. 6). The biomolecules, such as polynucleotides or proteins can be suspended in solution. In some instances, the system and methods provided herein maximize recovery of liquid from a flow cell (e.g., Hele-Shaw flow cell) by optimizing design and process parameters (e.g., forces acting on the fluid or interface in the flow cell). In some instances, the flow cell assembly comprises a device comprising a plurality of substrates that are substantially parallel as described herein. In some examples, two surfaces facing on another of at least two substrates are functionalized for association with a building block of a biomolecule (e.g., sandwiched concept described herein), separated by a seal to which both of the at least two substrates are juxtaposed. Fluid may be passed through the cavity between the two substrates, creating a fluidic layer and exposing the surfaces of the substrates to the fluid. In some instances, the flow cell assembly is oriented in the system such that a planar surface of the substrates is substantially parallel to a body force in the system.

A system for processing biomolecules, such as polynucleotides can comprise a reservoir or one or more reservoirs. In some instances, the reservoir is connected or connectable to a flow cell assembly. In some examples, referring to FIG. 13, the flow cell or the substrate(s) therein is at an orientation such that α>0°, β>0°, or both. In some examples, the substrate(s) in the flow cell or the substrate(s) therein is at an orientation such that α≤90°, β≤45°, or both. In some examples, the flow cell or the substrate(s) therein is at an orientation such that 0°<α≤90°, 0°<β≤45°, or both. In some examples, the substrate(s) is at an orientation such that a planar surface of the cavity is substantially parallel to a body force, such as gravity. In some instances, the reservoir and the flow cell are stably associated using a base station, platform, or any other suitable equipment (e.g., mounting equipment). In some instances, the reservoir is part of a fluid dispensing assembly that can be employed to dispense fluids (e.g., water, aqueous media, organic solvents, ionic liquids, and the like). In some instances, the system comprises a plurality of reservoirs, each comprising a different fluid. In some instances, the reservoir comprises a liquid for extracting the plurality of biomolecules from the substrate. In some instances, a reservoir of the plurality of reservoirs comprises a reagent for polynucleotide synthesis or extraction. In some examples, a reservoir of the plurality of reservoir comprises a reagent for polynucleotide cleavage.

It shall be understood by one of ordinary skill in the art that the size of a reservoir comprising a fluid may be readily adjusted. The size of a reservoir may be, but is not limited to, about 0.1 mL, 0.2 mL, 0.5 mL, 0.7 mL, 1 mL, 5 mL, 10 mL, 25 mL, 50 mL, 75mL, 100, or about 2 L. In some examples, the size of the reservoir is at least about 0.1 mL, 0.2 mL, 0.5 mL, 0.7 mL, 1 mL, 5 mL, 10 mL, 25 mL, 50 mL, 75 mL, 100 mL, 250 mL, 500 mL, 750 mL, 1 L, 1.25 L, 1.5 L, 1.75 L, or about 2 L. In some examples, the size of the reservoir is at most about 0.2 mL, 0.5 mL, 0.7 mL, 1 mL, 5 mL, 10 mL, 25 mL, 50 mL, 75 mL, or 100 mL, 250 mL, 500 mL, 750 mL, 1 L, 1.25 L, 1.5 L, 1.75 L, or about 2 L. In some examples, the size of the reservoir is about 0.1 mL to 0.2 mL, 0.1 mL to 0.5 mL, 0.1 mL to 0.7 mL, 0.1 mL to 1 mL, 0.1 mL to 5 mL, 0.1 mL to 10 mL, 0.1 mL to 25 mL, 0.1 mL to 50 mL, 0.1 mL to 75 mL, 0.1 mL to 100 mL, 0.1 mL to 250 mL, 0.1 mL to 500 mL, 0.1 mL to 750 mL, 0.1 mL to 1 L, 0.1 mL to 1.25 L, 0.1 mL to 1.5 L, 0.1 mL to 1.75 L, or about 0.1 mL to 2 L, 0.2 mL to 0.5 mL, 0.2 mL to 0.7 mL, 0.2 mL to 1 mL, 0.2 mL to 5 mL, 0.2 mL to 10 mL, 0.2 mL to 25 mL, 0.2 mL to 50 mL, 0.2 mL to 75 mL, 0.2 mL to 100 mL, 0.2 mL to 250 mL, 0.2 mL to 500 mL, 0.2 mL to 750 mL, 0.2 mL to 1 L, 0.2 mL to 1.25 L, 0.2 mL to 1.5 L, 0.2 mL to 1.75 L, or about 0.2 mL to 2 L, 0.5 mL to 0.7 mL, 0.5 mL to 1 mL, 0.5 mL to 5 mL, 0.5 mL to 10 mL, 0.5 mL to 25 mL, 0.5 mL to 50 mL, 0.5 mL to 75 mL, 0.5 mL to 100 mL, 0.5 mL to 250 mL, 0.5 mL to 500 mL, 0.5 mL to 750 mL, 0.5 mL to 1 L, 0.5 mL to 1.25 L, 0.5 mL to 1.5 L, 0.5 mL to 1.75L, or about 0.5 mL to 2 L, 0.7 mL to 1 mL, 0.7 mL to 5 mL, 0.7 mL to 10 mL, 0.7 mL to 25 mL, 0.7 mL to 50 mL, 0.7 mL to 75 mL, 0.7 mL to 100 mL, 0.7 mL to 250 mL, 0.7 mL to 500 mL, 0.7 mL to 750 mL, 0.7 mL to 1 L, 0.7 mL to 1.25 L, 0.7 mL to 1.5 L, 0.7 mL to 1.75 L, or about 0.7 mL to 2 L, 1 mL to 5 mL, 1 mL to 10 mL, 1 mL to 25 mL, 1 mL to 50 mL, 1 mL to 75 mL, 1 mL to 100 mL, 1 mL to 250 mL, 1 mL to 500 mL, 1 mL to 750 mL, 1 mL to 1 L, 1 mL to 1.25 L, 1 mL to 1.5 L, 1 mL to 1.75 L, or about 1 mL to 2 L, 5 mL to 10 mL, 5 mL to 25 mL, 5 mL to 50 mL, 5 mL to 75 mL, 5 mL to 100 mL, 5 mL to 250 mL, 5 mL to 500 mL, 5 mL to 750 mL, 5 mL to 1 L, 5 mL to 1.25 L, 5 mL to 1.5 L, 5 mL to 1.75 L, or about 5 mL to 2 L, 10 mL to 25 mL, 10 mL to 50 mL, 10 mL to 75 mL, 10 mL to 100 mL, 10 mL to 250 mL, 10 mL to 500 mL, 10 mL to 750 mL, 10 mL to 1 L, 10 mL to 1.25 L, 10 mL to 1.5 L, 10 mL to 1.75 L, or about 10 mL to 2 L, 25 mL to 50 mL, 25 mL to 75 mL, 25 mL to 100 mL, 25 mL to 250 mL, 25 mL to 500 mL, 25 mL to 750 mL, 25 mL to 1 L, 25 mL to 1.25 L, 25 mL to 1.5 L, 25 mL to 1.75 L, or about 25 mL to 2 L, 50 mL to 75 mL, 50 mL to 100 mL, or 50 mL to 250 mL, 50 mL to 500 mL, 50 mL to 750 mL, 50 mL to 1 L, 50 mL to 1.25 L, 50 mL to 1.5 L, 50 mL to 1.75 L, or about 50 mL to 2 L, 75 mL to 100 mL, 75 mL to 250 mL, 75 mL to 500 mL, 75 mL to 750 mL, 75 mL to 1 L, 75 mL to 1.25 L, 75 mL to 1.5 L, 75 mL to 1.75 L, or about 75 mL to 2 L, 100 mL to 250 mL, 100 mL to 500 mL, 100 ml to 750 mL, 100 mL to 1 L, 100 mL to 1.25 L, 100 mL to 1.5 L, 100 mL to 1.75 L, 100 mL to 2 L, 250 mL to 500 mL, 250 mL to 750 mL, 250 mL to 1 L, 250 mL to 1.25 L, 250 mL to 1.5 L, 250 mL to 1.75 L, 250 mL to 2 L, 500 mL to 750 mL, 500 mL to 1 L, 500 mL to 1.25 L, 500 mL to 1.5 L, 500 mL to 1.75 L, 500 mL to 2 L, 750 mL to 1 L, 750 mL to 1.25 L, 750 mL to 1.5 L, 750 mL to 1.75 L, 750 mL to 2 L, 1 L to 1.25 L, 1 L to 1.5 L, 1 L to 1.75 L, 1 L to 2 L, 1.25 L to 1.5 L, 1.25 L to 1.75 L, 1.25 L to 2 L, 1.5 L to 1.75 L, 1.5 L to 2 L, or 1.75 L to 2 L.

In some instances, the fluid dispensing assembly comprises a second reservoir for moving fluid to or from a reservoir or a plurality of reservoirs. In some instances, the second reservoir comprises a pressurized reservoir or a pressure feed. In some instances, the second reservoir comprises a pump. In some instances, the second reservoir is used to transfer reagents in and out of the flow cell. However, in some instances, gravity-based draining may be used to remove liquid from the flow cell. In some instances, the fluid dispensing assembly comprises a manifold, a valve assembly, or both. In certain aspects, the assembly comprises a mechanism for delivering predetermined quantities of fluid to the flow cell. The fluids may be dispensed by a pumping mechanism. A standard pumping technique for pumping fluids known in the art may be employed in the system. Non-limiting examples of pumping may comprise means of a peristaltic pump, a pressurized fluid bed, a positive displacement pump, e.g., a syringe pump, and the like. In some examples, the system additionally comprises heating and/or cooling elements and/or insulating elements for controlling the temperature within various fluid reservoir(s), the flow cell assembly, or within the mechanisms for transferring the fluid between the reservoir(s) and flow cell, or any combination thereof. In some examples, a heating element comprises a heating jacket, a cartridge heater, or a film heater.

In some examples, a manifold connects or is connectable to (directly or indirectly) one or more reservoirs. In this way, different fluid reagents can be contacted to a substrate in the flow cell. In some examples, reagents for performing different steps in the synthesis of a chemical compound (e.g., a nucleic acid or polypeptide) may be introduced sequentially into the flow cell.

The flow cell assembly in the system can comprise a top manifold and a bottom manifold, as shown for example in FIGS. 14-16. In some examples, a top manifold and bottom manifold connect to a same one or more reservoirs. In some examples, a top manifold and bottom manifold connect to a different one or more reservoirs. The reservoirs may comprise, a waste reservoir, a sample collection reservoir, or one or more reservoirs, each comprising a different fluid. In some examples, a top manifold and a bottom manifold both connect to a waste reservoir. In some examples, the top manifold, the bottom manifold, or both, comprise a separate waste reservoir. In some examples, the bottom manifold is connected to a sample collection reservoir. In some examples, a top manifold is connected to a sample collection reservoir. In some examples, the bottom manifold is connected to one or more reservoirs, each comprising a different fluid. In some examples, a top manifold is connected to one or more reservoirs, each comprising a different fluid. In some instances, the top manifold connects, or is connectable to, a second reservoir, such as a pump, for displacing fluid from the flow cell. In some instances, the top manifold connects, or is connectable to, a pressurized reservoir for displacing fluid from the flow cell.

Each of the manifolds may be independently controlled. For example, each manifold may comprise a plurality of valves that can open or close paths between components of the system. In some instances, fluid passing through the top manifold, bottom manifold, or both can be independently controlled, e.g., through the use of automatically or manually operated valves. In some instances, the fluid passing through the system is controlled via a controller, which is coupled to one or more actuators that open and close valves connected to the flow cell, first reservoir (e.g., reagent reservoir), or second reservoir (e.g., pump, pressurized reservoir, pressure feed, etc.). In such instances, the controller is used to control the amount or rate of fluid or gas flow throughout the system, including the flow cell assembly.

In some instances, the system comprises a top manifold that communicates with the portion of the flow cell assembly comprising at least one top opening. In some examples, the top manifold comprises a conduit, which communicates with the flow cell assembly comprising at least one top opening. In some instances, the top manifold comprises at least one opening that connect with or are coextensive with the at least one top opening of the flow cell assembly. In some instances, the system comprises a bottom manifold that communicates with the portion of the flow cell assembly comprising at least one bottom opening. In some examples, the bottom manifold comprises a conduit, which communicates with the flow cell comprising at least one bottom opening. A conduit or tube connection one or more components of the system may comprise by way of non-limiting example, PFA, however, may be any suitable material known in the art. Further, the dimensions of such conduit may be, but is not limited to about ¼″, ⅛″ or 1/16″ in diameter. In some instances, the tubing comprises an outside diameter and an inside diameter. In some instances, the inside diameter or the outside diameter is about 1/16″ to 2″. In some instances, the inside diameter or the outside diameter is about 1/16″, ⅛″, ¼″, ½″, 1″, 1½″, or 2″. In some instances, the inside diameter or the outside diameter is at least about 1/16″, ⅛″, ¼″, ½″, 1″, 1½″, or 2″. In some instances, the inside diameter or the outside diameter is at most about 1/16″, ⅛″, ¼″, ½″, 1″, 1½″, or 2″. In some instances, the inside diameter or the outside diameter is about 1/16″ to ⅛″, 1/16″ to ¼″, 1/16″ to ½″, 1/16″ to 1″, 1/16″ to 1½″, or 1/16″ to 2″, ⅛″ to ¼″, ⅛″ to ½″, ⅛″ to 1″, ⅛″ to 1½″, or ⅛″ to 2″, ¼″ to ½″, ¼″ to 1″, ¼″ to 1½″, or ¼″ to 2″, ½″ to 1″, ½″ to 1½″, or ½″ to 2″, 1″ to 1½″, 1″ to 2″, or 1½″ to 2″. In some instances, the bottom manifold comprises at least one opening that connect with or are coextensive with the at least one bottom opening of the flow cell assembly (e.g., FIGS. 14-16). In some instances, when the flow cell assembly is in operation, the top manifold is distal to a surface on which the portion of the flow cell assembly comprising the at least one bottom opening is situated. In some examples, the top manifold can be used to introduce or backfill fluid into a fully charged flow cell assembly.

In some instances, the system comprising the flow cell assembly comprises a plurality of top and bottom submanifolds, which allow fluid (liquid or gas) to into the flow cell by a common top and bottom conduit respectively. In some examples, the plurality of top and bottom submanifolds are connected to one or more separate dispensing lines. In still other aspects, a top and bottom submanifold can be coupled via a common dispensing line, however fluid through the top or bottom manifold can be independently controlled by appropriately placed valves (e.g., through a controller).

The system may further comprise a vacuum source. In some instances, the vacuum source is connected to or in communication with the flow cell assembly. In some instances, the system comprises one or more electronic sensors, mechanical sensors, or both that sense conditions of the flow cell assembly. In some instances, a controller as described herein is programed to regulate flow of fluids in the system through the one or more sensors. In some examples, the system comprises a fluid level sensor, one or more pressure transducers, one or more pressure regulators, manually or automatically operated valves and/or pumps.

The system can further comprise a mechanism for facilitating movement of one or more substrates into and out of a flow cell assembly, as described herein. In a non-limiting example, a system can comprise a lift mechanism for placing substrate(s) into the flow cell assembly and/or lifting the substrate out of the flow cell assembly in a controlled manner, e.g., manually or in an automated fashion.

The system can further comprise mechanism for transferring substrate(s) to and from the system as part of a larger platform for biomolecule processing. Such a platform can comprise one or more components, such as a flow cell assembly comprising substrates as described herein. The flow cell assembly may be a flow cell assembly illustrated in or substantially similar to that illustrated in FIGS. 5-6 comprising biomolecules, a first reservoir (e.g., reagent reservoir), and a second reservoir (e.g., a pump), and any other suitable components of the system described herein. The platform can further comprise an apparatus comprising at least one logic element for performing one or more operations in the platform. In some instances, one or more operations are performed based on sensor data from one or more components of the biomolecule processing system. In some instances, the at least one logic element comprises a programmable logic controller (PLC), programable logic array (PLA), programmable array logic (PAL), generic logic array (GLA), complex programmable logic decide (CPLD), field programable gate array (FPGA), or application-specific integrated circuit (ASIC). Such an apparatus may be in communication with or coextensive with a controller of a system for biomolecule processing, as described herein.

An apparatus in a platform may perform one or more operations, such as (i) determining a timing for opening or closing one or more valves connecting the one or more components, (ii) adjusting one or more parameters of the biomolecule processing system, wherein the one or more parameters comprises a fill rate of the liquid, a volume of the liquid, the liquid, an evacuation rate of the liquid, a capillary number, one or more angles of the flow cell relative to a horizontal plane, or any combination thereof, (iii) determining a recovery efficiency of the liquid evacuated from the cavity comprising biomolecules, or (iv) any combination thereof. In some instances, one or more metrics, parameters, sensor data, or any combination thereof, may be displayed in real time to a user interface. In some instances, one or more metrics, parameters, sensor data, or any combination thereof, may be analyzed in real time to detect anomalies in a system. In some instances, one or more metrics, parameters, sensor data, or any combination thereof, may be stored on the cloud, random access memory, hard-disk drive, solid-state drive, flash memory device, or any variation thereof. In some examples, the apparatus is communicably coupled to a cloud computing resource, which can be used to execute any of the operations provided herein.

In some instances, the platform further comprises one or more components of a data storage system. In some instances, the platform is connected to or coextensive to a data storage system described herein. In some examples, the platform comprises a synthesis module, a sequencing module, an amplification module, or any combination thereof. In some examples, the platform further comprises one or more reservoirs. In some examples, the one or more reservoirs are in connected to the one or more fluidic interfaces. In some examples, the one or more reservoirs hold a fluid for processing the plurality of biomolecules. In some examples, the platform further comprises a controller communicatively coupled to one or more actuators that open and close valves connected to the flow cell assembly.

In some instances, the platform comprises a mechanism for transferring the substrate from the flow cell to another processing device (e.g., a substrate reaction device (e.g., for incubating a substrate with a reactant under reaction conditions, such as a synthesis module, a sequencing module, or an amplification module), a washing device, a scanning device, or any combinations thereof. Such mechanism can also be provided to move the substrate from a printing station (e.g., inkjet printing) to the cavity of the flow cell assembly. Transfer mechanisms can include, but are not limited to, robotic arms, and the like, which can be controlled by an apparatus and/or controllers, as described herein. In some instances, a transfer robot is mounted on a platform of an apparatus used in for synthesis. The transfer robot may include a base, an arm that is movably mounted on the base, and a grasping element adapted to grasp the substrate during transport that is attached to the arm. The element for grasping the substrate may be, for example, movable finger-like projections, and the like. In one aspect, in use, the robotic arm is activated so that the substrate is grasped by the grasping element. The arm of the robot is moved so that the substrate is delivered to the flow cell from a printing device. Other componentry may be used to position the substrate, e.g., motors, pistons, conveyers, cranks, levers, etc., where such will be obvious to those of skill in the art in view of the disclosure. As noted above, in some instances, a substrate may be positioned on a substrate holder or lift mechanism within the chamber of the flow cell assembly. In some instances, the holder may be adapted to be moveable to position the substrate appropriately.

### Methods for Processing Biomolecule

The devices, systems, or platforms described herein can be used to process molecules. In some instances, the methods for processing molecules employ a flow cell assembly described herein. In some instances, methods are developed to optimize one or more conditions or parameters of a device, system, or platform comprising a flow cell assembly. The flow cell assembly can have a plurality of substrates that are parallel or substantially parallel. The surface(s) of the substrates can comprise be functionalized with molecules or comprise biomolecules that have been synthesized, as described herein. The molecules can comprise, but are not limited to, polymers (e.g., peptides, proteins, nucleic acids, or mimetics thereof, e.g., peptide nucleic acids, LNA, UNA molecules), polysaccharides, phospholipids, or any combination thereof, where the polymers may be hetero- or homopolymeric. In some examples, the substrate comprises cells or tissue sections stably immobilized thereto. In some instances, a plurality of substrate is placed in the flow cell assembly manually. In some instances, a plurality of substrate is placed in the flow cell assembly using an automated system. The automated system may comprise, but is not limited to, a transfer mechanism (e.g., robotic system, such as a robotic arm) described herein. In some instances, a method for processing a plurality of biomolecules comprises: (a) providing a flow cell assembly; (b) filling at least a portion of the flow cell assembly with a fluid; and (c) evacuating the fluid from at least the portion of the flow cell assembly.

The flow cell assembly can comprise a plurality of components. In some instances, the flow cell assembly comprises a device comprising a plurality of substrates such as those described herein, as well as one or more fluidic interfaces. In some instances, the plurality of substrates is substantially parallel or parallel to one another. In some examples, the plurality of substrates comprises at least two substrates. The substrates can each comprise a surface functionalized, either partially or fully, for association with a building block of the biomolecules. A device for processing a plurality of biomolecules can comprise a first substrate comprising a first surface functionalized for association with a first building block of the plurality of biomolecules; and a second substrate comprising a second surface functionalized for association with a second building block of the plurality of biomolecules. In some instances, the second surface faces the first surface (e.g., sandwich design). In some instances, the two substrates may be parallel or substantially parallel to one another. The device may comprise a substrate design illustrated in the figures provided herein, for examples, FIG. 1B, FIGS. 2-3, or FIG. 12. The device may be assembled into a flow cell assembly described herein, for example, FIGS. 5-6 or FIG. 13. The flow cell assembly may comprise a plurality of substrates as illustrated in FIG. 14.

In some instances, filling at least a portion of the flow cell assembly comprises filling at least one cavity between two substrates of the plurality of substrates. In some instances, all cavities between substrates of the plurality of substrates are filled. An exemplary schematic is shown in FIG. 15, in which all layers are filled with a fluid, such as a reagent. In some instances, a subset of cavities between substrates of the plurality of substrates is filled. An exemplary schematic is shown in FIG. 16, in which only a subset of layers is filled with a fluid, such as a reagent.

In some instances, evacuating the fluid from at least the portion of the flow cell assembly comprises evacuating the at least one cavity between two substrates of the plurality of substrates. In some instances, fluid in all cavities between substrates of the plurality of substrates are evacuated. In some instances, fluid in a subset of cavities between substrates of the plurality of substrates is evacuated. Referring to FIG. 14, in some instances, fluid is evacuated through an outlet of the flow cell assembly located opposite to the inlet used to fill reagents. In alternative instances, however, the inlet and the outlet are located on the same side or manifold of the flow cell assembly. In an exemplary embodiment, the fluid may be filled and evacuated following the fluid path indicated by the arrows of FIG. 14.

The methods described herein for processing biomolecule can be used for biomolecule synthesis. For example, repeating operations comprising filling and evacuating one or more cavities between substrates of a plurality of substrates in a flow cell assembly can synthesize a plurality of biomolecules. In some instances, the fluid comprises a reagent for synthesis of the plurality of biomolecules. In some instances, the plurality of biomolecules comprises a plurality of polynucleotides. In some examples, the reagent comprises a reagent for one or more of: (i) coupling; (ii) capping; (iii) oxidizing; (iv) deblocking; or (v) washing.

The methods described herein for processing biomolecules can be used for biomolecule extraction. In some instances, the fluid can comprise a reagent for removing or cleaving a plurality of biomolecules on a surface of a substrate in a flow cell assembly. In some examples, the fluid removes the biomolecules from the active surface formed by the perimeter surface of a seal juxtaposed to a functionalized surface of a substrate. In some instances, removing the plurality of biomolecules comprises cleaving the association with the building block of the plurality of biomolecules. In some instances, evacuating the fluid comprises evacuating the plurality of biomolecules from the active surface on each surface of the plurality of substrates or a portion thereof.

In some instances, the fluid can be filled or evacuated at a rate of about 0 to 50 μL/s. In some instances, the fill rate or evacuation rate is about 0 to 0.5, 0 to 1, 0 to 2.5, 0 to 5, 0 to 10, 0 to 15, 0 to 20, 0 to 25, 0 to 30, 0 to 50, 0.5 to 1, 0.5 to 2.5, 0.5 to 5, 0.5 to 10, 0.5 to 15, 0.5 to 20, 0.5 to 25, 0.5 to 30, 0.5 to 50, 1 to 2.5, 1 to 5, 1 to 10, 1 to 15, 1 to 20, 1 to 25, 1 to 30, 1 to 50, 2.5 to 5, 2.5 to 10, 2.5 to 15, 2.5 to 20, 2.5 to 25, 2.5 to 30, 2.5 to 50, 5 to 10, 5 to 15, 5 to 20, 5 to 25, 5 to 30, 5 to 50, 10 to 15, 10 to 20, 10 to 25, 10 to 30, 10 to 50, 15 to 20, 15 to 25, 15 to 30, 15 to 50, 20 to 25, 20 to 30, 20 to 50, 25 to 30, 25 to 50, or 30 to 50 μL/s. In some instances, the fill rate or evacuation rate is about 0, 0.5, 1, 2.5, 5, 10, 15, 20, 25, 30, or 50 μL/s. In some instances, the fill rate or evacuation rate is at least about 0, 0.5, 1, 2.5, 5, 10, 15, 20, 25, or 30 μL/s. In some instances, the fill rate or evacuation rate is at most about 0.5, 1, 2.5, 5, 10, 15, 20, 25, 30, or 50 μL/s.

In some examples, the flow cell assembly is oriented such that a planar surface of the cavity is substantially parallel to a body force, such as gravity. Referring to FIG. 13, in some examples, the flow cell assembly is oriented such that α>0°, β>0°, or both. In some examples, the flow cell assembly is oriented such that α≤90°, β≤45°, or both. In some examples, the flow cell assembly is oriented such that 0°<α≤90°, 0°<β≤45°, or both. The fluid may comprise one or more properties suitable for use in the flow cell assembly or device described herein. The one or more properties may comprise, by way of non-limiting example, surface tension, viscosity, density, vapor pressure, capillarity, cavitation, specific weight, specific volume, specific gravity, temperature, or pressure.

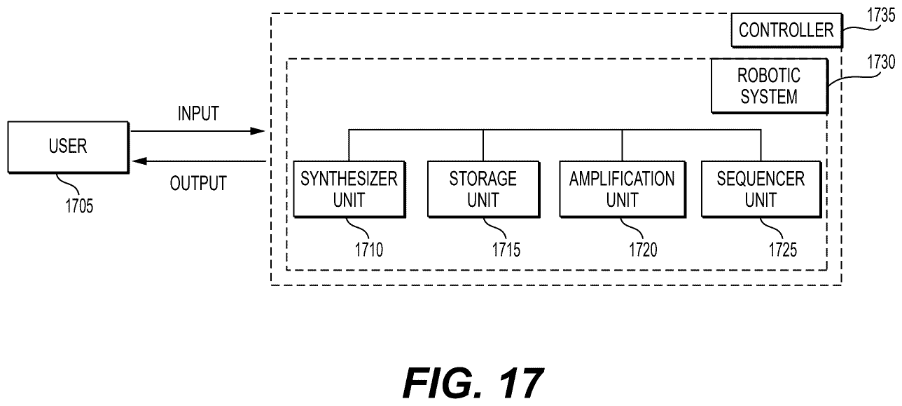

The method can further comprise collecting the liquid comprising the plurality of biomolecules. In some instances, biomolecules are collected in a sample collector. In some examples, the method comprises heating the extracted liquid in the sample collector, using the systems and methods described herein. In some examples, the sample collector comprises an intermediate compartment for transferring biomolecules for further processing or storage. In some examples, the sample collector comprises a storage compartment for storage of the biomolecules. The biomolecules may be stored in systems and platforms, for example, for DNA data storage, such as those provided herein (e.g., FIG. 17).

### Nucleic Acid Based Information Storage

Provided herein are devices, compositions, systems, and methods for nucleic acid-based information (data) storage. In some instances, the devices, compositions, platforms, systems, or methods provided herein are used for DNA data storage of biomolecules that have been extracted from a substrate. A biomolecule such as a DNA molecule provides a suitable host for storage of information, such as digital information, in-part due to its stability over time and capacity for enhanced information coding, as opposed to traditional binary information coding. In addition, a biomolecule such as a DNA molecule can provide high volumetric storage density. In a first step, a digital sequence encoding an item of information (e.g., digital information in a binary code for processing by a computer) is received. The digital sequence can comprise a first plurality of symbols, such a binary, octal, decimal, or hexadecimal data. An encryption scheme is applied to convert the digital sequence from the first string of symbols to a second string of symbols. The second string of symbols can comprise an alternative representation to the first string of symbols. In some examples, the second string of symbols comprises a nucleic acid sequence.

Once an item of information is converted to a nucleic acid sequence, the nucleic acids can be synthesized. A surface material for nucleic acid extension, a design for loci for nucleic acid extension (aka, arrangement spots), and reagents for nucleic acid synthesis are selected. The surface of a structure is prepared for nucleic acid synthesis. De novo polynucleotide synthesis is then performed. The synthesized polynucleotides can be extracted, in whole or in part, using the systems, devices, methods, or platforms provided herein. The synthesized polynucleotides are stored in a structure and, in some cases, are available for subsequent release, in whole or in part. The synthesized polynucleotides may be stored in a structure suitable for long term storage (e.g., weeks, months, years, etc.). A structure suitable for long term storage may be identifiable and/or capable of being catalogues, such as, for example, using a tag (e.g., barcode or RFID tag). Once released, the polynucleotides, in whole or in part, are sequenced, subject to decryption to convert nucleic sequence back to digital sequence. The digital sequence is then assembled to obtain an alignment encoding for the original item of information.

### Items of Information

Optionally, an early step of data storage process disclosed herein includes obtaining or receiving one or more items of information in the form of an initial code. In some instances, the items of information are encoded as a plurality of polynucleotides that have been extracted from a substrate, using systems, methods, platforms, or devices provided herein. Items of information (e.g., digital information) include, without limitation, text, audio, and visual information. Exemplary sources for items of information include, without limitation, books, periodicals, electronic databases, medical records, letters, forms, voice recordings, animal recordings, biological profiles, broadcasts, films, short videos, emails, bookkeeping phone logs, internet activity logs, drawings, paintings, prints, photographs, pixelated graphics, and software code. Exemplary biological profile sources for items of information include, without limitation, gene libraries, genomes, gene expression data, and protein activity data. Exemplary formats for items of information include, without limitation, .txt, .PDF, .doc, .docx, .ppt, .pptx, .xls, .xlsx, .rtf, .jpg, .gif, .psd, .bmp, .tiff, .png, and .mpeg. The amount of individual file sizes encoding for an item of information, or a plurality of files encoding for items of information, in digital format include, without limitation, up to 1024 bytes (equal to 1 KB), 1024 KB (equal to 1 MB), 1024 MB (equal to 1 GB), 1024 GB (equal to 1 TB), 1024 TB (equal to 1 PB), 1 exabyte, 1 zettabyte, 1 yottabyte, 1 xenottabyte or more. In some instances, an amount of digital information is at least 1 gigabyte (GB). In some instances, the amount of digital information is at least 1, 2, 3, 4, 5, 6, 7, 8, 9, 10, 20, 50, 100, 200, 300, 400, 500, 600, 700, 800, 900, 1000 or more than 1000 gigabytes. In some instances, the amount of digital information is at least 1 terabyte (TB). In some instances, the amount of digital information is at least 1, 2, 3, 4, 5, 6, 7, 8, 9, 10, 20, 50, 100, 200, 300, 400, 500, 600, 700, 800, 900, 1000 or more than 1000 terabytes. In some instances, the amount of digital information is at least 1 petabyte (PB). In some instances, the amount of digital information is at least 1, 2, 3, 4, 5, 6, 7, 8, 9, 10, 20, 50, 100, 200, 300, 400, 500, 600, 700, 800, 900, 1000 or more than 1000 petabytes. In some instances, the digital information does not contain genomic data acquired from an organism. Items of information in some instances are encoded. Non-limiting encoding method examples include 1 bit/base, 2 bit/base, 4 bit/base or other encoding method.

### DNA Data Storage

The devices, systems, or platforms provided herein for biomolecule processing may be integrated in a data storage system. A system for data storage can comprise one or more modules. In some instances, the some or all of the one or more modules are in communication. In some examples, some or all of the one or more modules are in communication to allow transferring of polynucleotides between them. In some examples, some or all of the one or more modules are fluidically coupled. In some examples, some or all of the one or more modules are fluidically coupled with one or more tubes. A fluid may generally refer to one or more liquids used in various processes involved in handling polynucleotides, including, without limitation, synthesis, amplification, preparation for sequencing, and sequencing. In some examples, some or all of the modules are in communication to allow transferring of control commands between modules of the system. In some examples, some or all of the one or more modules are electronically coupled. A module in the system can comprise, without limitation, a synthesizer unit, an amplification chamber, a sequencer unit, a storage unit, a controller, a robotic system, or any combination thereof. In some examples, a module can further comprise a fluid source, a database, or a file system, or both. In some examples, the database or file system keeps track of the storage capacity of the system. For example, the database or file system can keep track of available racks (or trays), slots (for capsules), or both. In some examples, the database or the file system is used to determine the disposition of the rack within the storage system. In some instances, movement of polynucleotides between one or more modules of a system is accomplished by one or more tubes or a robotic system. In some examples, the database or the file system is used to direct the robotic system to the correct position in the storage system. In some instances, the system is autonomous.

A data storage system may be a control system. A control system may generally refer to a framework to coordinate operations between protocols, connections, modules, and devices, so they may be executed properly and on schedule. In some embodiments, the operations may be executed with one or more logic elements comprising a programmable logic controller (PLC), programable logic array (PLA), programmable array logic (PAL), generic logic array (GLA), complex programmable logic decide (CPLD), field programable gate array (FPGA), or application-specific integrated circuit (ASIC). The control system may comprise one or more network communication protocols that may be standard network communication protocols, non-standard network communication protocols, or any combination thereof. In some embodiments, the standard network communication protocols are process field bus (Profibus), process field net (Profinet), highway addressable remote transducer (HART), distributed network protocol (DNP3), Modbus, open platform communication (OPC), building automation and control networks (BACnet), common industrial protocol (CIP), or ethernet for control automation technology (EtherCAT). A data storage system may include industrial, manufacturing, or processing facilities. Such facilities may support objectives on a mass-scale, such as synthesizing, storing, or retrieving information stored in biomolecules. A data storage system may comprise one or more of PLCs, remote terminal units, intelligent electronic devices, engineering workstations, human machine interfaces (HMIs), data historians, communication gateways, and front-end processors. In some embodiments, a data storage system may have different controllable states as steps of a process. In some embodiments, a data storage system may use an open communication protocol.

A non-limiting example of a system for data storage is illustrated in FIG. 17, with a feedback loop. A feedback loop may generally comprise a user 1705 that can interact with a system via a controller 1735 (e.g., PLC), for example, through a human-machine interface (HMI). The HMI may be a user interface (e.g., GUI) that connects a person or a user to one or more components (e.g., equipment, network, etc.) in the system. In some instances, a user may send an input, for example, as a query, to the controller 1735, regarding the state or function of components of the system. In some instances, the query is related to an item of information, whole or in part, that is stored in the system, such as the location, duration, or metadata of the information stored in the system.

The controller 1735 may send an output to a user 1705. The output can comprise a response to the query, which can be provided through an HMI and may be displayed on the user interface. In some instances, the controller 1735 sends status information regarding components of the ICS to the HMI and it is provided to the user 1705. In some instances, the controller 1735 implements control strategies using a system comprising a microprocessor for managing components in the system.

In some cases, the components may be a physical device, such as equipment in the system. The physical devices can be a device employed for storage or retrieval information in biomolecules. For example, physical devices can be part of a synthesizer unit 1710, storage unit 1715, amplification unit 1720, or sequencer unit 1725. In some examples, physical devices comprise one or more components illustrated, for example in FIGS. 5-6 or FIGS. 13-14 for processing biomolecules from a flow cell assembly comprising a plurality of substrates. In some examples, physical devices can comprise a robotic system 1730, which can be used for transferring or handling biomolecules in the system. In some cases, the equipment may be on-site or remote. In some examples, the controller 1735 control a physical device or a plurality thereof, such as control motors, valves, switches, etc., in the system.

A controller 1735 may controls a physical device based on one or more measurements obtained from sensors in the system. In some instances, sensors are integrated into one or more modules (e.g., a synthesizer unit 1710, storage unit 1715, amplification unit 1720, or sequencer unit 1725, robotic system 1735, flow cell assembly, or biomolecule processing systems, etc.). In some instances, sensors determine when and how the physical device should operate. For example, the sensor may be an integrated sensor as part of a control device comprising an actuator. In some cases, the measurements may be physical measurements obtained from sensors, such as pressure, volume, temperature, humidity, torque, vacuum, motion, flow rate (e.g., fill rate or evacuation rate), angles of orientation of devices (e.g., flow cells), etc. In some cases, the sensor is a standalone sensor. In further instances, the controller 1735 receives commands for the physical device to perform functions (e.g., pump actuation, stirrer operation, conveyor belt operation, etc.) from a user 1705, for example through an HMI.

The data from operations or sensors in the system, as described herein, may be fed into one or more software modules for analyzing data in the storage system. For example, the data may be sensor data from one or more compartments or modules in the system, and an algorithm may be used to monitor one or more parameters. In some examples, the algorithm monitors patterns in the sensor data and can be used to detect anomalies, for example, irregular sensor data from one or more compartments and optionally, alert a user through an HMI. As another example, the data may be an item of information or sequencing data and an algorithm may be used to convert the data to another format (e.g., convert an item of information to a nucleic acid sequence, or vice versa). In some examples, the algorithm comprises an error correction scheme that can be used to correct errors that have occurred during processes in the data storage system.

A system for data storage may comprise a synthesizer unit 1710. A synthesizer unit can be used to synthesize a plurality of polynucleotides encoding digital information. In some instances, the system comprises more than one synthesizer units 1710. In some instances, the synthesizer unit 1710 comprises a flow cell assembly for processing biomolecules described herein (e.g., FIG. 14). Polynucleotides may be synthesized using a method provided herein or any other suitable synthesis method known in the art. The fluidic and/or electronic control of polynucleotide synthesis in the synthesizer unit 1710 may be performed by a controller 1735. In some instances, the electronics in the synthesizer unit 1710 are in communication with the controller 1735. In some instances, the synthesizer unit 1710 has an input for receiving DNA sequences. In some instances, the synthesizer unit 1710 has an input for receiving fluids for polynucleotide synthesis. In some instances, the synthesizer unit 1710 has an output for eluting synthesized polynucleotides. In some instances, the synthesized polynucleotides are transferred to another component of the system, such as, by way of non-limiting example, a storage unit, an amplification chamber, or a sequencing unit.

A flow cell assembly, or a system or platform comprising a flow cell assembly, may be connected to, part of, or coextensive with one or more components of the system, such as the synthesizer unit 1710, storage unit 1715, amplification unit 1720, or sequencer unit 1725. In some examples, once the polynucleotides are cleaved from the surface, they are collected and transferred to another component of the system, such as, by way of non-limiting example, storage unit 1715, amplification unit 1720, or sequencer unit 1725. In some instances, the flow cell assembly is oriented to maximize the recovery of liquid, for example, by adjusting angles α or β (as shown in FIG. 13) as defined herein. Further, an apparatus comprising at least one logic element for performing one or more operations of a biomolecule processing platform, as provided herein may be in communication with or may be part of a controller 1735 of a larger data storage system.

A synthesizer unit may comprise a solid support. The solid support may comprise a surface for polynucleotide synthesis. In some instances, the solid support, the surface, or both comprise a material described herein. In some instances, the material comprises a metal or organic polymer. In some instances, the material comprises steel (e.g., stainless steel) or other metal alloy. In some instances, the material comprises polyethylene, polypropylene, or other polymer. In some instances, the structure comprises a flexible material, such as those provided herein. Exemplary flexible materials include, without limitation, modified nylon, unmodified nylon, nitrocellulose, and polypropylene. In some instances, the materials comprise a rigid material, such as those provided herein. Exemplary rigid materials include, without limitation, glass, fuse silica, silicon, silicon dioxide, silicon nitride, plastics (for example, polytetrafluoroethylene, polypropylene, polystyrene, polycarbonate, and blends thereof, and metals (for example, steel, gold, platinum). In some instances, materials disclosed herein may be fabricated from a material comprising silicon, polystyrene, agarose, dextran, cellulosic polymers, polyacrylamides, polydimethylsiloxane (PDMS), glass, or any combination thereof. In some examples, materials disclosed herein are manufactured with a combination of materials listed herein or any other suitable material known in the art.

In some instances, the solid support has varying dimensions. In some instances, a size of the solid support is between about 40 and 120 mm by between about 25 and 100 mm. In some instances, a size of the solid support is about 80 mm by about 50 mm. In some instances, a width of a solid support is at least or about 10 mm, 20 mm, 40 mm, 60 mm, 80 mm, 100 mm, 150 mm, 200 mm, 300 mm, 400 mm, 500 mm, or more than 500 mm. In some instances, a height of a solid support is at least or about 10 mm, 20 mm, 40 mm, 60 mm, 80 mm, 100 mm, 150 mm, 200 mm, 300 mm, 400 mm, 500 mm, or more than 500 mm. In some instances, the solid support has a planar surface area of at least or about 100 mm²; 200 mm²; 500 mm²; 1,000 mm²; 2,000 mm²; 4,500 mm²; 5,000 mm²; 10,000 mm²; 12,000 mm²; 15,000 mm²; 20,000 mm²; 30,000 mm²; 40,000 mm²; 50,000 mm² or more. In some instances, the thickness of the solid support is between about 50 mm and about 2000 mm, between about 50 mm and about 1000 mm, between about 100 mm and about 1000 mm, between about 200 mm and about 1000 mm, or between about 250 mm and about 1000 mm. Non-limiting examples thickness of the solid support include 275 mm, 375 mm, 525 mm, 625 mm, 675 mm, 725 mm, 775 mm and 925 mm. In some instances, the thickness of the solid support is at least or about 0.5 mm, 1.0 mm, 1.5 mm, 2.0 mm, 2.5 mm, 3.0 mm, 3.5 mm, 4.0 mm, or more than 4.0 mm.

In some instances, two or more solid supports are assembled. In some instances, solid supports are interfaced together on a larger unit. Interfacing may comprise exchange of fluids, electrical signals, or other medium of exchange between solid supports. This unit is capable of interface with any number of servers, computers, or networked devices. For example, a plurality of solid support is integrated onto a rack unit, which is conveniently inserted or removed from a server rack. The rack unit may comprise any number of solid supports. In some instances, the rack unit comprises at least 1, 2, 5, 10, 20, 50, 100, 200, 500, 1000, 2000, 5000, 10,000, 20,000, 50,000, 100,000 or more than 100,000 solid supports. In some instances, two or more solid supports are not interfaced with each other. Polynucleotides (and the information stored in them) present on solid supports can be accessed from the rack unit. Access includes removal of polynucleotides from solid supports, direct analysis of polynucleotides on the solid support, or any other method which allows the information stored in the polynucleotides to be manipulated or identified. Information in some instances is accessed from a plurality of racks, a single rack, a single solid support in a rack, a portion of the solid support, or a single locus on a solid support. In various instances, access comprises interfacing polynucleotides with additional devices such as mass spectrometers, HPLC, sequencing instruments, PCR thermocyclers, or other device for manipulating polynucleotides. Access to nucleic acid information in some instances is achieved by cleavage of polynucleotides from all or a portion of a solid support. Cleavage in some instances comprises exposure to chemical reagents (ammonia or other reagent), electrical potential, radiation, heat, light, acoustics, or other form of energy capable of manipulating chemical bonds. In some examples, one or more orientations of the flow cell has been optimized to maximize a liquid comprising the polynucleotides that can be recovered from the flow cell (e.g., angles α or β). In some instances, cleavage occurs by charging one or more electrodes in the vicinity of the polynucleotides. In some instances, electromagnetic radiation in the form of UV light is used for cleavage of polynucleotides. In some instances, a lamp is used for cleavage of polynucleotides, and a mask mediates exposure locations of the UV light to the surface. In some instances, a laser is used for cleavage of polynucleotides, and a shutter opened/closed state controls exposure of the UV light to the surface. In some instances, access to nucleic acid information (including removal/addition of racks, solid supports, reagents, polynucleotides, or other component) is completely automated.

Solid supports as described herein comprise an active area. In some instances, the active area comprises regions, cells, features, or loci for nucleic acid synthesis. In some instances, the active area or surface is formed at least in part by the perimeter surface of a seal juxtaposed to one or more surfaces of substrates that are functionalized for association with biomolecules. In some instances, the active area comprises regions or loci for nucleic acid storage. In some examples, the regions or loci comprise the one or more modules. In some examples, the regions or loci comprise the second one or more modules. In some instances, the regions are addressable. In some examples, the regions are addressable through an electrode.

The active area comprises varying dimensions. For example, the dimension of the active area is between about 1 mm to about 50 mm by about 1 mm to about 50 mm. In some instances, the active area comprises a width of at least or about 0.5, 1, 1.5, 2, 2.5, 3, 5, 5, 10, 12, 14, 16, 18, 20, 25, 30, 35, 40, 45, 50, 60, 70, 80, or more than 80 mm. In some instances, the active area comprises a height of at least or about 0.5, 1, 1.5, 2, 2.5, 3, 5, 5, 10, 12, 14, 16, 18, 20, 25, 30, 35, 40, 45, 50, 60, 70, 80, or more than 80 mm.

In some instances, the solid support has a number of sites (e.g., spots) or positions for polynucleotides synthesis. In some instances, the solid support may be used to storage of polynucleotides. In some instances, the solid support comprises up to or about 10,000 by 10,000 positions in an area. In some instances, the solid support comprises between about 1000 and 20,000 by between about 1000 and 20,000 positions in an area. In some instances, the solid support comprises at least or about 10, 30, 50, 75, 100, 200, 300, 400, 500, 1000, 2000, 3000, 4000, 5000, 6000, 7000, 8000, 9000, 10,000, 12,000, 14,000, 16,000, 18,000, 20,000 positions by least or about 10, 30, 50, 75, 100, 200, 300, 400, 500, 1000, 2000, 3000, 4000, 5000, 6000, 7000, 8000, 9000, 10,000, 12,000, 14,000, 16,000, 18,000, 20,000 positions in an area. In some instances, the area is up to 0.25, 0.5, 0.75, 1.0, 1.25, 1.5, or 2.0 inches squared. In some instances, the solid support comprises loci having a pitch of at least or about 0.1, 0.2, 0.25, 0.3, 0.4, 0.5, 1.0, 1.5, 2.0, 2.5, 3.0, 3.5, 4.0, 4.5, 5, 6, 7, 8, 9, 10, or more than 10 μm. In some instances, the solid support comprises loci having a pitch of about 5 μm. In some instances, the solid support comprises loci having a pitch of about 2 μm. In some instances, the solid support comprises loci having a pitch of about 1 μm. In some instances, the solid support comprises loci having a pitch of about 0.2 μm. In some instances, the solid support comprises loci having a pitch of about 0.2 μm to about 10 μm, about 0.2 to about 8 μm, about 0.5 to about 10 μm, about 1 μm to about 10 μm, about 2 μm to about 8 μm, about 3 μm to about 5 μm, about 1 μm to about 3 μm or about 0.5 μm to about 3 μm. In some instances, the solid support comprises loci having a pitch of about 0.1 μm to about 3 μm.

In some instances, the solid support can be used for polynucleotide storage. In some instances, the solid support comprises a high capacity for storage of data. For example, the capacity of the solid support is at least or about 1, 2, 3, 4, 5, 6, 7, 8, 9, 10, 20, 50, 100, 200, 300, 400, 500, 600, 700, 800, 900, 1000, or more than 1000 petabytes. In some instances, the capacity of the solid support is between about 1 to about 10 petabytes or between about 1 to about 100 petabytes. In some instances, the capacity of the solid support is about 100 petabytes. In some examples, the polynucleotides are stored for a time on the solid support, and subsequently extracted from the solid support using the systems and methods provided herein. For example, polynucleotides on a solid support may be stored for days, months, or years, and subsequently extracted from the solid support using a flow cell such as those provided herein for recovery of information whole or in-part, or quality control of the polynucleotides. In some examples, one or more orientations of the flow cell has been optimized to maximize a liquid comprising the polynucleotides that can be recovered from the flow cell (e.g., angles α or β).

In some instances, the data is stored as arrays of packets as droplets. In some examples, the arrays of packets are addressable packets. In some examples, the packets are addressable using an electrode. In some instances, the data is stored as arrays of packets as droplets on a spot. In some instances, the data is stored as arrays of packets as dry wells. In some instances, the arrays comprise at least or about 1, 2, 3, 4, 5, 6, 7, 8, 9, 10, 20, 50, 100, 200, or more than 200 gigabytes of data. In some instances, the arrays comprise at least or about 1, 2, 3, 4, 5, 6, 7, 8, 9, 10, 20, 50, 100, 200, or more than 200 terabytes of data. In some instances, an item of information is stored in a background of data. For example, an item of information encodes for about 10 to about 100 megabytes of data and is stored in 1 petabyte of background data. In some instances, an item of information encodes for at least or about 1, 10, 20, 30, 40, 50, 60, 70, 80, 90, 100, 150, 200, 300, 400, 500, or more than 500 megabytes of data and is stored in 1, 10, 20, 30, 40, 50, 60, 70, 80, 90, 100, 150, 200, 300, 400, 500, or more than 500 petabytes of background data.

Provided herein is a data storage system comprising a solid support, where following synthesis, the polynucleotides are collected in packets as one or more droplets. In some instances, the polynucleotides are collected in packets as one or more droplets and stored. In some instances, a number of droplets is at least or about 1, 10, 20, 50, 100, 200, 300, 500, 1000, 2500, 5000, 75000, 10,000, 25,000, 50,000, 75,000, 100,000, 1 million, 5 million, 10 million, 25 million, 50 million, 75 million, 100 million, 250 million, 500 million, 750 million, or more than 750 million droplets. In some instances, a droplet volume comprises 5, 10, 15, 20, 25, 30, 35, 40, 45, 50, 55, 60, 65, 70, 75, 80, 85, 90, 95, 100, or more than 100 μm (micrometer) in diameter. In some instances, a droplet volume comprises 1-100 μm, 10-90 μm, 20-80 μm, 30-70 μm, or 40-50 μm in diameter.

In some instances, the polynucleotides that are collected in the packets comprise a similar sequence. In some instances, the polynucleotides further comprise a non-identical sequence to be used as a tag or barcode. For example, the non-identical sequence is used to index the polynucleotides stored on the solid support and to later search for specific polynucleotides based on the non-identical sequence. Exemplary tag or barcode lengths include barcode sequences comprising, without limitation, about 1, 2, 3, 4, 5, 6, 7, 8, 9, 10, 15, 20, 25 or more bases in length. In some instances, the tag or barcode comprise at least or about 10, 50, 75, 100, 200, 300, 400, or more than 400 base pairs in length.

Provided herein is a data storage system comprising a solid support, where the polynucleotides are collected in packets comprising redundancy. For example, the packets comprise about 100 to about 1000 copies of each polynucleotide. In some instances, the packets comprise at least or about 50, 75, 100, 200, 300, 400, 500, 600, 700, 800, 900, 1000, 1200, 1400, 1600, 1800, 2000, or more than 2000 copies of each polynucleotide. In some instances, the packets comprise about 1000× to about 5000× synthesis redundancy. Synthesis redundancy in some instances is at least or about 500×, 1000×, 1500×, 2000×, 2500×, 3000×, 3500×, 4000×, 5000×, 6000×, 7000×, 8000×, or more than 8000×. The polynucleotides that are synthesized using solid support-based methods as described herein comprise various lengths. In some instances, the polynucleotides are synthesized and further stored on the solid support. In some instances, the polynucleotide length is in between about 100 to about 1000 bases. In some instances, the polynucleotides comprise at least or about 10, 20, 30, 40, 50, 60, 70, 80, 90, 100, 125, 150, 175, 200, 225, 250, 275, 300, 325, 350, 375, 400, 425, 450, 475, 500, 600, 700, 800, 900, 1000, 1100, 1200, 1300, 1400, 1500, 1600, 1700, 1800, 1900, 2000, or more than 2000 bases in length.

In some instances, the polynucleotides are deprotected, cleaved, and/or eluted from the synthesizer unit 1710 and transferred to another module in the system. In some instances, the polynucleotides are transferred from the synthesizer unit 1710 on the solid support. In some instances, a robotic system 1730 or fluidic tube is used to transports the polynucleotides to another module in the system. A robotic system 1730 may be controlled by a controller 1735. A robotic system generally comprises a system for manipulation of a plurality of polynucleotides. In some instances, the robotic system is used to manipulate a structure comprising a plurality of polynucleotides, such as those described herein. Manipulation can comprise, by way of non-limiting example, moving, storing, retrieving, handling, transferring, or any combination thereof. The robotic system may be similar to those used in semiconductor processing to move trays of wafers and chips between processing devices. A robotic system 1730 may be used to select and transfer polynucleotides between modules of the system. For example, a robotic system 1735 may include a tag reader to verify a structure in a storage unit 1715. In some instances, the robotic system 1735 comprises a reader of a tag (e.g., RFID reader, barcode reader, etc.) and the structure in the storage unit 1715 comprises a tag (e.g., RFID tag, barcode, etc.). Once verified, the robotic system 1730 may transfer the structure to a component of the system. Additionally, the robotic system 1730 may transfer the structure to a precise location in a component of the system. In some instances, the robotic system can allow for polynucleotides to be added and/or removed from modules in the data storage system. In some instances, the robotic system allows for a structure comprising a plurality of polynucleotides to be placed and/or retrieved from a location in an identifiable layout in the storage unit 1715. The robotic system 1730 may be controlled using a controller 1735 as further described herein.

In some instances, one or more droplets comprising polynucleotides are transferred from a synthesizer unit 1710 to a storage unit 1715. In some instances, some or all of the polynucleotides synthesized on a solid support are transferred to a structure for storage. In some examples, the synthesizer unit 1710 is connected to or is coextensive with a system or platform for biomolecule processing. Thus, in some instances, the polynucleotides are synthesized and/or extracted using a system or platform comprising a flow cell assembly, oriented to maximize the recovery of fluid comprising the polynucleotides. The extracted polynucleotides can be collected in a structure for subsequent storage.

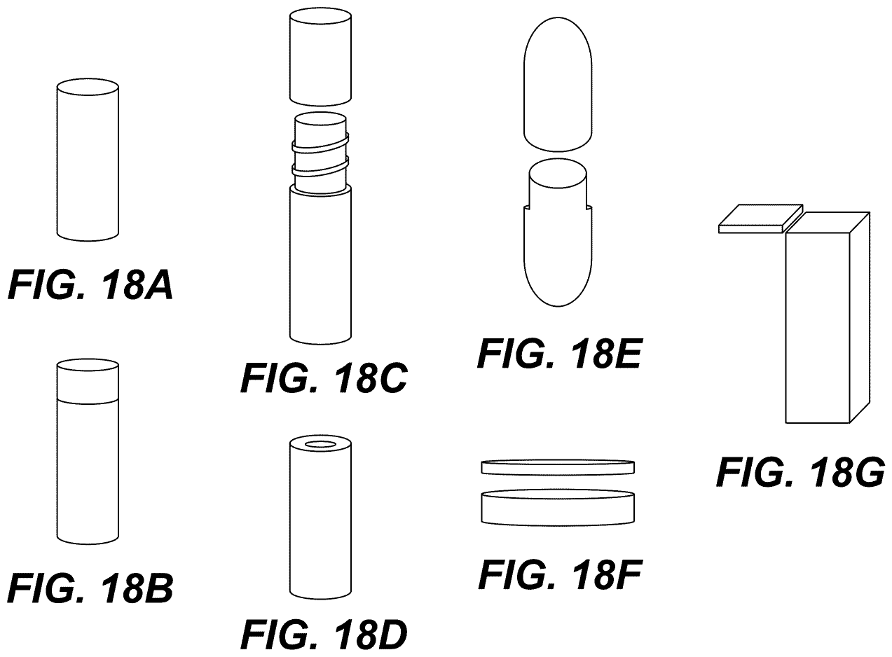

The structure may have a variety of shapes and sizes, such as those described herein (e.g., FIGS. 18A-18G). A structure for storing the plurality of polynucleotides may be any shape or size. In some instances, the structure is substantially spherical, tubular (FIG. 18A), egg-shaped, conical, cubic, cuboid, cylindrical, wedge, hexagonal prism, square base pyramid, triangular based pyramid, triangular prism, toroid, hemisphere, helical, heart-shaped, or other shape. In some instances, shapes are configured to allow the structure to be opened or closed to the outside environment. In some instances, such closures are facilitated by welding, seals, septa, or other mechanism for restricting the movement of gases or other matter in or out of the structure. In some instances, the structure comprises holes, slots, septum, valves, or ports for addition or removal of nucleic acids, fluids, gases, or other material into or out of the structure. In some instances a structure for storing the plurality of polynucleotides comprises a cap and a body that are flush-welded together (FIG. 18B). In some instances, a structure for storing the plurality of polynucleotides comprises a removable screw-cap (FIG. 18C). In some instances, a structure comprises a septum (FIG. 18D). In some instances a structure comprises two rounded, pill-shaped halves that form a seal when one half is inserted into the other (FIG. 18E). In some instances, a structure comprises a substantially flat, disc container with sealable lid (FIG. 18F). In some instances, a structure comprises a box with an optionally attached lid (FIG. 18G). In some examples, the shape is a cylinder or a disk. In some examples, a cylinder or a disk shape is preferrable for automated handling and/or filing of the structures.

The structure may further comprise a tag, such as those described herein. The tag can comprise a barcode or an RFID tag. In some instances, a plurality of polynucleotides is transferred to a structure in the synthesizer unit 1710. In some instances, the plurality of polynucleotides is transferred to a structure from a flow cell assembly, which can be part of a biomolecule processing system. In some instances, a plurality of polynucleotides is transferred to a structure in the storage unit 1715. The fluidic and/or electronic control of polynucleotide synthesis in the storage unit 1715 may be performed by a controller 1735. In some instances, the electronics in the storage unit 1715 are in communication with the controller 1735. In some instances, the polynucleotides are stored at room temperature in the storage unit 1715. In some instances, the system comprises a database or a file system for keeping track of the storage capacity in the storage unit 1715. In some examples, the database comprises a control application database. In some instances, the database or the file system is part of the controller 1735.

A structure comprising a plurality of polynucleotides can be stored in an identifiable layout in storage unit 1715. The identifiable layout may comprise a rack or a plurality of racks, or a variation thereof. The rack may be used to hold one or more structures comprising the plurality of polynucleotides. In some instances, each structure is stored at a fixed location in the identifiable layout. In some instances, the tag comprises information about a location of the structure in the identifiable layout. As an example, a tag (e.g., RFID tag) can encode metadata comprising a location of the structure in the identifiable layout. In some instances, the rack may be located in a data center. In some instances, the rack uses mechanical structures commonly used for mounting conventional computing and data storage resources in rack units. For example, a rack may comprise openings adapted to support disk drives, processing blades, and/or other computer equipment. In some instances, a rack comprises a tag. In some examples, the tag comprises information of the structures stored in/on the rack. In some examples, the tag comprises a list of the structures stored in/on the rack.

In some instances, the storage unit 1715 may be accessed using a robotic system 1730. In some instances, the identifiable layout in the storage unit 1715 comprises robotically addressable slots. Each slot may hold a structure comprising a plurality of polynucleotides. In some instances, each slot comprises a width, depth, length, or any combination thereof for accommodating a structure comprising the plurality of polynucleotides. In some instances, a rack comprises a plurality of slots, where each slot holds a structure comprising the plurality of polynucleotides.

The system for storing polynucleotides may further comprise an amplification chamber 1720. The amplification unit may be used to amplify the plurality of polynucleotides. In some instances, the system comprises more than one amplification chamber 1720. In some instances, a structure is selected from a storage unit 1715 and the polynucleotides from the structure are transferred to the amplification chamber 1720. In some instances, the polynucleotides from a synthesizer unit 1710 are transferred to the amplification chamber 1720 for size selection, PCR, or other type of amplification or preparation for storage. Size selection generally involves selecting DNA in the target size and rejecting strands that are much shorter or much longer. In some instances, filters are tuned to capture DNA of a particular size range. In some instances, other methods include PCR, electrophoresis, capture by solid phase bound primers, which are complementary to the end sequences of synthesized oligonucleotides, or the use of an isothermal polymerase. The fluidic and/or electronic control of polynucleotide synthesis in the amplification chamber 1720 may be performed by a controller 1735. In some instances, the electronics in the amplification chamber 1720 are in communication with the controller 1735.

The system for storing polynucleotides may further comprise a sequencing unit 1725. The sequencing unit 1725 may be used to sequence a plurality of polynucleotides. In some instances, the plurality of polynucleotides is transferred from the amplification chamber 1720 to the sequencing unit 1725. In some instances, the system may comprise additional modules for performing additional sequencing preparation steps. In some examples, the plurality of polynucleotides is transferred from the amplification chamber 1720 to the sequencing unit 1725 using one or more tubes or the robotic system 1730. In some instances, the amplification chamber 1720 and the sequencing unit 1725 are fluidically coupled. The fluidic and/or electronic control of polynucleotide synthesis in the sequencing unit 1725 may be performed by a controller 1735. In some instances, the electronics in the sequencing unit 1725 are in communication with the controller 1735.

In some instances, the system comprises large-scale sequencing of polynucleotides. In some instances, large-scale sequencing comprises dense and highly parallel sequencers. In some instances, the system comprises more than one sequencing unit 1725. In some instances, the sequencing unit 1725 use centrifugal forces and/or vacuum/pressure to add or evacuate reagents from the sequencing unit 1725. In some instances, the sequencing unit 1725 is light-based (e.g., with light sources and sensors on chip), nanopore-based (e.g., Oxford Nanopore Technologies (ONT)), or involve other operations (e.g., a light-based method such as PacBio or other sequencing technologies). In some instances, the sequencing unit 1725 employs sequencing methods provided herein. In some instances, the sequencing unit 1725 uses of nanopores or other electrical sequencing technology that benefits from the bulk fluidics provided by semiconductor fabrication equipment. In some instances, the one or more modules described herein comprises a camera. A camera may be used to capture one or more optical features of polynucleotides in a module. As an example, a camera may be used in a synthesizer unit, a sequencing unit, or both, to capture an optical feature of polynucleotides attached to a surface on a solid support as described herein.

The system for storing polynucleotides can comprise a robotic system 1730 as described herein. The robotic system may generally be used to manipulate the polynucleotides in a system. Manipulation can comprise, without limitation, moving, storing, retrieving, handling, transferring, or any combination thereof. In some instances, the robotic system transfers the plurality of polynucleotides between modules in the system. In some examples, the robotic system manipulates (e.g., transfers) the plurality of polynucleotides in structure for storage as described herein. In some instances, the robotic system manipulates (e.g., transfers) the plurality of polynucleotides in a rack. In some examples, the rack comprises a plurality of structures each comprising an RFID tag. In some examples, the rack comprises a plurality of solid supports for synthesis and/or sequencing. In some instances, the robotic system comprises a robotic hand or a robotic picker. In some instances, the robotic system 1730 is fully integrated with the storage system control software and/or firmware in the controller 1735. In some instances, the robotic system 1730 is fully integrated with an external host application. In some instances, the robotic system 1730 is fully automated.

The system for storing polynucleotides can comprise a controller 1735. The controller may generally be used for controlling modules, components, fluidics, robots, or any combination thereof. The modules, components, fluidics, electronics, robots, or any combination thereof may be used for synthesizing, storing, retrieving, sequencing, and/or amplifying polynucleotides. In some instances, the controller 1735 is capable of cataloguing all storage structures loaded, unloaded, and/or stored within a rack. The polynucleotides can encode digital information as described herein. The modules, components, fluidics, electronics, robots, or any combination thereof may be used for performing methods, models, or algorithms, such as encoding or decoding the polynucleotides.

In some instances, the controller 1735 controls the physical location of the plurality of polynucleotides. In some instances, the controller 1735 provides commands to one or more modules of the system. In some examples, the controller 1735 controls robotics (e.g., robotic system 1730), actuators, and fluidic valves, or any other equipment of the system. In some instances, the controller 1735 allows for synchronizing and controlling the modules for processing and/or transferring polynucleotides. In some examples, the polynucleotides are processed and/or transferred via fluidics. In some examples, the controller 1735 controls one or more valves or parameters (e.g., pressure, vacuum, temperature, volume, etc.) in the system for biomolecule processing. In some examples, the controller 1735 can be used to orient or adjust the orientation of a flow cell in a system for biomolecule processing. This can allow for flexibility of the system and maximize recovery of material (e.g., polynucleotides). In some examples, the polynucleotides are processed and/or transferred via electronics. In some instances, the controller 1735 controls physical parameters in one or more modules, such as, without limitation, pressure, vacuum, temperature, volume (e.g., of fluids), or any combination thereof.

In some instances, the controller 1735 invokes an encoder module or a decoder module. In some instances, the encoder module encodes the digital information as a plurality of polynucleotides. In some instances, the encoder module applies one or more codecs, such as those described herein, to the digital information. In some instances, the decoder module decodes the sequences of the plurality of polynucleotides to retrieve the digital information. In some instances, the decoder module applies one or more codecs, such as those described herein, to the sequences of the plurality of polynucleotides. In some instances, the decode module performs reassembly, error correction, and outputs digital information (e.g., binary data). In some instances, the output comprising digital information is transferred to an operating system and/or a file system. The output may be provided on a display, such as a graphical user interface (GUI), or any other suitable display such as those described herein, for providing the digital information. In some instances, the controller 1735 is implemented on one or more software modules, such as those described herein. In some instances, the controller 1735 responds to commands from an operating system, such as those described herein.

An encoder module generally encodes the digital information as a plurality of polynucleotides. An encoder can apply an encoding scheme to digital information. In some instances, the encoding scheme comprises codecs for encoding binary data as polynucleotide sequences (e.g., inner codec). In some instances, the encoding scheme comprises an error correction code (ECC) (e.g., outer codec). In some instances, employing a flow cell optimized for maximum recovery of material from a substrate decreases the need for error correction, since less material is lost between transfer of material. In some cases, the encoding scheme is designed and implemented to allow streaming read and write API access. In some cases, the encoding scheme is designed and implemented to match the streaming of the systems and methods for digital storage described herein.

The encoding scheme can generally comprise one or more operations. The one or more operations can comprise one or more operation to manipulate or transform data (e.g., digital information). The one or more operations can comprise by way of non-limiting example, splitting, shuffling, concatenating, transposing, translating, duplicating, labeling (e.g., using an index) data or a part of the data, or any combination thereof.

In some instances, the outer codec comprises an error correction code (ECC) or scheme, such as, without limitation, a Reed-Solomon (RS) code, a low-density parity-check (LDPC) code, a polar code, a turbo code, or any variation thereof. This outer codec is used for spreading the digital or binary data to be stored over many oligonucleotides. In some instances, spreading the data builds redundancy to correct for erasures (e.g., lost oligos). In some further embodiments, spreading the data also builds redundancy to correct errors from an inner codec. In some instances, the methods for encoding digital or binary data in a plurality of nucleotide sequences comprise an inner codec. In some instances, the inner codec is applied to the binary data. In some instances, the inner codec is applied to the binary data from the ECC. In some instances, the inner codec is applied to the lanes of the binary data. In some instances, the inner codec is applied to binary data that has been shuffled.

In some instances, the encoding scheme comprises an inner codec. In some instances, an inner codec is applied to encode the binary data as a polynucleotide sequence. The inner codec is used to transform digital or binary data into nucleotide bases. In some instances, the inner codec is capable of correcting deletion, substitution, or insertion errors, or any combination thereof. In some further embodiments, the inner codec is used to validate oligos and discard any suspicious oligos to avoid contaminating the outer decoding. The inner codec further encodes the indices, which can allow for efficient clustering during decoding. In some instances, the encoding scheme adds redundancy across the plurality of oligonucleotide sequences. In some instances, the inner codec comprises generating base candidates. In some instances, base candidates are generated using a codebook, a lookup table, a hash, or any suitable method known in the art. In some instances, the inner codec further comprises a base repetition check. In some instances, the inner codec further comprises performing GC filtering.

A decoder module generally decodes the sequences of the plurality of polynucleotides to retrieve the digital information. A decoder can apply a decoding scheme to the sequences of the plurality of polynucleotides. In some instances, a decoding scheme comprises an inner codec, an outer codec (e.g., ECC), or a combination thereof. In some instances, the decoding scheme decodes a plurality of polynucleotide sequences to generate an output comprising digital information. In some instances, the decoding scheme comprises undoing operations in the encoding scheme. In some examples, the operations comprise, without limitation, splitting, shuffling, concatenating, transposing, translating, duplicating, labeling (e.g., using an index) data or a part of the data, or any combination thereof.

A digital output from a sequencer unit comprising sequences of the plurality of polynucleotides may be provided to the decoding module. In some instances, the decoder module orders, clusters, and/or aligns sequences of the plurality of polynucleotides. In some examples, the decoder module comprises an alignment algorithm, such as with limitation, a pairwise alignment algorithm, a multi-sequence alignment algorithm, or any other suitable algorithm.

In some instances, decoding scheme comprise an inner codec. In some instances, the inner codec is applied to the plurality of polynucleotide sequences. The inner codec is used to transform the polynucleotide sequences into digital or binary data. In some instances, the inner codec is capable of correcting deletion, substitution, or insertion errors, or any combination thereof. In some further embodiments, the inner codec is used to validate oligos and discard any suspicious oligos to avoid contaminating the outer decoding. In some instances, the inner codec allows for efficient decoding using the indices.

An inner codec comprising a decoding scheme can be applied to the plurality of polynucleotide sequences. In some instances, the inner codec transforms each of the plurality of polynucleotide sequences into binary data. In some instances, the inner codec is applied to a plurality of polynucleotides that have been sequenced. In some examples, the plurality of clustered have been ordered, clustered, aligned, or any combination thereof.

In some instances, the inner codec comprises a greedy algorithm. A greedy algorithm generally takes into account transitions from only the most probably state as it decodes each bit position in a sequence. In some instances, the inner codec comprises a maximum likelihood (ML) algorithm. A ML algorithm generally takes into account transitions from all states as it decodes each bit position in a sequence In some instances, the inner codec comprises a mixed greedy ML algorithm. A mixed greedy ML algorithm can generally take into account transitions from a plurality of states as it decodes each bit position in a sequence. In some instances, the inner codec comprises a beam search decoder or a random sampling decoder (e.g., pure sampling decoder, a top-K sampling decoder, etc.). In some cases, a beam search decoder or a random sampling decoder provides a diversity of candidate states compared to a greedy decoder. In some instances, the inner codec further comprises a checksum. In some instances, the inner codec comprises a hash (e.g., SHA-256). In some instances, the hash verifies that the data was correctly decoded. In some instances, by using a hash at the end (after the ECC), the encoding and decoding are performed as a stream. In some instances, this can limit memory use to only temporary buffers.

In some instances, the decoding module comprises an outer codec (e.g., ECC). In some instances, the plurality of nucleotide sequences is decoded into digital or binary data. In some instances, an outer codec (e.g., ECC) is applied to the digital or binary data. In some instances, the outer codec comprises an ECC used to encode the data (e.g., binary data). In some instances, the ECC comprises a Reed-Solomon (RS) code, a LDPC code, a polar code, a turbo code, or any combination thereof. In some instances, the decoding scheme comprises soft decoding. Soft decoding generally refers to decoding by considering a range of possible values (e.g., using probability estimates).

### De Novo Polynucleotide Synthesis

Provided herein are systems and methods for synthesis of libraries of polynucleotides on a substrate. In some instances, the library comprising a plurality of polynucleotides from the encoding scheme are synthesized. In some examples, the library comprising the plurality of polynucleotides from the encoding scheme encode a pool of the plurality of pools. In some examples, the library comprising the plurality of polynucleotides from the encoding scheme encode an index pool. In some instances, methods comprise use of electrochemical deprotection. In some instances, the substrate is a flexible substrate. In some instances, at least 10¹⁰, 10¹¹, 10¹², 10¹³, 10¹⁴, or 10¹⁵ bases are synthesized in one day. In some instances, at least 10×10⁸, 10×10⁹, 10×10¹⁰, 10×10¹¹, or 10×10¹² polynucleotides are synthesized in one day. In some cases, each polynucleotide synthesized comprises at least 20, 50, 100, 200, 300, 400 or 500 nucleobases. In some cases, these bases are synthesized with a total average error rate of less than about 1 in 100; 200; 300; 400; 500; 1000; 2000; 5000; 10000; 15000; 20000 bases. In some instances, these error rates are for at least 50%, 60%, 70%, 80%, 90%, 95%, 98%, 99%, 99.5%, or more of the polynucleotides synthesized. In some instances, these at least 90%, 95%, 98%, 99%, 99.5%, or more of the polynucleotides synthesized do not differ from a predetermined sequence for which they encode. In some instances, the error rate for synthesized polynucleotides on a substrate using the methods and systems described herein is less than about 1 in 200, less than about 1 in 1,000, less than about 1 in 2,000, less than about 1 in 3,000, or less than about 1 in 5,000. Individual types of error rates include mismatches, deletions, insertions, and/or substitutions for the polynucleotides synthesized on the substrate. The term “error rate” refers to a comparison of the collective amount of synthesized polynucleotide to an aggregate of predetermined polynucleotide sequences. In some instances, synthesized polynucleotides disclosed herein comprise a tether of 12 to 25 bases. In some instances, the tether comprises 10, 11, 12, 13, 14, 15, 16, 17, 17, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 or more bases.

Described herein are methods, systems, devices, and compositions wherein chemical reactions used in polynucleotide synthesis are controlled using electrochemistry. Electrochemical reactions in some instances are controlled by any source of energy, such as light, heat, radiation, or electricity. For example, electrodes are used to control chemical reactions as all or a portion of discrete loci on a surface. Electrodes in some instances are charged by applying an electrical potential to the electrode to control one or more chemical steps in polynucleotide synthesis. In some instances, these electrodes are addressable. Any number of the chemical steps described herein is in some instances controlled with one or more electrodes. Electrochemical reactions may comprise oxidations, reductions, acid/base chemistry, or other reaction that is controlled by an electrode. In some instances, electrodes generate electrons or protons that are used as reagents for chemical transformations. Electrodes in some instances directly generate a reagent such as an acid. In some instances, an acid is a proton. Electrodes in some instances directly generate a reagent such as a base. Acids or bases are often used to cleave protecting groups, or influence the kinetics of various polynucleotide synthesis reactions, for example by adjusting the pH of a reaction solution. Electrochemically controlled polynucleotide synthesis reactions in some instances comprise redox-active metals or other redox-active organic materials. In some instances, metal or organic catalysts are employed with these electrochemical reactions. In some instances, acids are generated from oxidation of quinones.

Control of chemical reactions is not limited to the electrochemical generation of reagents; chemical reactivity may be influenced indirectly through biophysical changes to substrates or reagents through electric fields (or gradients) which are generated by electrodes. In some instances, substrates include but are not limited to polynucleotides. In some instances, electrical fields which repel or attract specific reagents or substrates towards or away from an electrode or surface are generated. Such fields in some instances are generated by application of an electrical potential to one or more electrodes. For example, negatively charged polynucleotides are repelled from negatively charged electrode surfaces. Such repulsions or attractions of polynucleotides or other reagents caused by local electric fields in some instances provides for movement of polynucleotides or other reagents in or out of region of the synthesis device or structure. In some instances, electrodes generate electric fields which repel polynucleotides away from a synthesis surface, structure, or device. In some instances, electrodes generate electric fields which attract polynucleotides towards a synthesis surface, structure, or device. In some instances, protons are repelled from a positively charged surface to limit contact of protons with substrates or portions thereof. In some instances, repulsion or attractive forces are used to allow or block entry of reagents or substrates to specific areas of the synthesis surface. In some instances, nucleoside monomers are prevented from contacting a polynucleotide chain by application of an electric field in the vicinity of one or both components. Such arrangements allow gating of specific reagents, which may obviate the need for protecting groups when the concentration or rate of contact between reagents and/or substrates is controlled. In some instances, unprotected nucleoside monomers are used for polynucleotide synthesis. Alternatively, application of the field in the vicinity of one or both components promote contact of nucleoside monomers with a polynucleotide chain. Additionally, application of electric fields to a substrate can alter the substrates reactivity or conformation. In an exemplary application, electric fields generated by electrodes are used to prevent polynucleotides at adjacent loci from interacting. In some instances, the substrate is a polynucleotide, optionally attached to a surface. Application of an electric field in some instances alters the three-dimensional structure of a polynucleotide. Such alterations comprise folding or unfolding of various structures, such as helices, hairpins, loops, or other 3-dimensional nucleic acid structure. Such alterations are useful for manipulating polynucleotides inside of wells, channels, or other structures. In some instances, electric fields are applied to a nucleic acid substrate to prevent secondary structures. In some instances, electric fields obviate the need for linkers or attachment to a solid support during polynucleotide synthesis.

A suitable method for polynucleotide synthesis on a substrate of this disclosure is a phosphoramidite-based synthesis of DNA. In some cases, a reagent for the phosphoramidite-based synthesis comprises any one of or a combination of a nucleoside phosphoramidite, an oxidizer, an activator, or a deblocker or the solvent comprises acetonitrile. In some instances, the phosphoramidite-based synthesis method comprises the controlled addition of a phosphoramidite building block, i.e., nucleoside phosphoramidite, to a growing polynucleotide chain in a coupling step that forms a phosphite triester linkage between the phosphoramidite building block and a nucleoside bound to the substrate. In some instances, the nucleoside phosphoramidite is provided to the substrate activated. In some instances, the nucleoside phosphoramidite is provided to the substrate with an activator. In some instances, nucleoside phosphoramidites are provided to the substrate in a 1.5, 2, 3, 4, 5, 6, 7, 8, 9, 10, 11, 12, 13, 14, 15, 16, 17, 17, 19, 20, 25, 30, 35, 40, 50, 60, 70, 80, 90, 100-fold excess or more over the substrate-bound nucleosides. In some instances, the addition of nucleoside phosphoramidite is performed in an anhydrous environment, for example, in anhydrous acetonitrile. Following addition and linkage of a nucleoside phosphoramidite in the coupling step, the substrate is optionally washed. In some instances, the coupling step is repeated one or more additional times, optionally with a wash step between nucleoside phosphoramidite additions to the substrate. In some instances, a polynucleotide synthesis method used herein comprises 1, 2, 3 or more sequential coupling steps. Prior to coupling, in many cases, the nucleoside bound to the substrate is de-protected by removal of a protecting group, where the protecting group functions to prevent polymerization. Protecting groups may comprise any chemical group that prevents extension of the polynucleotide chain. In some instances, the protecting group is cleaved (or removed) in the presence of an acid. In some instances, the protecting group is cleaved in the presence of a base. In some instances, the protecting group is removed with electromagnetic radiation such as light, heat, or other energy source. In some instances, the protecting group is removed through an oxidation or reduction reaction. In some instances, a protecting group comprises a triarylmethyl group. In some instances, a protecting group comprises an aryl ether. In some instances, a protecting comprises a disulfide. In some instances, a protecting group comprises an acid-labile silane. In some instances, a protecting group comprises an acetal. In some instances, a protecting group comprises a ketal. In some instances, a protecting group comprises an enol ether. In some instances, a protecting group comprises a methoxybenzyl group. In some instances, a protecting group comprises an azide. In some instances, a protecting group is 4,4′-dimethoxytrityl (DMT). In some instances, a protecting group is a tert-butyl carbonate. In some instances, a protecting group is a tert-butyl ester. In some instances, a protecting group comprises a base-labile group.

Following coupling, phosphoramidite polynucleotide synthesis methods optionally comprise a capping step. In a capping step, the growing polynucleotide is treated with a capping agent. A capping step generally serves to block unreacted substrate-bound 5′-OH groups after coupling from further chain elongation, preventing the formation of polynucleotides with internal base deletions. Further, phosphoramidites activated with 1H-tetrazole often react, to a small extent, with the 06 position of guanosine. Without being bound by theory, upon oxidation with I2/water, this side product, possibly via O6-N7 migration, undergoes depurination. The apurinic sites can end up being cleaved in the course of the final deprotection of the polynucleotide thus reducing the yield of the full-length product. The O6 modifications may be removed by treatment with the capping reagent prior to oxidation with I2/water. In some instances, inclusion of a capping step during polynucleotide synthesis decreases the error rate as compared to synthesis without capping. As an example, the capping step comprises treating the substrate-bound polynucleotide with a mixture of acetic anhydride and 1-methylimidazole. Following a capping step, the substrate is optionally washed.

Following addition of a nucleoside phosphoramidite, and optionally after capping and one or more wash steps, a substrate described herein comprises a bound growing nucleic acid that may be oxidized. The oxidation step comprises oxidizing the phosphite triester into a tetracoordinated phosphate triester, a protected precursor of the naturally occurring phosphate diester internucleoside linkage. In some instances, phosphite triesters are oxidized electrochemically. In some instances, oxidation of the growing polynucleotide is achieved by treatment with iodine and water, optionally in the presence of a weak base such as a pyridine, lutidine, or collidine. Oxidation is sometimes carried out under anhydrous conditions using tert-Butyl hydroperoxide or (1S)-(+)-(10-camphorsulfonyl)-oxaziridine (CSO). In some methods, a capping step is performed following oxidation. A second capping step allows for substrate drying, as residual water from oxidation that may persist can inhibit subsequent coupling. Following oxidation, the substrate and growing polynucleotide is optionally washed. In some instances, the step of oxidation is substituted with a sulfurization step to obtain polynucleotide phosphorothioates, wherein any capping steps can be performed after the sulfurization. Many reagents are capable of the efficient sulfur transfer, including, but not limited to, 3-(Dimethylaminomethylidene)amino)-3H-1,2,4-dithiazole-3-thione, DDTT, 3H-1,2-benzodithiol-3-one 1,1-dioxide, also known as Beaucage reagent, and N,N,N′N′-Tetraethylthiuram disulfide (TETD).

For a subsequent cycle of nucleoside incorporation to occur through coupling, a protected 5′ end (or 3′ end, if synthesis is conducted in a 5′ to 3′ direction) of the substrate bound growing polynucleotide is be removed so that the primary hydroxyl group can react with a next nucleoside phosphoramidite. In some instances, the protecting group is DMT and deblocking occurs with trichloroacetic acid in dichloromethane. In some instances, the protecting group is DMT and deblocking occurs with electrochemically generated protons. Conducting detritylation for an extended time or with stronger than recommended solutions of acids may lead to increased depurination of solid support-bound polynucleotide and thus reduces the yield of the desired full-length product. Methods and compositions described herein provide for controlled deblocking conditions limiting undesired depurination reactions. In some instances, the substrate bound polynucleotide is washed after deblocking. In some cases, efficient washing after deblocking contributes to synthesized polynucleotides having a low error rate.

Methods for the synthesis of polynucleotides on a substrate described herein may involve an iterating sequence of the following steps: application of a protected monomer to a surface of a substrate feature to link with either the surface, a linker or with a previously deprotected monomer; deprotection of the applied monomer so that it can react with a subsequently applied protected monomer; and application of another protected monomer for linking. One or more intermediate steps include oxidation and/or sulfurization. In some instances, one or more wash steps precede or follow one or all of the steps.

Methods for the synthesis of polynucleotides on a substrate described herein may comprise an oxidation step. For example, methods involve an iterating sequence of the following steps: application of a protected monomer to a surface of a substrate feature to link with either the surface, a linker or with a previously deprotected monomer; deprotection of the applied monomer so that it can react with a subsequently applied protected monomer; application of another protected monomer for linking, and oxidation and/or sulfurization. In some instances, one or more wash steps precede or follow one or all of the steps.

Methods for the synthesis of polynucleotides on a substrate described herein may further comprise an iterating sequence of the following steps: application of a protected monomer to a surface of a substrate feature to link with either the surface, a linker or with a previously deprotected monomer; deprotection of the applied monomer so that it can react with a subsequently applied protected monomer; and oxidation and/or sulfurization. In some instances, one or more wash steps precede or follow one or all of the steps.

Methods for the synthesis of polynucleotides on a substrate described herein may further comprise an iterating sequence of the following steps: application of a protected monomer to a surface of a substrate feature to link with either the surface, a linker or with a previously deprotected monomer; and oxidation and/or sulfurization. In some instances, one or more wash steps precede or follow one or all of the steps.

Methods for the synthesis of polynucleotides on a substrate described herein may further comprise an iterating sequence of the following steps: application of a protected monomer to a surface of a substrate feature to link with either the surface, a linker or with a previously deprotected monomer; deprotection of the applied monomer so that it can react with a subsequently applied protected monomer; and oxidation and/or sulfurization. In some instances, one or more wash steps precede or follow one or all of the steps.

In some instances, polynucleotides are synthesized with photolabile protecting groups, where the hydroxyl groups generated on the surface are blocked by photolabile-protecting groups. When the surface is exposed to UV light, such as through a photolithographic mask, a pattern of free hydroxyl groups on the surface may be generated. These hydroxyl groups can react with photoprotected nucleoside phosphoramidites, according to phosphoramidite chemistry. A second photolithographic mask can be applied, and the surface can be exposed to UV light to generate second pattern of hydroxyl groups, followed by coupling with 5′-photoprotected nucleoside phosphoramidite. Likewise, patterns can be generated, and oligomer chains can be extended. Without being bound by theory, the lability of a photocleavable group depends on the wavelength and polarity of a solvent employed and the rate of photocleavage may be affected by the duration of exposure and the intensity of light. This method can leverage a number of factors such as accuracy in alignment of the masks, efficiency of removal of photo-protecting groups, and the yields of the phosphoramidite coupling step. Further, unintended leakage of light into neighboring sites can be minimized. The density of synthesized oligomer per spot can be monitored by adjusting loading of the leader nucleoside on the surface of synthesis.

The surface of a substrate described herein that provides support for polynucleotide synthesis may be chemically modified to allow for the synthesized polynucleotide chain to be cleaved from the surface. In some instances, the polynucleotide chain is cleaved at the same time as the polynucleotide is deprotected. In some cases, the polynucleotide chain is cleaved after the polynucleotide is deprotected. In an exemplary scheme, a trialkoxysilyl amine such as (CH₃CH₂O)₃Si—(CH₂)₂—NH₂ is reacted with surface SiOH groups of a substrate, followed by reaction with succinic anhydride with the amine to create an amide linkage and a free OH on which the nucleic acid chain growth is supported. Cleavage includes gas cleavage with ammonia or methylamine. In some instances, cleavage includes linker cleavage with electrically generated reagents such as acids or bases. In some instances, once released from the surface, polynucleotides are assembled into larger polynucleotides that are sequenced and decoded to extract stored information.

The surfaces described herein can be reused after polynucleotide cleavage to support additional cycles of polynucleotide synthesis. For example, the linker can be reused without additional treatment/chemical modifications. In some instances, a linker is non-covalently bound to a substrate surface or a polynucleotide. In some embodiments, the linker remains attached to the polynucleotide after cleavage from the surface. Linkers in some embodiments comprise reversible covalent bonds such as esters, amides, ketals, beta substituted ketones, heterocycles, or other group that is capable of being reversibly cleaved. Such reversible cleavage reactions are in some instances controlled through the addition or removal of reagents, or by electrochemical processes controlled by electrodes. Optionally, chemical linkers or surface-bound chemical groups are regenerated after a number of cycles, to restore reactivity and remove unwanted side product formation on such linkers or surface-bound chemical groups.

Alternatively, the polymer synthesis can be enzymatic DNA synthesis. In some cases, the enzymatic DNA synthesis uses water as a solvent and the reagent is an enzyme terminal deoxynucleotidyl transferase (TdT) or a deblocker. In some cases, enzymatic synthesis of DNA uses a template-independent DNA polymerase, terminal deoxynucleotidyl transferase (TdT), which is a protein that evolved to rapidly catalyze the linkage of naturally occurring dNTPs. TdT adds nucleotides indiscriminately, so it is stopped from continuing unregulated synthesis by various techniques such a tethering the TDT, creating variant enzymes, and using nucleotides that include reversible terminators to prevent chain elongation. TdT activity is maximized at approximately 37° C. and performs enzymatic reactions in an aqueous environment.

### Sequencing

Polynucleotides are extracted and/or amplified from surfaces where they are synthesized or stored. After extraction and/or amplification of polynucleotides from the surface of a structure, suitable sequencing technology may be employed to sequence the polynucleotides. In some cases, the DNA sequence is read on the substrate or within a feature of a structure. In some cases, the polynucleotides stored on the substrate are extracted is optionally assembled into longer polynucleotides and then sequenced.

Polynucleotides synthesized and stored on the structures described herein encode data that can be interpreted by reading the sequence of the synthesized polynucleotides and converting the sequence into binary code readable by a computer. In some cases, the sequences require assembly, and the assembly step may need to be at the nucleic acid sequence stage or at the digital sequence stage.

Provided herein are detection systems comprising a device capable of sequencing stored polynucleotides, either directly on the synthesis structure and/or after removal from the main structure (e.g., synthesis structure, storage structure, etc.). In cases where the synthesis structure is a reel-to-reel tape of flexible material, the detection system comprises a device for holding and advancing the structure through a detection location and a detector disposed proximate the detection location for detecting a signal originated from a section of the tape when the section is at the detection location. In some instances, the signal is indicative of a presence of a polynucleotide. In some instances, the signal is indicative of a sequence of a polynucleotide (e.g., a fluorescent signal). In some instances, information encoded within polynucleotides on a continuous tape is read by a computer as the tape is conveyed continuously through a detector operably connected to the computer. In some instances, a detection system comprises a computer system comprising a polynucleotide sequencing device, a database for storage and retrieval of data relating to polynucleotide sequence, software for converting DNA code of a polynucleotide sequence to binary code, a computer for reading the binary code, or any combination thereof.

Provided herein are sequencing systems that can be integrated into the devices described herein. Various methods of sequencing are well known in the art and comprise “base calling” wherein the identity of a base in the target polynucleotide is identified. In some instances, polynucleotides synthesized using the methods, devices, compositions, and systems described herein are sequenced after cleavage from the synthesis surface. In some instances, sequencing occurs during or simultaneously with polynucleotide synthesis, wherein base calling occurs immediately after or before extension of a nucleoside monomer into the growing polynucleotide chain. Methods for base calling include measurement of electrical currents/voltages generated by polymerase-catalyzed addition of bases to a template strand. In some instances, synthesis surfaces comprise enzymes, such as polymerases. In some instances, such enzymes are tethered to electrodes or to the synthesis surface. In some instances, enzymes comprise terminal deoxynucleotidyl transferases, or variants thereof.

In some instances, the polynucleotides cleaved from a substrate surface or the amplified polynucleotides can be processed by techniques such as conventional or massively parallel sequencing. The sequencing can be done via various methods available in the field, e.g., methods involving incorporating one or more chain-terminating nucleotides, e.g., Sanger Sequencing method that can be performed by, e.g., SeqStudio® Genetic Analyzer from Applied Biosystems. In other embodiments, the sequencing can include performing a Next Generation Sequencing (NGS) method, e.g., primer extension followed by semiconductor-based detection (e.g., Ion Torrent™ systems from Thermo Fisher Scientific) or via fluorescent detection (e.g., Illumina systems).

### Computing System

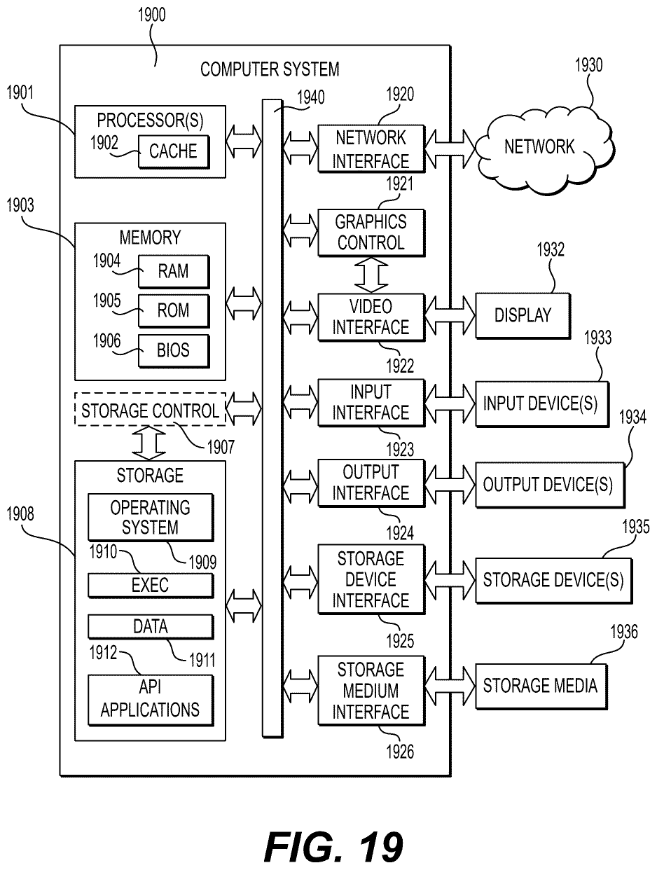

Referring to FIG. 19, a block diagram is shown depicting an exemplary machine that includes a computer system 1900 (e.g., a processing or computing system) within which a set of instructions can execute for causing a device to perform or execute any one or more of the aspects and/or methodologies for static code scheduling of the present disclosure. The components in FIG. 19 are examples only and do not limit the scope of use or functionality of any hardware, software, embedded logic component, or a combination of two or more such components implementing particular embodiments. A computing system as generally illustrated in FIG. 19 may be part of a data storage system, as exemplary illustrated in FIG. 17.

In various aspects, any of the devices, systems, or platforms described herein are operably linked to a computer and are optionally automated through a computer either locally or remotely. In various instances, the methods and systems described herein further comprise software programs on computer systems and use thereof. Accordingly, computerized control for the synchronization of the dispense/vacuum/refill functions such as orchestrating and synchronizing the material deposition device movement, dispense action and vacuum actuation are within the bounds of the disclosure provided herein. In some instances, the computer systems are programmed to interface between the user specified base sequence and the position of a material deposition device to deliver the correct building blocks and/or reagents to specified regions of the substrate (e.g., specific loci).

As an example, a computer system, such as the system shown in FIG. 19, may be used for encoding data represented as a set of symbols to another set of symbols. For example, the data may be represented as numerical symbols, such as binary values of “0”s and “1”s and the computer system may execute a program comprising a codec (e.g., an error correction code, such as RS code, LDPC code, Turbo code, etc.). In some instances, the computer system converts a first string of symbols to a second string of symbols using the program. In some instances, the computer system executes a program to convert the data to a plurality of nucleic acid sequences, convert a plurality of nucleic acid sequences to data, or both. In some instances, the computer system executes a program to convert a first one or more nucleic acid sequence to a second one or more nucleic acid sequences. For example, the computer program may convert a first one or more nucleic acid sequence to a second one or more nucleic acid sequence, where the second one or more nucleic acid sequences is more resistant to oxidation compared to the first one or more nucleic acid sequences.

As an example, a computer system, such as the system shown in FIG. 20, may be used for monitoring one or more components in a data storage system (e.g., FIG. 17) or a biomolecule processing system comprising a flow cell assembly (e.g., FIGS. 5-6 or FIGS. 13-14). For example, the computer system may be used to monitor one or more sensor data from a sensor integrated in or connected to a components or modules in the systems illustrated herein. In some instances, the computer system employs a program to monitor and detect irregularities in one or more parameters, such as pressure, volume, flow rate, temperature, vacuum, angles of orientation, humidity, or any other physical parameters that can be measured in the systems and platforms described herein. The computer system comprising the program may analyze patterns in one or more sensor data and optionally alert a user through an HMI if any irregularities are detected or if any data or combination of data fall outside of a threshold (e.g., predetermined or dynamic thresholds).

A program may be executed on a computer system provided herein. In some instances, a program comprises a statistical algorithm or a machine learning algorithm. In some instances, an algorithm comprising machine learning (ML) is trained to perform the functions or operations described herein. In some cases, the algorithm comprises classical ML algorithms for classification and/or clustering (e.g., K-means clustering, mean-shift clustering, density-based spatial clustering of applications with noise (DBSCAN), expectation-maximization (EM) clustering, agglomerative hierarchical clustering, logistic regression, naïve Bayes, K-nearest neighbors, random forests or decision trees, gradient boosting, support vector machines (SVMs), or a combination thereof).

In some cases, the algorithm comprises a learning algorithm comprising layers, such as one or more neural networks. Neural networks may comprise connected nodes in a network, which may perform functions, such as transforming or translating input data. In some examples, the output from a given node may be passed on as input to another node. In some embodiments, the nodes in the network may comprise input units, hidden units, output units, or a combination thereof. In some cases, an input node may be connected to one or more hidden units. In some cases, one or more hidden units may be connected to an output unit. The nodes may take in input and may generate an output based on an activation function. In some embodiments, the input or output may be a tensor, a matrix, a vector, an array, or a scalar. In some embodiments, the activation function may be a Rectified Linear Unit (ReLU) activation function, a sigmoid activation function, or a hyperbolic tangent activation function. In some embodiments, the activation function may be a Softmax activation function. The connections between nodes may further comprise weights for adjusting input data to a given node (e.g., to activate input data or deactivate input data). In some embodiments, the weights may be learned by the neural network. In some embodiments, the neural network may be trained using gradient-based optimizations. In some cases, the gradient-based optimization may comprise of one or more loss functions. In some examples, the gradient-based optimization may be conjugate gradient descent, stochastic gradient descent, or a variation thereof (e.g., adaptive moment estimation (Adam)). In further examples, the gradient in the gradient-based optimization may be computed using backpropagation. In some embodiments, the nodes may be organized into graphs to generate a network (e.g., graph neural networks). In some embodiments, the nodes may be organized into one or more layers to generate a network (e.g., feed forward neural networks, convolutional neural networks (CNNs), recurrent neural networks (RNNs), etc.). In some cases, the neural network may be a deep neural network comprising of more than one layer.

In some cases, the neural network may comprise one or more recurrent layer. In some examples, the one or more recurrent layer may be one or more long short-term memory (LSTM) layers or gated recurrent unit (GRU), which may perform sequential data classification and clustering. In some embodiments, the neural network may comprise one or more convolutional layers. The input and output may be a tensor representing of variables or attributes in a data set (e.g., features), which may be referred to as a feature map (or activation map). In some cases, the convolutions may be one dimensional (1D) convolutions, two dimensional (2D) convolutions, three dimensional (3D) convolutions, or any combination thereof. In further cases, the convolutions may be 1D transpose convolutions, 2D transpose convolutions, 3D transpose convolutions, or any combination thereof. In some examples, one-dimensional convolutional layers may be suited for time series data since it may classify time series through parallel convolutions. In some examples, convolutional layers may be used for analyzing a signal (e.g., sensor data) from one or more components of a system described herein.

The layers in a neural network may further comprise one or more pooling layers before or after a convolutional layer. The one or more pooling layers may reduce the dimensionality of the feature map using filters that summarize regions of a matrix. This may down sample the number of outputs, and thus reduce the parameters and computational resources needed for the neural network. In some embodiments, the one or more pooling layers may be max pooling, min pooling, average pooling, global pooling, norm pooling, or a combination thereof. Max pooling may reduce the dimensionality of the data by taking only the maximums values in the region of the matrix, which helps capture the significant feature. In some embodiments, the one or more pooling layers may be one dimensional (1D), two dimensional (2D), three dimensional (3D), or any combination thereof. The neural network may further comprise of one or more flattening layers, which may flatten the input to be passed on to the next layer. In some cases, the input may be flattened by reducing it to a one-dimensional array. The flattened inputs may be used to output a classification of an object (e.g., classification of signals (e.g., sensor data) in a system described herein). The neural networks may further comprise one or more dropout layers. Dropout layers may be used during training of the neural network (e.g., to perform binary or multi-class classifications). The one or more dropout layers may randomly set certain weights as 0, which may set corresponding elements in the feature map as 0, so the neural network may avoid overfitting. The neural network may further comprise one or more dense layers, which comprise a fully connected network. In the dense layer, information may be passed through the fully connected network to generate a predicted classification of an object, and the error may be calculated. In some embodiments, the error may be backpropagated to improve the prediction. The one or more dense layers may comprise a Softmax activation function, which may convert a vector of numbers to a vector of probabilities. These probabilities may be subsequently used in classifications, such as classifications of signal (e.g., sensor data) from a system described herein, or probable nucleobases during decoding (e.g., as part of a codec).

Computer system 1900 may include one or more processors 1901, a memory 1903, and a storage 1908 that communicate with each other, and with other components, via a bus 1940. The bus 1940 may also link a display 1932, one or more input devices 1933 (which may, for example, include a keypad, a keyboard, a mouse, a stylus, etc.), one or more output devices 1934, one or more storage devices 1935, and various tangible storage media 1936. All of these elements may interface directly or via one or more interfaces or adaptors to the bus 1940. For instance, the various tangible storage media 1936 can interface with the bus 1940 via storage medium interface 1926. Computer system 1900 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1900 includes one or more processor(s) 1901 (e.g., central processing units (CPUs), general purpose graphics processing units (GPGPUs), or quantum processing units (QPUs)) that carry out functions. Processor(s) 1901 optionally contains a cache memory unit 1902 for temporary local storage of instructions, data, or computer addresses. Processor(s) 1901 are configured to assist in execution of computer readable instructions. Computer system 1900 may provide functionality for the components depicted in FIG. 19 as a result of the processor(s) 1901 executing non-transitory, processor-executable instructions embodied in one or more tangible computer-readable storage media, such as memory 1903, storage 1908, storage devices 1935, and/or storage medium 1936. The computer-readable media may store software that implements particular embodiments, and processor(s) 1901 may execute the software. Memory 1903 may read the software from one or more other computer-readable media (such as mass storage device(s) 1935, 1936) or from one or more other sources through a suitable interface, such as network interface 1920. The software may cause processor(s) 1901 to carry out one or more processes or one or more steps of one or more processes described or illustrated herein. Carrying out such processes or steps may include defining data structures stored in memory 1903 and modifying the data structures as directed by the software.

The memory 1903 may include various components (e.g., machine readable media) including, but not limited to, a random access memory component (e.g., RAM 1904) (e.g., static RAM (SRAM), dynamic RAM (DRAM), ferroelectric random access memory (FRAM), phase-change random access memory (PRAM), etc.), a read-only memory component (e.g., ROM 1905), and any combinations thereof. ROM 1905 may act to communicate data and instructions unidirectionally to processor(s) 1901, and RAM 1904 may act to communicate data and instructions bidirectionally with processor(s) 1901. ROM 1905 and RAM 1904 may include any suitable tangible computer-readable media described below. In one example, a basic input/output system 1906 (BIOS), including basic routines that help to transfer information between elements within computer system 1900, such as during start-up, may be stored in the memory 1903.

Fixed storage 1908 is connected bidirectionally to processor(s) 1901, optionally through storage control unit 1907. Fixed storage 1908 provides additional data storage capacity and may also include any suitable tangible computer-readable media described herein. Storage 1908 may be used to store operating system 1909, executable(s) 1910, data 1911, applications 1912 (application programs), and the like. Storage 1908 can also include an optical disk drive, a solid-state memory device (e.g., flash-based systems), or a combination of any of the above. Information in storage 1908 may, in appropriate cases, be incorporated as virtual memory in memory 1903.

In one example, storage device(s) 1935 may be removably interfaced with computer system 1900 (e.g., via an external port connector (not shown)) via a storage device interface 1925. Particularly, storage device(s) 1935 and an associated machine-readable medium may provide non-volatile and/or volatile storage of machine-readable instructions, data structures, program modules, and/or other data for the computer system 1900. In one example, software may reside, completely or partially, within a machine-readable medium on storage device(s) 1935. In another example, software may reside, completely or partially, within processor(s) 1901.

Bus 1940 connects a wide variety of subsystems. Herein, reference to a bus may encompass one or more digital signal lines serving a common function, where appropriate. Bus 1940 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1900 may also include an input device 1933. In one example, a user of computer system 1900 may enter commands and/or other information into computer system 1900 via input device(s) 1933. Examples of an input device(s) 1933 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 1933 may be interfaced to bus 1940 via any of a variety of input interfaces 1923 (e.g., input interface 1923) including, but not limited to, serial, parallel, game port, USB, FIREWIRE, THUNDERBOLT, or any combination of the above.

In particular embodiments, when computer system 1900 is connected to network 1930, computer system 1900 may communicate with other devices, specifically mobile devices and enterprise systems, distributed computing systems, cloud storage systems, cloud computing systems, and the like, connected to network 1930. In some embodiments, the computing system 1900 may communicate with one or more components of a system of data storage (e.g., FIG. 19). For example, the computing system 1900 may communicate with (e.g., control or manage) the robotic system 1330. Communications to and from computer system 1900 may be sent through network interface 1920. For example, network interface 1920 may receive incoming communications (such as requests or responses from other devices) in the form of one or more packets (such as Internet Protocol (IP) packets) from network 1930, and computer system 1900 may store the incoming communications in memory 1903 for processing. Computer system 1900 may similarly store outgoing communications (such as requests or responses to other devices) in the form of one or more packets in memory 1903 and communicated to network 1930 from network interface 1920. In some embodiments, the computing system 1900 has access to a tag on a structure for data storage, such as, for example, an RFID tag. In some embodiments, the computing system 1900 manages the information of the tag, as well as an associated file system or database. Processor(s) 1901 may access these communication packets stored in memory 1903 for processing.

Examples of the network interface 1920 include, but are not limited to, a network interface card, a modem, and any combination thereof. Examples of a network 1930 or network segment 1930 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1930, may employ a wired and/or a wireless mode of communication. In general, any network topology may be used.

Information and data can be displayed through a display 1932. Examples of a display 1932 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1932 can interface to the processor(s) 1901, memory 1903, and fixed storage 1908, as well as other devices, such as input device(s) 1933, via the bus 1940. The display 1932 is linked to the bus 1940 via a video interface 1922, and transport of data between the display 1932 and the bus 1940 can be controlled via the graphics control 1921. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 1932, computer system 1900 may include one or more other peripheral output devices 1934 including, but not limited to, an audio speaker, a printer, a storage device, and any combinations thereof. In some instances, a peripheral output device 1934 may correspond to a tag on a structure, such as, for example, an RFID tag. Such peripheral output devices may be connected to the bus 1940 via an output interface 1924. Examples of an output interface 1924 include, but are not limited to, a serial port, a parallel connection, a USB port, a FIREWIRE port, a THUNDERBOLT port, and any combinations thereof.

In addition, or as an alternative, computer system 1900 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of information, such as information related to a system or platform (e.g., for data storage or biomolecule processing) provided herein. In various embodiments, suitable databases include, by way of non-limiting examples, relational databases, non-relational databases, object oriented databases, object databases, entity-relationship model databases, associative databases, XML databases, document oriented databases, and graph databases.

Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### Certain Definitions

Unless otherwise defined, all technical terms used herein have the same meaning as commonly understood by one of ordinary skill in the art to which the present subject matter belongs.

Throughout this disclosure, numerical features are presented in a range format. It should be understood that the description in range format is merely for convenience and brevity and should not be construed as an inflexible limitation on the scope of any embodiments. Accordingly, the description of a range should be considered to have specifically disclosed all the possible subranges as well as individual numerical values within that range to the tenth of the unit of the lower limit unless the context clearly dictates otherwise. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual values within that range, for example, 1.1, 2, 2.3, 5, and 5.9. This applies regardless of the breadth of the range. The upper and lower limits of these intervening ranges may independently be included in the smaller ranges, and are also encompassed within the invention, subject to any specifically excluded limit in the stated range. Where the stated range includes one or both of the limits, ranges excluding either or both of those included limits are also included in the invention, unless the context clearly dictates otherwise.

The terminology used herein is for the purpose of describing particular embodiments only and is not intended to be limiting of any embodiment. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference throughout this specification to “some instances,” “further instances,” or “a particular instance,” means that a particular feature, structure, or characteristic described in connection with the instance is included in at least one instance. Thus, the appearances of the phrase “in some instances,” or “in further instances,” or “in a particular instance” in various places throughout this specification are not necessarily all referring to the same instance. Furthermore, the particular features, structures, or characteristics may be combined in any suitable manner in one or more instances.

Unless specifically stated or obvious from context, as used herein, the term “about” in reference to a number or range of numbers is understood to mean the stated number and numbers +/−10% thereof, or 10% below the lower listed limit and 10% above the higher listed limit for the values listed for a range.

Polynucleotide sequences described herein may be, unless stated otherwise, comprise DNA or RNA or an analog or derivative thereof. As used herein, the terms nucleic acids, polynucleotides, oligonucleotides, oligos, oligonucleic acids are used synonymously throughout to represent a polymer of nucleoside monomers. In some instances, nucleic acids are connected via phosphate or sulfur-containing linkages. Nucleic acids in some instances comprise DNA, RNA, non-canonical nucleic acids, unnatural nucleic acids, or other nucleoside. In some instances, nucleotides comprise non-canonical bases, sugars, or other moiety. In some instances, nucleotides comprise terminators which are configured to prevent extension reactions. In some instances, such terminators are removed before addition of subsequent nucleotides to the growing chain.

### EXAMPLES

The following illustrative examples are representative of embodiments of the software applications, systems, and methods described herein and are not meant to be limiting in any way.

### Example 1—Polynucleotide Synthesis on Two Substrates with Sandwiched Fluidic Layer

An experimental setup was constructed for demonstrating oligomer synthesis from two parallel substrates with a sandwiched fluidic layer. The primary objectives included: demonstrating simultaneous oligomer synthesis on two substrates in the sandwiched design and show parity in synthesis quality between the two substrates; comparing spatial uniformity of oligomer synthesis on the two substrates in the prototype sandwich; comparing oligomer synthesis quality and spatial uniformity between the sandwiched substrates and a control single substrate; and comparing variances in experimental conditions tested against run-to-run differences using statistical methods.

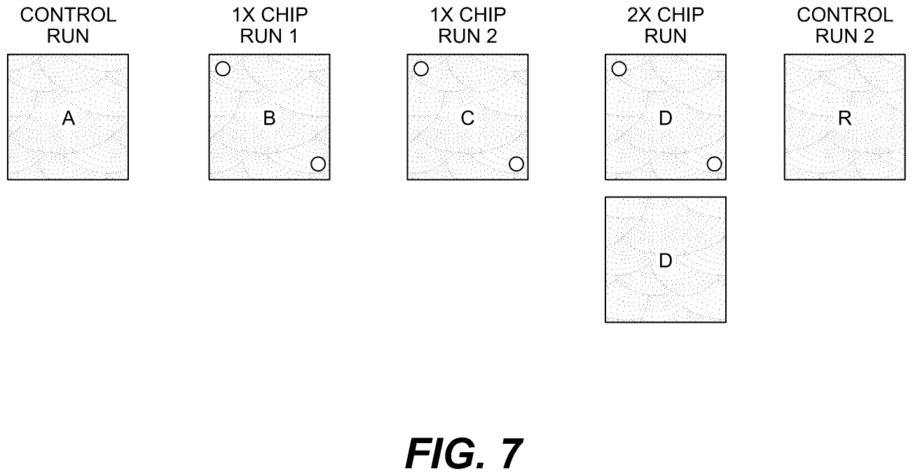

In view of the above objectives, four conditions were tested using standard operating protocols and common process parameters: Run A: Single substrate with standard operating protocol; Run B: Single chip with 1×150 micron drilled hole; Run C: Single chip with 1×150 micron drilled hole (repeat run); Run D: Simultaneous synthesis in 2 chips with flow sandwiched in between the substrates; Run R: Single substrate with standard operating protocol (repeat run). These conditions are shown in FIG. 7.

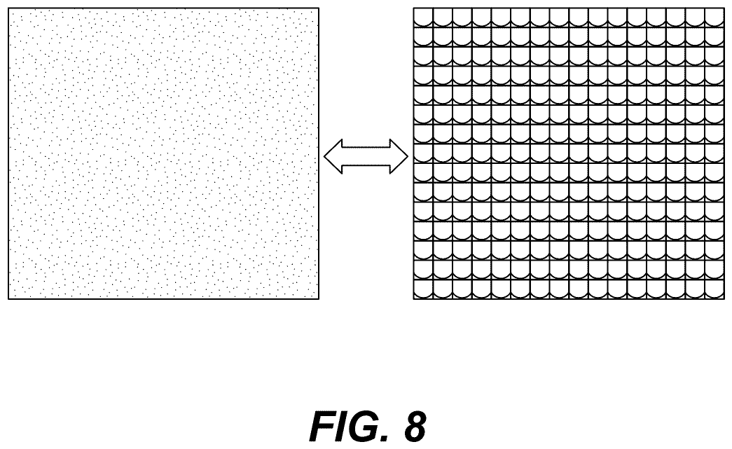

A standard phosphoramidite-based chemical oligomer synthesis protocol for a single substrate was employed. The protocol included repetitive addition of bases with the cyclic operation of deblocking ->coupling->capping->oxidation for every base to be added with intermittent washing steps to prevent cross-contamination. 3′-YYY-5′, where Y represents the base T-tagged with the fluorescent dye 5-TAMRA (5-Carboxytetramethylrhodamine), was chosen as the oligomer to be synthesized to demonstrate functionality. Fluorescent images were collected using a Nikon microscope which scans in segments across the chip. All segments were stitched together ultimately using vendor-provided software to obtain an overall spatial distribution of oligomers across the chip. An example of the final stitched image is shown below. Image processing techniques and standard ANOVA analysis was performed to determine the parity between conditions and prove out any actual statistically significant differences. An example of a fluorescent image stitched together to represent a silicon substrate post-oligomer synthesis is provided in FIG. 8.

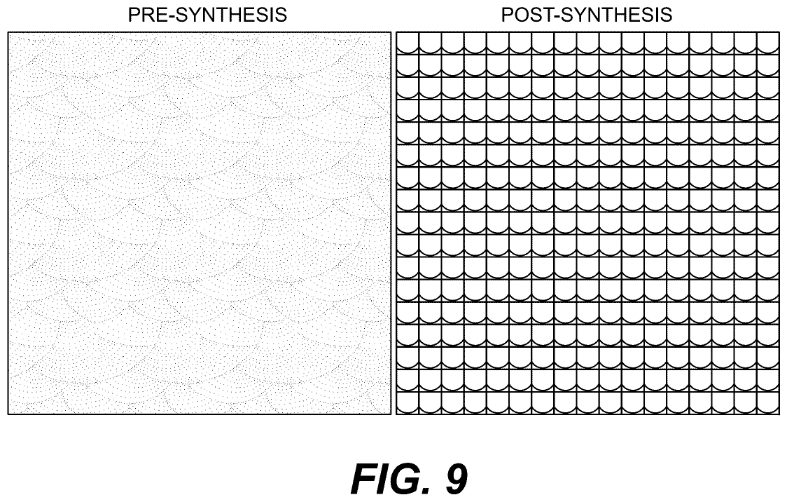

Oligomers were synthesized successfully in both chips in the sandwich prototype as shown by the presence of fluorescent signals from the chips compared to the negative control (i.e., fluorescent images of the chips taken prior to synthesis). A comparison between the microscope image of a silicon substrate pre-synthesis versus post-synthesis is shown in FIG. 9, providing evidence for oligomer synthesis on the substrate.

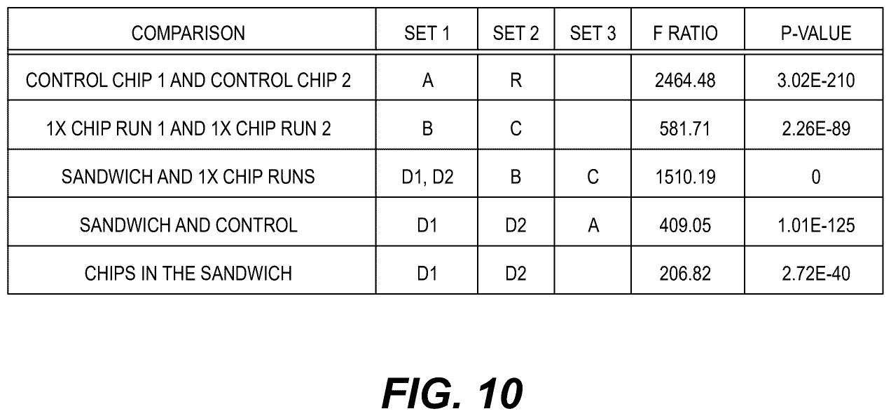

An ANOVA analysis (single factor, α=0.05) of all the conditions tested showed statistically significant differences present in all groups compared. FIG. 10 provides a table with the ANOVA analysis of various comparison groups showing the p-value and F-ratio to demonstrate statistical significance of differences. However, the variation was least between (i) the two chips in the sandwich prototype and between (ii) the sandwich chips and the single chip control.

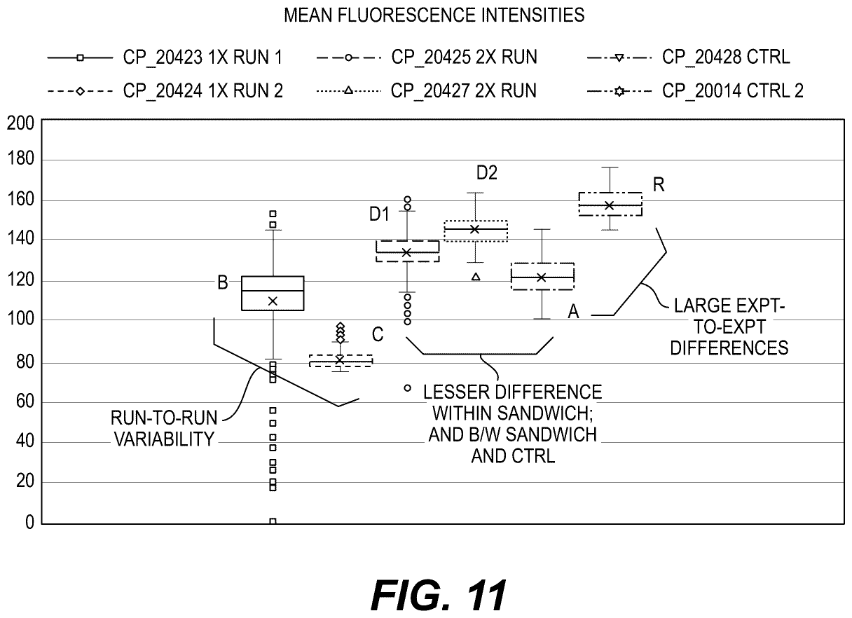

Further, mean fluorescence intensities were measured, which are shown in FIG. 11. FIG. 11 provides a box and whisker plot for fluorescent intensity from every condition: the variances in average signal for repeats between runs and experiments were higher than the chips used within a sandwich and between the sandwich and control. This showed that the variations were caused by a secondary source and not the prototype concept itself. The run-to-run variance was far greater than the differences between the two substrates in a sandwich and between the sandwich and a single-chip control setup.

These results showed that variations were due to a secondary source unrelated to the primary conditions tested for. Spatial homogeneity was also observed in oligomer synthesis across the chips for every condition. In summary, there were results showing parity in oligomer synthesis in terms of quality and spatial uniformity for the two parallel substrates in the sandwich prototype and any variations are attributed to secondary sources. There was parity in oligomer synthesis in terms of quality and spatial uniformity between the substrates in the sandwich prototype and single-chip control run. The results demonstrated a method for synthesizing oligomers of equivalent quality and uniformity in two parallel substrates with the reagents sandwiched in between the active surfaces, while preserving the operation time and reagent volume used.

### Example 2—Polynucleotide Synthesis on a Plurality of Substrates

The experimental set up and general procedure for synthesis of polynucleotides described in Example 1 is applied to synthesis polynucleotides on a plurality of substrates as generally illustrated in FIG. 14. The set up in FIG. 14 is integrated into a flow cell assembly generally illustrated in FIG. 5. Each of the polynucleotides comprise 100 bases with a plurality of bases: A, T, C, and G. The quality and spatial uniformity of the polynucleotides are analyzed, demonstrating synthesis of equivalent quality and uniformity in parallel substrates with the reagents sandwiched in between the active surfaces, while preserving the operation time and reagent volume used.

### Example 3—Automated System for Biomolecule Processing

The flow cell assembly generally demonstrated in Example 1 is integrated into a data storage system as illustrated in FIG. 17. An item of information represented by a first string of symbols is converted to a second string of symbols comprising sequences of a plurality of nucleic acids using an inner codec and outer codec provided herein. The plurality of polynucleotides is synthesized in a synthesizer unit 1710 comprising the flow cell assembly. After a time, a pump is used to displace liquid from the flow cell assembly using the methods described herein. The liquid comprising the plurality of nucleic acids are collected in a sample collection reservoir. The robotic system 1730 is used to transfer the sample collection reservoir to a storage unit 1715. The sample collection reservoir can be stored under one or more controlled conditions, such as temperature, humidity, pressure, vacuum, or any other physical parameter, in an identifiable layout (e.g., tray or rack) as described herein.

### Example 4—Multiplex Set Ups for Polynucleotide Synthesis

The general set up for synthesis of polynucleotides from Example 2 is applied to two set ups comprising a spacer. The two set ups are applied to enzymatic synthesis of polynucleotides, each about 100 bases with a plurality of bases: A, T, C, and G.

In a first set up, the spacer is a frame. Substrates (also referred to as chips) for polynucleotide synthesis are bonded into a machined or molded frame with integral fluid ports. The frame material can be plastic or metal. Gluing features such as glue trough are provided, and the entire assembly can be automated. The resulting assembly is provided in FIGS. 20A-20B. Chip to chip spacing can be set as desired, from 150 to 500 μm.

In a second set up, the spacer is end pieces comprising as beads. Substrates for polynucleotide synthesis are bonded with spacing beads and separate fluid port manifolds at each end. Bonding can also be done with PSA. The resulting assembly is provided in FIGS. 21A-21B. Chip to chip spacing can be set as desired, from 150 to 500 μm.

Both designs have a cross manifold and individual fluid introduction ports. These ports are smaller in cross sectional area than the cross manifold to assure even distribution. Cross manifold can assure even filling and bypass, if desired. However, both designs can also be set up for use with a single port at each corner for fluid flow (not shown in FIGS. 20A-20B or FIGS. 21A-21B). In such case, for adequate flow, the single port is oblong in nature to provide added flow area without restriction. Both designs can be implemented in horizontal, vertical or tilted orientation (e.g., defined by angles α or β (e.g., α is about 0° to 90° and/or angle β is about 0° to 60°).

The set up in FIGS. 20A-20B or FIGS. 21A-21B is multiplexed as shown in FIGS. 14-15. Each set up can be integrated into a flow cell assembly generally illustrated in FIG. 5 for synthesis of polynucleotides on the substrates. Each of the polynucleotides comprise 100 bases with a plurality of bases: A, T, C, and G. The quality and spatial uniformity of the polynucleotides are analyzed, demonstrating synthesis of equivalent quality and uniformity in parallel substrates with the reagents sandwiched in between the active surfaces, while preserving the operation time and reagent volume used.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

The present disclosure is further described by the following non-limiting items.

Item 1. A device for processing a plurality of biomolecules comprising:
(a) a first substrate comprising a first surface functionalized for association with a first building block of the plurality of biomolecules; and
(b) a second substrate comprising a second surface functionalized for association with a second building block of the plurality of biomolecules, wherein the second surface faces the first surface.

Item 2. The device of item 1, wherein the first substrate and the second substrate are substantially parallel.

Item 3. The device of item 1 or 2, wherein the first substrate or the second substrate comprises dimensions of about 15 to 40 mm by about 15 to 40 mm.

Item 4. The device of any one of items 1-3, wherein the plurality of biomolecules comprises a plurality of polynucleotides and wherein the building block comprises a nucleotide.

Item 5. The device of any one of items 1-4, wherein the first surface and the second surface are functionalized with a chemical moiety suitable for nucleotide coupling.

Item 6. The device of any one of items 1-5, wherein the first surface or the second surface comprises a plurality of addressable loci.

Item 7. The device of any one of items 1-6, wherein the first surface or the second surface are functionalized for association with the plurality of molecules at a density of about 1 pmol/cm² to 200 pmol/cm².

Item 8. The device of any one of items 1-7, wherein the first substrate or the second substrate comprises at least one through-hole.

Item 9. The device of item 8, wherein the at least one through-hole is about 120 to 500 μm in diameter.

Item 10. The device of any one of items 1-9, wherein the second substrate comprises at least two through-holes located on opposite sides.

Item 11. The device of item 10, wherein the at least two through-holes are located diagonal to each other on the second substrate.

Item 12. The device of item 11, wherein the at least two through-holes of the second substrate each connect to a manifold of a flow cell assembly.

Item 13. The device of any one of items 1-9, wherein the first substrate and the second substrate each comprise at least one through-hole.

Item 14. The device of item 13, wherein the at least one through-hole of the first substrate and the at least one through-hole of the second substrate are located diagonal to each other.

Item 15. The device of item 13 or 14, wherein the at least one through-hole of the first substrate and the at least one through-hole of the second substrate each connect to a manifold of a flow cell.

Item 16. The device of any one of items 1-15, further comprising a spacer comprising a perimeter surface.

Item 17. The device of item 16, wherein the spacer comprises a seal, a frame, or end pieces.

Item 18. The device of item 17, wherein the end pieces comprise spacing beads.

Item 19. The device of item 16, wherein the perimeter surface is juxtaposed to the first substrate forming a first active surface.

Item 20. The device of item 19, wherein the second substrate is juxtaposed to the perimeter surface opposite to the first substrate forming a second active surface.

Item 21. The device of item 20, wherein the spacer comprising the perimeter surface between the first substrate and the second substrate forms a cavity enclosed by the first active surface and the second active surface.

Item 22. A device for processing a plurality of biomolecules comprising a plurality of substrates, the plurality of substrates comprising:
(a) a top substrate comprising a first top surface and a first bottom surface, wherein the first bottom surface is functionalized for association with a building block of the plurality of biomolecules;
(b) a middle substrate comprising a second top surface and a second bottom surface functionalized for association with a building block of the plurality of biomolecules, wherein the second top surface faces the first bottom surface; and
(c) a bottom substrate comprising a third top surface and a third bottom surface, the third top surface functionalized for association with a building block of the plurality of biomolecules, wherein the top third surface faces the second bottom surface.

Item 23. The device of item 22, wherein each of the plurality of substrates is substantially parallel to one another.

Item 24. The device of item 22 or 23, further comprising a plurality of middle substrates, each of the plurality of middle substrates comprising a top surface and a bottom surface.

Item 25. The device of item 24, wherein the top surface and the bottom surface of each of the plurality of middle substrates is functionalized for association with a building block of the plurality of biomolecules.

Item 26. The device of any one of items 22-25, wherein each of the plurality of substrates is separated by a seal comprising a perimeter surface.

Item 27. The device of item 26, wherein the spacer comprises a seal, a frame, or end pieces.

Item 28. The device of item 27, wherein the end pieces comprise spacing beads.

Item 29. The device of item 26, wherein the perimeter surface forms an active surface on a surface of a substrate of the plurality of substrates to which it is juxtaposed.

Item 30. The device of any one of items 22-29, wherein the device comprises a number of active surfaces on a number of substrates, wherein the number of active surfaces is twice that of the number of substrates.

Item 31. The device of any one of items 22-30, wherein each of the plurality of substrates comprises at least one through-hole.

Item 32. The device of item 31, wherein the at least one through-hole on each of the plurality of substrates is located diagonal to the at least one through-hole on an adjacent substrate of the plurality of substrates.

Item 33. The device of item 31 or 32, wherein the at least one through-hole on each of the plurality of substrates provides fluidic connection between each of the plurality of substrates.

Item 34. The device of any one of items 31-33, wherein the at least one through-hole of the top substrate and the at least one through-hole of the bottom substrate each connect to a manifold of a flow cell assembly.

Item 35. A flow cell assembly for processing a plurality of biomolecules, comprising:
(a) the device of any one of items 1-34; and
(b) one or more fluidic interfaces.

Item 36. The flow cell assembly of item 35, further comprising one or more of:
(a) a top assembly clamp and a bottom clamp;
(b) a support plate; or
(c) one or more spacers.

Item 37. The flow cell assembly of item 35 or 36, wherein the one or more spacers comprises one or more seals, one or more frames, or one or more beads.

Item 38. The flow cell assembly of item 37, wherein the one or more seals comprises a perfluoroelastomer (FFKM) comprising tetrafluoroethylene (TFE), perfluoromethyl vinyl ether (PMVE), or cure site monomer (CSM), or any combination thereof.

Item 39. The flow cell assembly of any one of items 35-38, wherein the at least one through-hole is connected to at least one manifold of a fluidic interface of the one or more fluidic interfaces.

Item 40. A method of processing a plurality of biomolecules, comprising:
(a) providing a flow cell assembly comprising:
   (i) the device comprising a plurality of substrates of any one of items 1-34; and
   (ii) one or more fluidic interfaces;
(b) filling at least a portion of the flow cell assembly with a fluid; and
(c) evacuating the fluid from at least the portion of the flow cell assembly.

Item 41. The method of item 40, wherein each of the plurality of substrates is substantially parallel to one another.

Item 42. The method of item 40 or 41, wherein filling the flow cell assembly comprises filling at least one cavity between two substrates of the plurality of substrates in at least the portion of the flow cell assembly.

Item 43. The method of any one of items 40-42, wherein evacuating the fluid in the flow cell assembly comprises evacuating the fluid in at least one cavity between the two substrates of the plurality of substrates in at least the portion of the flow cell assembly.

Item 44. The method of any one of items 40-43, further comprising repeating (b)-(c) to synthesize a plurality of biomolecules, wherein the fluid comprises a reagent for synthesis of the plurality of biomolecules.

Item 45. The method of any one of items 40-44, wherein the plurality of biomolecules comprises a plurality of polynucleotides.

Item 46. The method of item 44 or 45, wherein the synthesis comprises solid-phase synthesis or enzymatic synthesis.

Item 47. The method of item 44 or 45, wherein the reagent comprises a reagent for one or more of: (i) coupling; (ii) capping; (iii) oxidizing; (iv) deblocking; or (v) washing.

Item 48. The method of any one of items 40-43, wherein the fluid comprises a reagent for removing the plurality of biomolecules.

Item 49. The method of item 48, wherein removing the plurality of biomolecules comprises cleaving the association with the building block of the plurality of biomolecules.

Item 50. The method of item 48 or 49, wherein (c) evacuating the fluid comprises evacuating the plurality of biomolecules from the active surface on each surface of the plurality of substrates or a portion thereof.

Item 51. A platform for processing a plurality of biomolecules, comprising:
(a) a device of any one of items 1-34; and
(b) an apparatus comprising at least one logic element for performing one or more operations based on sensor data from one or more components of the flow cell assembly.

Item 52. A platform for processing a plurality of biomolecules, comprising:
(a) a flow cell assembly comprising one or more components, wherein the one or more component comprises:
   (i) one or more fluidic interfaces;
   (ii) a plurality of substrates, each surface of the plurality of substrates facing an adjacent substrate of the plurality of substrates is functionalized for association with a building block of the plurality of biomolecules;
   (iii) one or more spacers each comprising a perimeter surface, wherein each of the plurality of substrates is separated by a spacer of the one or more spacers, wherein the perimeter surface forms an active surface on each surface of the plurality of substrates to which it is juxtaposed; and
(b) an apparatus comprising at least one logic element for performing one or more operations based on sensor data from one or more components of the flow cell assembly.

Item 53. The platform of item 51 or 52, wherein each of the plurality of substrates is substantially parallel to one another.

Item 54. The platform of any one of items 51-53, wherein one or more operations comprise one or more of:
(i) determining a timing for opening or closing one or more valves connecting the one or more components;
(ii) adjusting one or more parameters of the flow cell assembly, wherein the one or more parameters comprises a fill rate of the liquid, a volume of the liquid, the liquid, an evacuation rate of the liquid, a capillary number, or one or more angles of the flow cell assembly; or
(iii) determining a recovery efficiency of a fluid evacuated from the flow cell assembly.

Item 55. The platform of any one of items 51-54, further comprising a cloud computing resource communicably coupled to the apparatus.

Item 56. The platform of any one of items 51-55, wherein the apparatus comprises at least one processor, a memory, and instructions executable by at least one processor.

Item 57. The platform of any one of items 51-56, wherein the at least one logic element comprises a programmable logic controller (PLC), programable logic array (PLA), programmable array logic (PAL), generic logic array (GLA), complex programmable logic decide (CPLD), field programable gate array (FPGA), or application-specific integrated circuit (ASIC).

Item 58. The platform of any one of items 51-57, wherein the platform further comprises a synthesis module, a sequencing module, an amplification module, or any combination thereof.

Item 59. The platform of any one of items 51-58, wherein the platform further comprises one or more reservoirs.

Item 60. The platform of item 59, wherein the one or more reservoirs are in connected to the one or more fluidic interfaces.

Item 61. The platform of item 59 or 60, wherein the one or more reservoirs hold a fluid for processing the plurality of biomolecules.

Item 62. The platform of any one of items 51-61, herein the platform further comprises a controller communicatively coupled to one or more actuators that open and close valves connected to the flow cell assembly.

1. A device for processing a plurality of biomolecules comprising:
a first substrate comprising a first surface functionalized for association with a first building block of the plurality of biomolecules; and
a second substrate comprising a second surface functionalized for association with a second building block of the plurality of biomolecules, wherein the second surface faces the first surface.

2. The device of claim 1, wherein the first substrate and the second substrate are substantially parallel.

3. The device of claim 1, wherein the first substrate or the second substrate comprises dimensions of about 15 mm to about 40 mm by about 15 mm to about 40 mm.

4. The device of claim 1, wherein the plurality of biomolecules comprises a plurality of polynucleotides and wherein the first building block and the second building block each comprise a nucleotide.

5. The device of claim 1, wherein the first surface and the second surface are functionalized with a chemical moiety suitable for nucleotide coupling.

6. The device of claim 1, wherein the first surface or the second surface comprises a plurality of addressable loci.

7. The device of claim 1, wherein the first surface or the second surface are functionalized for association with the plurality of biomolecules at a density of about 1 pmol/cm² to about 200 pmol/cm².

8. The device of claim 1, wherein the first substrate or the second substrate comprises at least one through-hole.

9. The device of claim 8, wherein the at least one through-hole is about 120 μm to about 500 μm in diameter.

10. The device of claim 1, wherein the second substrate comprises at least two through-holes located on opposite sides.

11. The device of claim 10, wherein the at least two through-holes of the second substrate each connect to a manifold of a flow cell assembly.

12. The device of claim 1, wherein the first substrate and the second substrate each comprise at least one through-hole.

13. The device of claim 12, wherein the at least one through-hole of the first substrate and the at least one through-hole of the second substrate each connect to a manifold of a flow cell.

14. The device of claim 1, further comprising a spacer comprising a perimeter surface.

15. The device of claim 14, wherein the spacer comprises a seal, a frame, or end pieces.

16. The device of claim 15, wherein the spacer comprises end pieces, and the end pieces comprise spacing beads.

17. A device for processing a plurality of biomolecules comprising:
a top substrate comprising a first top surface and a first bottom surface, wherein the first bottom surface is functionalized for association with a building block of the plurality of biomolecules;
a middle substrate comprising a second top surface and a second bottom surface functionalized for association with a building block of the plurality of biomolecules, wherein the second top surface and the first bottom surface define a first cavity;
a bottom substrate comprising a third top surface and a third bottom surface, the third top surface functionalized for association with a building block of the plurality of the plurality of biomolecules, wherein the third top surface and the second bottom surface define a second cavity.

18. The device of claim 17, wherein the first cavity is separated from the second cavity by a spacer comprising a perimeter surface.

19. The device of claim 17, wherein the device comprises at six functionalized surfaces, including the first top surface, the first bottom surface, the second top surface, the second bottom surface, the third top surface, and the third bottom surface.

19. The device of claim 18, wherein the spacer comprising the perimeter surface between the first substrate and the second substrate forms a cavity enclosed by the first active surface and the second active surface.

20. The device of claim 18, wherein the middle substrate comprises two through-holes.
